(19) United States
(12) Patent Application Publication
(10) Pub. No.: US 2022/0366077 A1
(43) Pub. Date: Nov. 17, 2022

(54) USER INTERFACES AND ASSOCIATED SYSTEMS AND PROCESSES FOR SHARED PLAYBACK OF CONTENT ITEMS

(71) Applicant: Apple Inc., Cupertino, CA (US)

(72) Inventors: Agnes WON, Los Angeles, CA (US); Tiffany S. REESE, Cupertino, CA (US); Drew R. DOMM, Oakland, CA (US); Gabriel V. BENVENISTE, San Francisco, CA (US); Catherine L. TOMEZSKO, Los Angeles, CA (US); Jae Woo CHANG, San Jose, CA (US); Sooyeon KIM, New York, NY (US); Victoria K. HARRINGTON, San Francisco, CA (US); Lauren E. TAPPANA, San Francisco, CA (US); Lucio MORENO RUFO, Campbell, CA (US)

(21) Appl. No.: 17/663,406

(22) Filed: May 13, 2022

Related U.S. Application Data
(60) Provisional application No. 63/189,106, filed on May 15, 2021.
(60) Provisional application No. 63/197,493, filed on Jun. 6, 2021.

(51) Int. Cl. G06F 21/62; G06F 3/14; G06F 3/0484

(52) U.S. Cl. CPC G06F 21/6245; G06F 3/1454; G06F 3/0484; G06F 3/0482

(57) ABSTRACT

In some embodiments, an electronic device plays a content item in a manner synchronized with playback of the content item at one or more other electronic devices of other users. For example, the electronic device and one or more other electronic devices are participating in a communication session that includes synchronized playback of content items, including synchronized modifications to the playback of content items based on an input to modify playback of the content item received at one of the electronic devices.

### CROSS-REFERENCE TO RELATED APPLICATIONS

This application claims the benefit of U.S. Provisional Application No. 63/189,106, filed May 15, 2021, and U.S. Provisional Application No. 63/197,493, filed Jun. 6, 2021, the contents of which are incorporated herein by reference in their entireties for all purposes.

### FIELD OF THE DISCLOSURE

This specification relates generally to electronic devices that perform shared playback of content items, and user interactions with such devices.

### BACKGROUND

User interaction with electronic devices has increased significantly in recent years. These devices can be devices such as computers, tablet computers, televisions, multimedia devices, mobile devices, smart watches, and the like. In some circumstances, users wish to use electronic devices to play content items in a synchronized manner with electronic devices of other users.

### SUMMARY

Some embodiments described in this disclosure are directed to ways of playing content items on an electronic device in a manner that is synchronized with playback of the content item at other electronic devices of other users. Enhancing a user's interactions with an electronic device in performing the above actions improves the user's experience with the device and decreases user interaction time, which is particularly important where input devices are battery-operated.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating exemplary components for event handling in accordance with some embodiments.

FIG. 2 illustrates a portable multifunction device having a touch screen in accordance with some embodiments.

FIG. 3 is a block diagram of an exemplary multifunction device with a display and a touch-sensitive surface in accordance with some embodiments.

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

FIG. 5A illustrates a personal electronic device in accordance with some embodiments.

FIG. 5B is a block diagram illustrating a personal electronic device in accordance with some embodiments.

FIGS. 5C-5D illustrate exemplary components of a personal electronic device having a touch-sensitive display and intensity sensors in accordance with some embodiments.

FIGS. 5E-5H illustrate exemplary components and user interfaces of a personal electronic device in accordance with some embodiments.

FIGS. 6A-6CC illustrate exemplary ways in which an electronic device plays content items in a manner synchronized with playback of the content item at other electronic devices of other users in accordance with some embodiments.

FIG. 7 is a flow diagram illustrating a method of playing content items at an electronic device in a manner synchronized with playback of the content item at other electronic devices of other users in accordance with some embodiments.

### DETAILED DESCRIPTION

### Description of Embodiments

The following description sets forth exemplary methods, parameters, and the like. It should be recognized, however, that such description is not intended as a limitation on the scope of the present disclosure but is instead provided as a description of exemplary embodiments.

In some implementations, an example electronic device in a communication session with one or more second electronic devices plays a content item in a manner that is synchronized with playback of the content item at the one or more second electronic devices. For example, the electronic devices in a shared playback mode of the communication session present the same content items in a synchronized manner, including synchronizing modifications to playback of the content item in response to one or more user inputs. Such techniques can reduce the cognitive burden on a user who uses an example electronic device and streamline a process for playing a content item at a plurality of electronic devices in a communication session.

Although the following description uses terms “first,” “second,” etc. to describe various elements, these elements should not be limited by the terms. These terms are only used to distinguish one element from another. For example, a first touch could be termed a second touch, and, similarly, a second touch could be termed a first touch, without departing from the scope of the various described embodiments. The first touch and the second touch are both touches, but they are not the same touch.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, Calif. Other portable electronic devices, such as laptops or tablet computers with touch-sensitive surfaces (e.g., touch screen displays and/or touchpads), are, optionally, used. It should also be understood that, in some embodiments, the device is not a portable communications device, but is a desktop computer with a touch-sensitive surface (e.g., a touch screen display and/or a touchpad). In some embodiments, the electronic device is a computer system that is in communication (e.g., via wireless communication, via wired communication) with a display generation component. The display generation component is configured to provide visual output, such as display via a CRT display, display via an LED display, or display via image projection. In some embodiments, the display generation component is integrated with the computer system. In some embodiments, the display generation component is separate from the computer system. As used herein, “displaying” content includes causing to display the content (e.g., video data rendered or decoded by display controller 156) by transmitting, via a wired or wireless connection, data (e.g., image data or video data) to an integrated or external display generation component to visually produce the content.

In the discussion that follows, an electronic device that includes a display and a touch-sensitive surface is described. It should be understood, however, that the electronic device optionally includes one or more other physical user-interface devices, such as a physical keyboard, a mouse, and/or a joystick.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

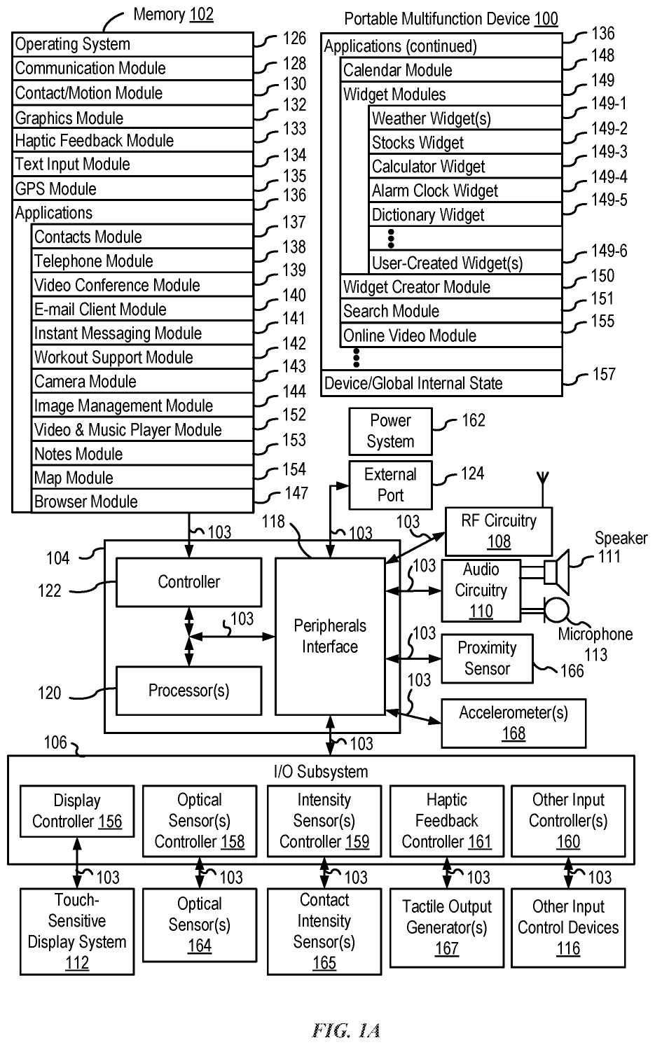

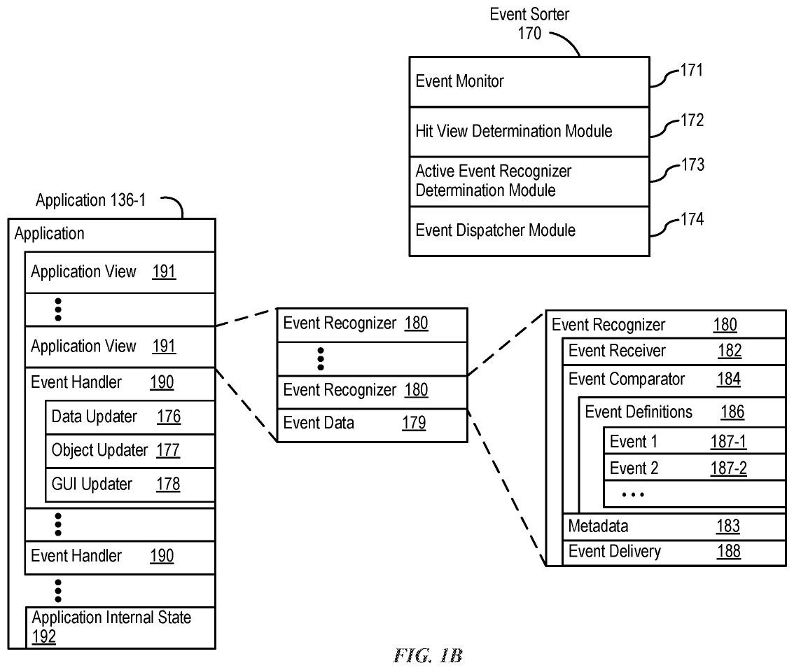

Attention is now directed toward embodiments of portable devices with touch-sensitive displays. FIG. 1A is a block diagram illustrating portable multifunction device 100 with touch-sensitive display system 112 in accordance with some embodiments. Touch-sensitive display 112 is sometimes called a “touch screen” for convenience and is sometimes known as or called a “touch-sensitive display system.” Device 100 includes memory 102 (which optionally includes one or more computer-readable storage mediums), memory controller 122, one or more processing units (CPUs) 120, peripherals interface 118, RF circuitry 108, audio circuitry 110, speaker 111, microphone 113, input/output (I/O) subsystem 106, other input control devices 116, and external port 124. Device 100 optionally includes one or more optical sensors 164. Device 100 optionally includes one or more contact intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure, and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application-specific integrated circuits.

Memory 102 optionally includes high-speed random access memory and optionally also includes non-volatile memory, such as one or more magnetic disk storage devices, flash memory devices, or other non-volatile solid-state memory devices. Memory controller 122 optionally controls access to memory 102 by other components of device 100.

Peripherals interface 118 can be used to couple input and output peripherals of the device to CPU 120 and memory 102. The one or more processors 120 run or execute various software programs and/or sets of instructions stored in memory 102 to perform various functions for device 100 and to process data. In some embodiments, peripherals interface 118, CPU 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 108 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VoIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

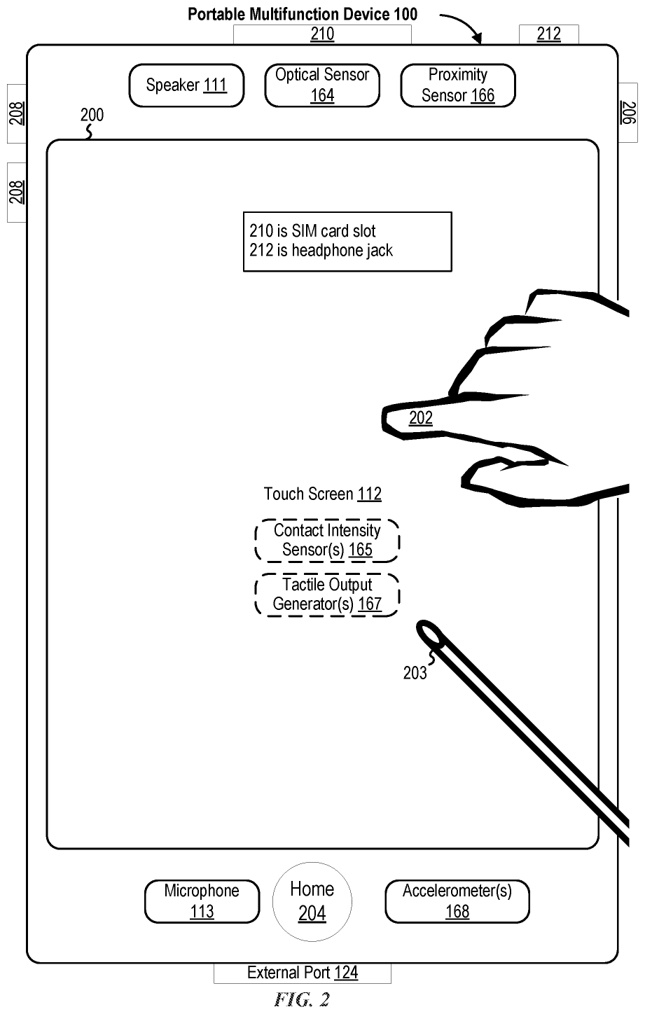

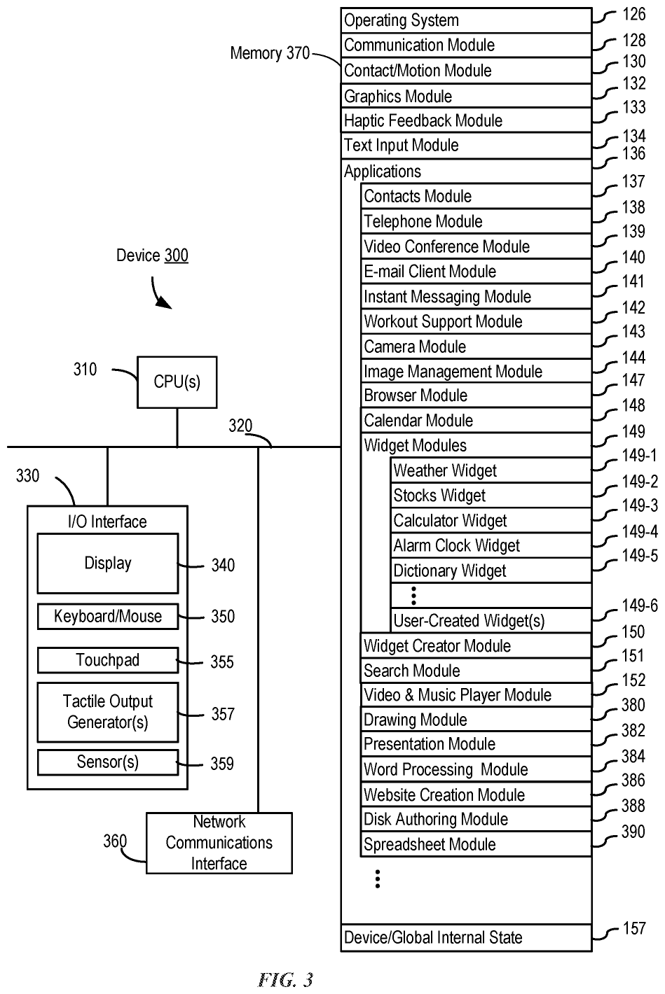

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both ears) and input (e.g., a microphone).

I/O subsystem 106 couples input/output peripherals on device 100, such as touch screen 112 and other input control devices 116, to peripherals interface 118. I/O subsystem 106 optionally includes display controller 156, optical sensor controller 158, intensity sensor controller 159, haptic feedback controller 161, and one or more input controllers 160 for other input or control devices. The one or more input controllers 160 receive/send electrical signals from/to other input control devices 116. The other input control devices 116 optionally include physical buttons (e.g., push buttons, rocker buttons, etc.), dials, slider switches, joysticks, click wheels, and so forth. In some embodiments, input controller(s) 160 are, optionally, coupled to any (or none) of the following: a keyboard, an infrared port, a USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2). In some embodiments, the electronic device is a computer system that is in communication (e.g., via wireless communication, via wired communication) with one or more input devices. In some embodiments, the one or more input devices include a touch-sensitive surface (e.g., a trackpad, as part of a touch-sensitive display). In some embodiments, the one or more input devices include one or more camera sensors (e.g., one or more optical sensors 164 and/or one or more depth camera sensors 175), such as for tracking a user's gestures (e.g., hand gestures) as input. In some embodiments, the one or more input devices are integrated with the computer system. In some embodiments, the one or more input devices are separate from the computer system.

A quick press of the push button optionally disengages a lock of touch screen 112 or optionally begins a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 206) optionally turns power to device 100 on or off. The functionality of one or more of the buttons are, optionally, user-customizable. Touch screen 112 is used to implement virtual or soft buttons and one or more soft keyboards.

Touch-sensitive display 112 provides an input interface and an output interface between the device and a user. Display controller 156 receives and/or sends electrical signals from/to touch screen 112. Touch screen 112 displays visual output to the user. The visual output optionally includes graphics, text, icons, video, and any combination thereof (collectively termed “graphics”). In some embodiments, some or all of the visual output optionally corresponds to user-interface objects.

Touch screen 112 has a touch-sensitive surface, sensor, or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, icons, web pages, or images) that are displayed on touch screen 112. In an exemplary embodiment, a point of contact between touch screen 112 and the user corresponds to a finger of the user.

Touch screen 112 optionally uses LCD (liquid crystal display) technology, LPD (light emitting polymer display) technology, or LED (light emitting diode) technology, although other display technologies are used in other embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone® and iPod Touch® from Apple Inc. of Cupertino, Calif.

A touch-sensitive display in some embodiments of touch screen 112 is, optionally, analogous to the multi-touch sensitive touchpads described in the following U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference in its entirety. However, touch screen 112 displays visual output from device 100, whereas touch-sensitive touchpads do not provide visual output.

A touch-sensitive display in some embodiments of touch screen 112 is described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 112 optionally has a video resolution in excess of 100 dpi. In some embodiments, the touch screen has a video resolution of approximately 160 dpi. The user optionally makes contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad (not shown) for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CMOS) phototransistors. Optical sensor 164 receives light from the environment, projected through one or more lenses, and converts the light to data representing an image. In conjunction with imaging module 143 (also called a camera module), optical sensor 164 optionally captures still images or video. In some embodiments, an optical sensor is located on the back of device 100, opposite touch screen display 112 on the front of the device so that the touch screen display is enabled for use as a viewfinder for still and/or video image acquisition. In some embodiments, an optical sensor is located on the front of the device so that the user's image is, optionally, obtained for video conferencing while the user views the other video conference participants on the touch screen display. In some embodiments, the position of optical sensor 164 can be changed by the user (e.g., by rotating the lens and the sensor in the device housing) so that a single optical sensor 164 is used along with the touch screen display for both video conferencing and still and/or video image acquisition.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112, which is located on the front of device 100.

Device 100 optionally also includes one or more proximity sensors 166. FIG. 1A shows proximity sensor 166 coupled to peripherals interface 118. Alternately, proximity sensor 166 is, optionally, coupled to input controller 160 in I/O subsystem 106. Proximity sensor 166 optionally performs as described in U.S. patent application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 112 when the multifunction device is placed near the user's ear (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112, which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. Accelerometer 168 optionally performs as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 100 optionally includes, in addition to accelerometer(s) 168, a magnetometer (not shown) and a GPS (or GLONASS or other global navigation system) receiver (not shown) for obtaining information concerning the location and orientation (e.g., portrait or landscape) of device 100.

In some embodiments, the software components stored in memory 102 include operating system 126, communication module (or set of instructions) 128, contact/motion module (or set of instructions) 130, graphics module (or set of instructions) 132, text input module (or set of instructions) 134, Global Positioning System (GPS) module (or set of instructions) 135, and applications (or sets of instructions) 136. Furthermore, in some embodiments, memory 102 (FIG. 1A) or 370 (FIG. 3) stores device/global internal state 157, as shown in FIGS. 1A and 3. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, iOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with, the 30-pin connector used on iPod® (trademark of Apple Inc.) devices.

Contact/motion module 130 optionally detects contact with touch screen 112 (in conjunction with display controller 156) and other touch-sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments, at least a subset of the intensity thresholds are determined in accordance with software parameters (e.g., the intensity thresholds are not determined by the activation thresholds of particular physical actuators and can be adjusted without changing the physical hardware of device 100). For example, a mouse “click” threshold of a trackpad or touch screen display can be set to any of a large range of predefined threshold values without changing the trackpad or touch screen display hardware. Additionally, in some implementations, a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 132 includes various known software components for rendering and displaying graphics on touch screen 112 or other display, including components for changing the visual impact (e.g., brightness, transparency, saturation, contrast, or other visual property) of graphics that are displayed. As used herein, the term “graphics” includes any object that can be displayed to a user, including, without limitation, text, web pages, icons (such as user-interface objects including soft keys), digital images, videos, animations, and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts 137, e-mail 140, IM 141, browser 147, and any other application that needs text input).

GPS module 135 determines the location of the device and provides this information for use in various applications (e.g., to telephone 138 for use in location-based dialing; to camera 143 as picture/video metadata; and to applications that provide location-based services such as weather widgets, local yellow page widgets, and map/navigation widgets).

Applications 136 optionally include the following modules (or sets of instructions), or a subset or superset thereof:
Contacts module 137 (sometimes called an address book or contact list);
Telephone module 138;
Video conference module 139;
E-mail client module 140;
Instant messaging (IM) module 141;
Workout support module 142;
Camera module 143 for still and/or video images;
Image management module 144;
Video player module;
Music player module;
Browser module 147;
Calendar module 148;
Widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
Widget creator module 150 for making user-created widgets 149-6;
Search module 151;
Video and music player module 152, which merges video player module and music player module;
Notes module 153;
Map module 154; and/or
Online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact/motion module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone 138, video conference module 139, e-mail 140, or IM 141; and so forth.

In conjunction with RF circuitry 108, audio circuitry 110, speaker 111, microphone 113, touch screen 112, display controller 156, contact/motion module 130, graphics module 132, and text input module 134, telephone module 138 are optionally, used to enter a sequence of characters corresponding to a telephone number, access one or more telephone numbers in contacts module 137, modify a telephone number that has been entered, dial a respective telephone number, conduct a conversation, and disconnect or hang up when the conversation is completed. As noted above, the wireless communication optionally uses any of a plurality of communications standards, protocols, and technologies.

In conjunction with RF circuitry 108, audio circuitry 110, speaker 111, microphone 113, touch screen 112, display controller 156, optical sensor 164, optical sensor controller 158, contact/motion module 130, graphics module 132, text input module 134, contacts module 137, and telephone module 138, video conference module 139 includes executable instructions to initiate, conduct, and terminate a video conference between a user and one or more other participants in accordance with user instructions.

In conjunction with RF circuitry 108, touch screen 112, display controller 156, contact/motion module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact/motion module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact/motion module 130, graphics module 132, text input module 134, GPS module 135, map module 154, and music player module, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 112, display controller 156, optical sensor(s) 164, optical sensor controller 158, contact/motion module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact/motion module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display controller 156, contact/motion module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display controller 156, contact/motion module 130, graphics module 132, text input module 134, e-mail client module 140, and browser module 147, calendar module 148 includes executable instructions to create, display, modify, and store calendars and data associated with calendars (e.g., calendar entries, to-do lists, etc.) in accordance with user instructions.

In conjunction with RF circuitry 108, touch screen 112, display controller 156, contact/motion module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch screen 112, display controller 156, contact/motion module 130, graphics module 132, text input module 134, and browser module 147, the widget creator module 150 are, optionally, used by a user to create widgets (e.g., turning a user-specified portion of a web page into a widget).

In conjunction with touch screen 112, display controller 156, contact/motion module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display controller 156, contact/motion module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present, or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact/motion module 130, graphics module 132, and text input module 134, notes module 153 includes executable instructions to create and manage notes, to-do lists, and the like in accordance with user instructions.

In conjunction with RF circuitry 108, touch screen 112, display controller 156, contact/motion module 130, graphics module 132, text input module 134, GPS module 135, and browser module 147, map module 154 are, optionally, used to receive, display, modify, and store maps and data associated with maps (e.g., driving directions, data on stores and other points of interest at or near a particular location, and other location-based data) in accordance with user instructions.

In conjunction with touch screen 112, display controller 156, contact/motion module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,067, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the methods described in this application (e.g., the computer-implemented methods and other information processing methods described herein). These modules (e.g., sets of instructions) need not be implemented as separate software programs, procedures, or modules, and thus various subsets of these modules are, optionally, combined or otherwise rearranged in various embodiments. For example, video player module is, optionally, combined with music player module into a single module (e.g., video and music player module 152, FIG. 1A). In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating exemplary components for event handling in accordance with some embodiments. In some embodiments, memory 102 (FIG. 1A) or 370 (FIG. 3) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views when touch-sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 172, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit (not shown) or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177, or GUI updater 178 to update the application internal state 192. Alternatively, one or more of the application views 191 include one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170 and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event (187) include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and liftoff of the touch (touch end). In some embodiments, the event also includes information for one or more associated event handlers 190.

In some embodiments, event definition 187 includes a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event (187) also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable multifunction device 100 having a touch screen 112 in accordance with some embodiments. The touch screen optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward), and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also include one or more physical buttons, such as “home” or menu button 204. As described previously, menu button 204 is, optionally, used to navigate to any application 136 in a set of applications that are, optionally, executed on device 100. Alternatively, in some embodiments, the menu button is implemented as a soft key in a GUI displayed on touch screen 112.

In some embodiments, device 100 includes touch screen 112, menu button 204, push button 206 for powering the device on/off and locking the device, volume adjustment button(s) 208, subscriber identity module (SIM) card slot 210, headset jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 3 is a block diagram of an exemplary multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPUs) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM, or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while memory 102 of portable multifunction device 100 (FIG. 1A) optionally does not store these modules.

Each of the above-identified elements in FIG. 3 is, optionally, stored in one or more of the previously mentioned memory devices. Each of the above-identified modules corresponds to a set of instructions for performing a function described above. The above-identified modules or programs (e.g., sets of instructions) need not be implemented as separate software programs, procedures, or modules, and thus various subsets of these modules are, optionally, combined or otherwise rearranged in various embodiments. In some embodiments, memory 370 optionally stores a subset of the modules and data structures identified above. Furthermore, memory 370 optionally stores additional modules and data structures not described above.

Attention is now directed towards embodiments of user interfaces that are, optionally, implemented on, for example, portable multifunction device 100.

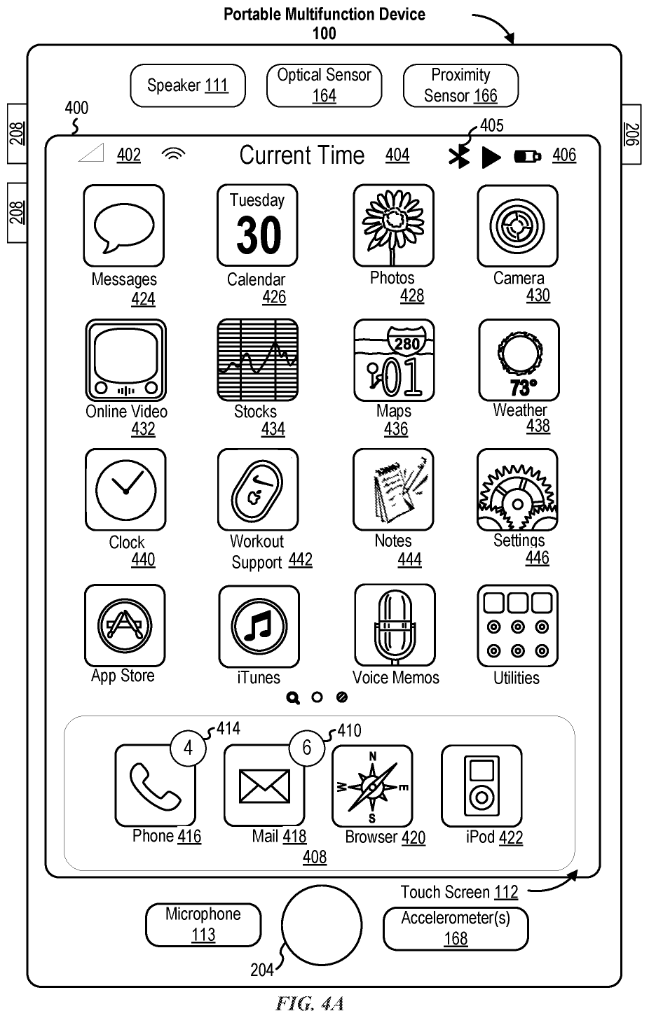

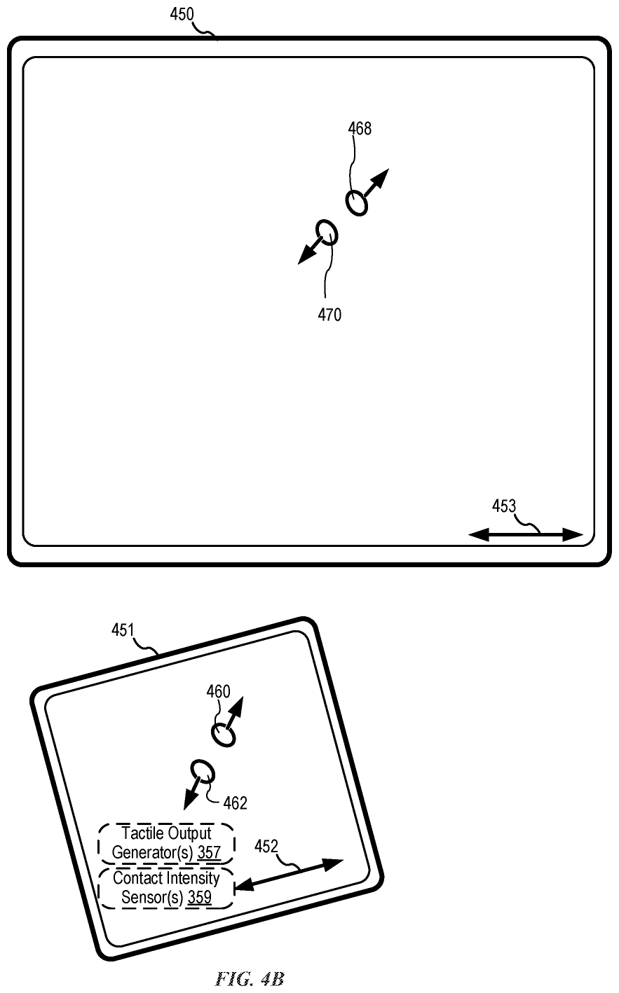

FIG. 4A illustrates an exemplary user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser;” and
   Icon 422 for video and music player module 152, also referred to as iPod (trademark of Apple Inc.) module 152, labeled “iPod;” and
Icons for other applications, such as:
   Icon 424 for IM module 141, labeled “Messages;”
   Icon 426 for calendar module 148, labeled “Calendar;”
   Icon 428 for image management module 144, labeled “Photos;”
   Icon 430 for camera module 143, labeled “Camera;”
   Icon 432 for online video module 155, labeled “Online Video;”
   Icon 434 for stocks widget 149-2, labeled “Stocks;”
   Icon 436 for map module 154, labeled “Maps;”
   Icon 438 for weather widget 149-1, labeled “Weather;”
   Icon 440 for alarm clock widget 149-4, labeled “Clock;”
   Icon 442 for workout support module 142, labeled “Workout Support;”
   Icon 444 for notes module 153, labeled “Notes;” and
   Icon 446 for a settings application or module, labeled “Settings,” which provides access to settings for device 100 and its various applications 136.

It should be noted that the icon labels illustrated in FIG. 4A are merely exemplary. For example, icon 422 for video and music player module 152 is labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a device (e.g., device 300, FIG. 3) with a touch-sensitive surface 451 (e.g., a tablet or touchpad 355, FIG. 3) that is separate from the display 450 (e.g., touch screen display 112). Device 300 also, optionally, includes one or more contact intensity sensors (e.g., one or more of sensors 359) for detecting intensity of contacts on touch-sensitive surface 451 and/or one or more tactile output generators 357 for generating tactile outputs for a user of device 300.

Although some of the examples that follow will be given with reference to inputs on touch screen display 112 (where the touch-sensitive surface and the display are combined), in some embodiments, the device detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, 460 corresponds to 468 and 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

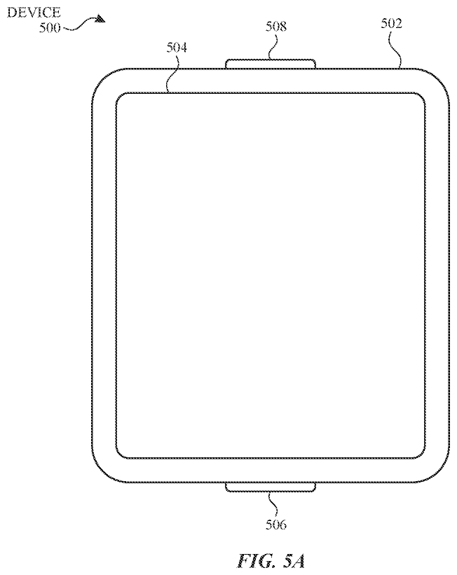

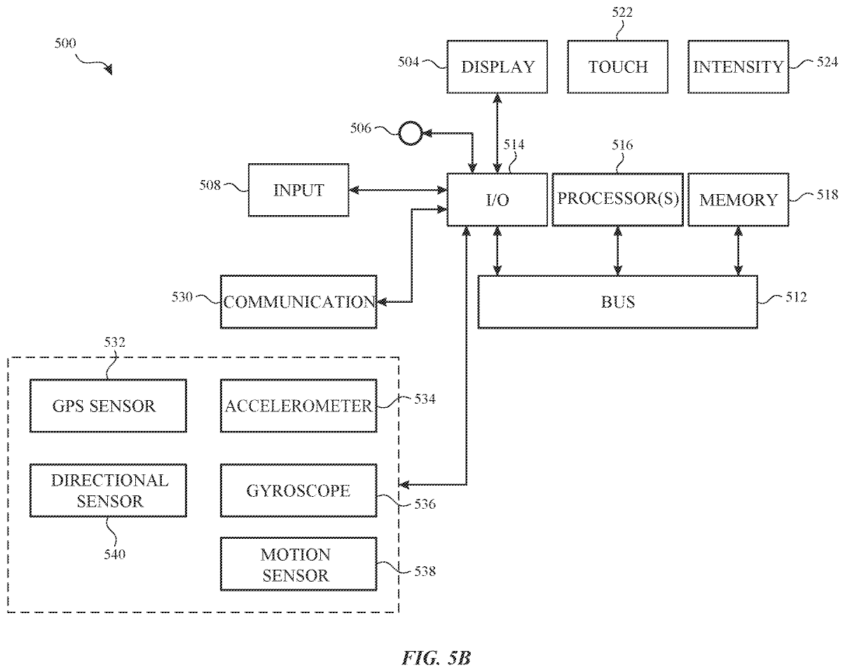

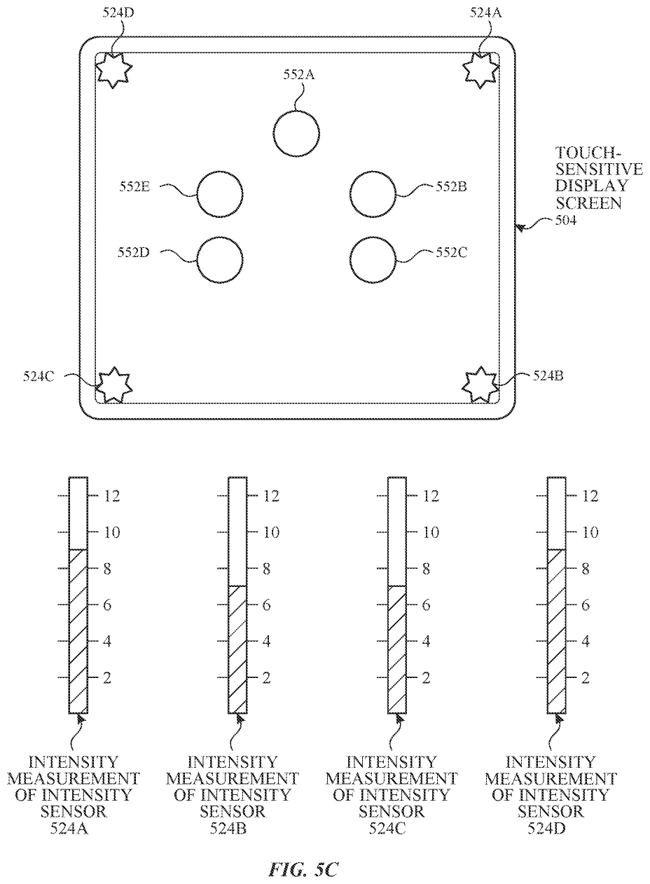

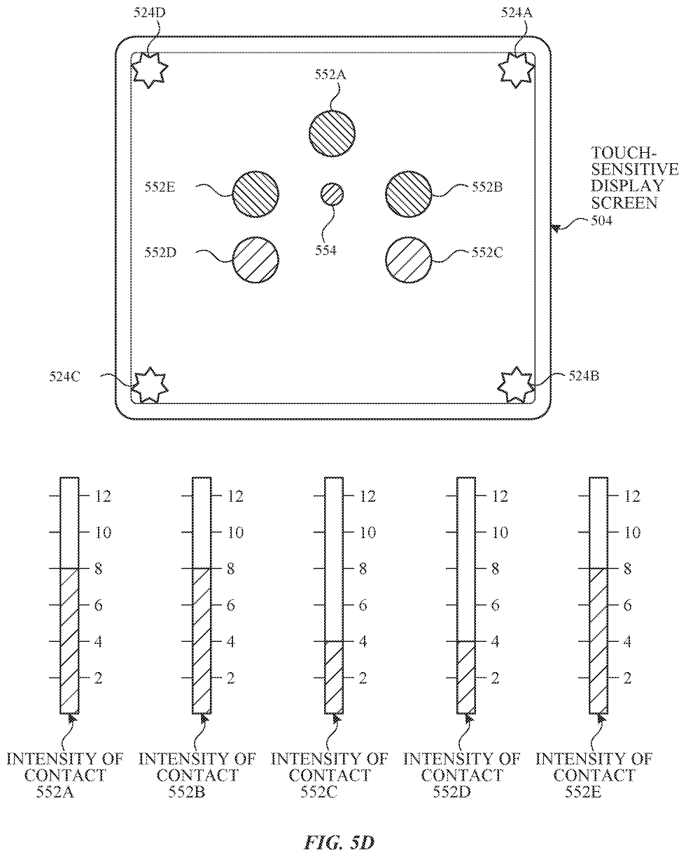

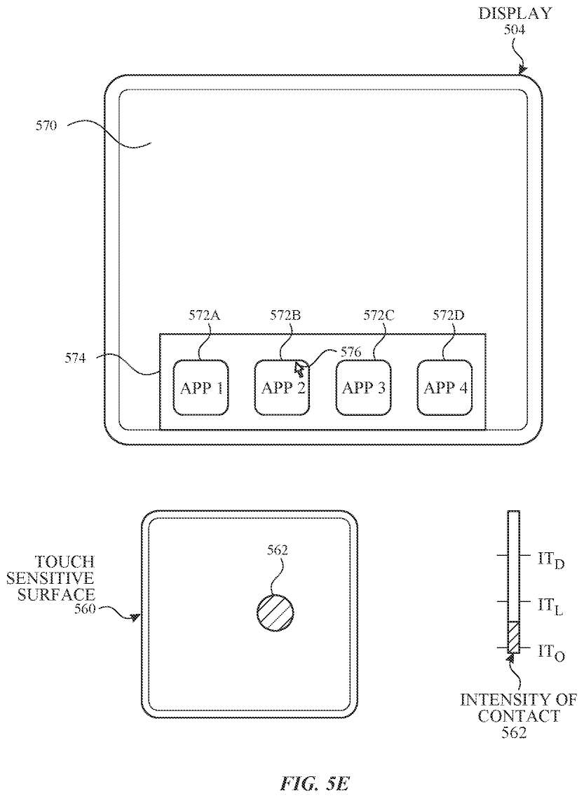

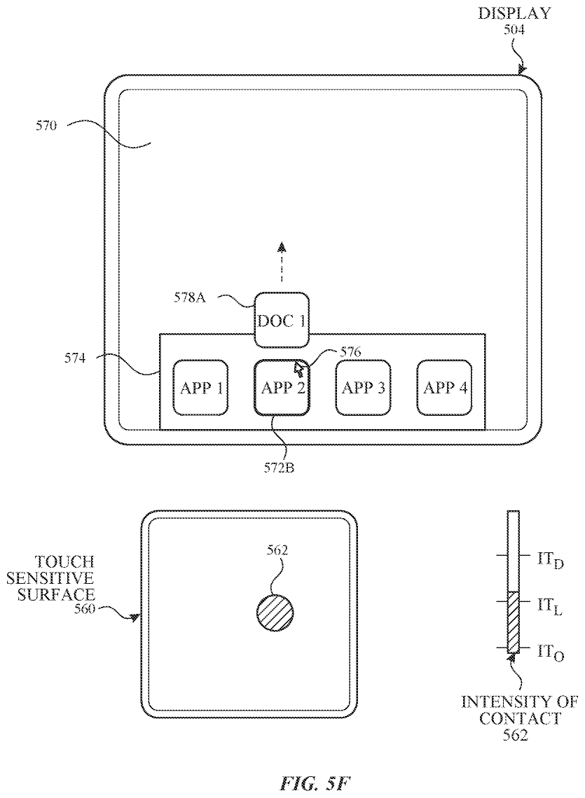

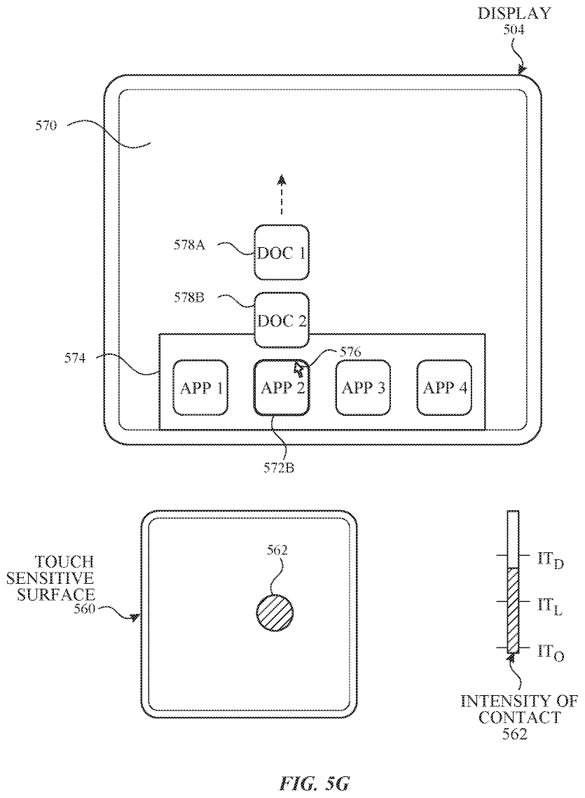

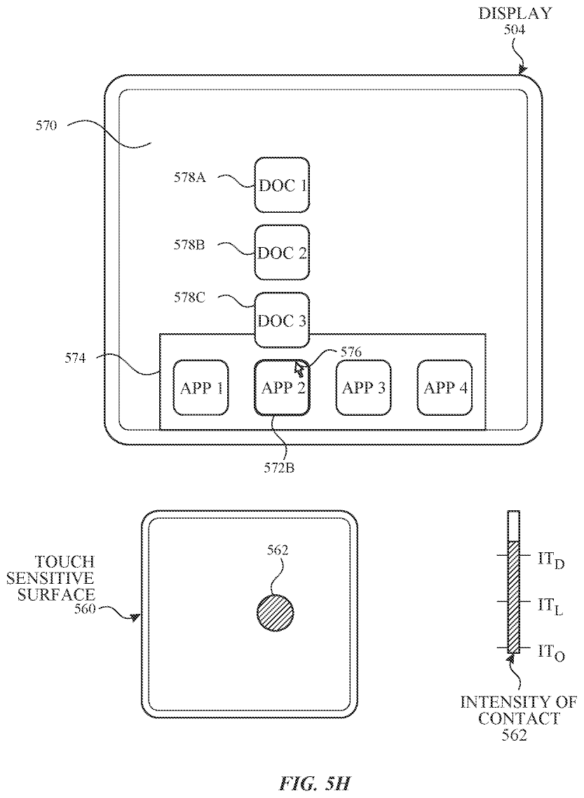

FIG. 5A illustrates exemplary personal electronic device 500. Device 500 includes body 502. In some embodiments, device 500 can include some or all of the features described with respect to devices 100 and 300 (e.g., FIGS. 1A-4B). In some embodiments, device 500 has touch-sensitive display screen 504, hereafter touch screen 504. Alternatively, or in addition to touch screen 504, device 500 has a display and a touch-sensitive surface. As with devices 100 and 300, in some embodiments, touch screen 504 (or the touch-sensitive surface) optionally includes one or more intensity sensors for detecting intensity of contacts (e.g., touches) being applied. The one or more intensity sensors of touch screen 504 (or the touch-sensitive surface) can provide output data that represents the intensity of touches. The user interface of device 500 can respond to touches based on their intensity, meaning that touches of different intensities can invoke different user interface operations on device 500.

Exemplary techniques for detecting and processing touch intensity are found, for example, in related applications: International Patent Application Serial No. PCT/US2013/040061, titled “Device, Method, and Graphical User Interface for Displaying User Interface Objects Corresponding to an Application,” filed May 8, 2013, published as WIPO Publication No. WO/2013/169849, and International Patent Application Serial No. PCT/US2013/069483, titled “Device, Method, and Graphical User Interface for Transitioning Between Touch Input to Display Output Relationships,” filed Nov. 11, 2013, published as WIPO Publication No. WO/2014/105276, each of which is hereby incorporated by reference in their entirety.

In some embodiments, device 500 has one or more input mechanisms 506 and 508. Input mechanisms 506 and 508, if included, can be physical. Examples of physical input mechanisms include push buttons and rotatable mechanisms. In some embodiments, device 500 has one or more attachment mechanisms. Such attachment mechanisms, if included, can permit attachment of device 500 with, for example, hats, eyewear, earrings, necklaces, shirts, jackets, bracelets, watch straps, chains, trousers, belts, shoes, purses, backpacks, and so forth. These attachment mechanisms permit device 500 to be worn by a user.

FIG. 5B depicts exemplary personal electronic device 500. In some embodiments, device 500 can include some or all of the components described with respect to FIGS. 1A, 1B, and 3. Device 500 has bus 512 that operatively couples I/O section 514 with one or more computer processors 516 and memory 518. I/O section 514 can be connected to display 504, which can have touch-sensitive component 522 and, optionally, intensity sensor 524 (e.g., contact intensity sensor). In addition, I/O section 514 can be connected with communication unit 530 for receiving application and operating system data, using Wi-Fi, Bluetooth, near field communication (NFC), cellular, and/or other wireless communication techniques. Device 500 can include input mechanisms 506 and/or 508. Input mechanism 506 is, optionally, a rotatable input device or a depressible and rotatable input device, for example. Input mechanism 508 is, optionally, a button, in some examples.

Input mechanism 508 is, optionally, a microphone, in some examples. Personal electronic device 500 optionally includes various sensors, such as GPS sensor 532, accelerometer 534, directional sensor 540 (e.g., compass), gyroscope 536, motion sensor 538, and/or a combination thereof, all of which can be operatively connected to I/O section 514.

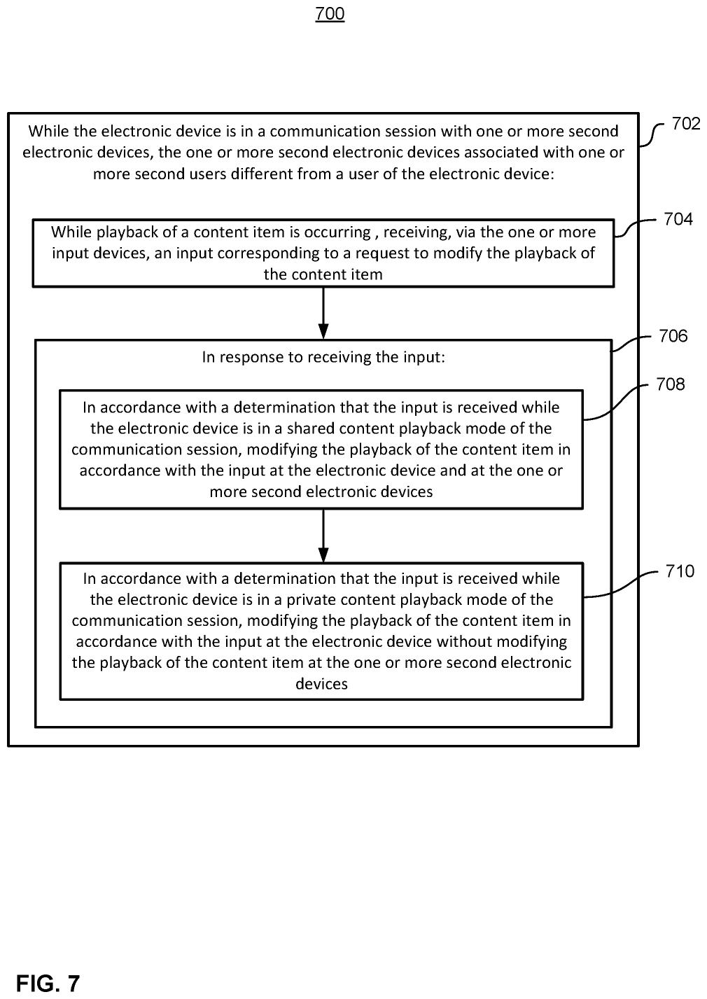

Memory 518 of personal electronic device 500 can include one or more non-transitory computer-readable storage mediums, for storing computer-executable instructions, which, when executed by one or more computer processors 516, for example, can cause the computer processors to perform the techniques described below, including process 700 (FIG. 7). A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like. Personal electronic device 500 is not limited to the components and configuration of FIG. 5B, but can include other or additional components in multiple configurations.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

As used here, the term “affordance” refers to a user-interactive graphical user interface object that is, optionally, displayed on the display screen of devices 100, 300, and/or 500 (FIGS. 1A, 3, and 5A-5B). For example, an image (e.g., icon), a button, and text (e.g., hyperlink) each optionally constitute an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 355 in FIG. 3 or touch-sensitive surface 451 in FIG. 4B) while the cursor is over a particular user interface element (e.g., a button, window, slider, or other user interface element), the particular user interface element is adjusted in accordance with the detected input. In some implementations that include a touch screen display (e.g., touch-sensitive display system 112 in FIG. 1A or touch screen 112 in FIG. 4A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

FIG. 5C illustrates detecting a plurality of contacts 552A-552E on touch-sensitive display screen 504 with a plurality of intensity sensors 524A-524D. FIG. 5C additionally includes intensity diagrams that show the current intensity measurements of the intensity sensors 524A-524D relative to units of intensity. In this example, the intensity measurements of intensity sensors 524A and 524D are each 9 units of intensity, and the intensity measurements of intensity sensors 524B and 524C are each 7 units of intensity. In some implementations, an aggregate intensity is the sum of the intensity measurements of the plurality of intensity sensors 524A-524D, which in this example is 32 intensity units. In some embodiments, each contact is assigned a respective intensity that is a portion of the aggregate intensity. FIG. 5D illustrates assigning the aggregate intensity to contacts 552A-552E based on their distance from the center of force 554. In this example, each of contacts 552A, 552B, and 552E are assigned an intensity of contact of 8 intensity units of the aggregate intensity, and each of contacts 552C and 552D are assigned an intensity of contact of 4 intensity units of the aggregate intensity. More generally, in some implementations, each contact j is assigned a respective intensity Ij that is a portion of the aggregate intensity, A, in accordance with a predefined mathematical function, Ij=A·(Dj/ΣDi), where Dj is the distance of the respective contact j to the center of force, and ΣDi is the sum of the distances of all the respective contacts (e.g., i=1 to last) to the center of force. The operations described with reference to FIGS. 5C-5D can be performed using an electronic device similar or identical to device 100, 300, or 500. In some embodiments, a characteristic intensity of a contact is based on one or more intensities of the contact. In some embodiments, the intensity sensors are used to determine a single characteristic intensity (e.g., a single characteristic intensity of a single contact). It should be noted that the intensity diagrams are not part of a displayed user interface, but are included in FIGS. 5C-5D to aid the reader.

In some embodiments, a portion of a gesture is identified for purposes of determining a characteristic intensity. For example, a touch-sensitive surface optionally receives a continuous swipe contact transitioning from a start location and reaching an end location, at which point the intensity of the contact increases. In this example, the characteristic intensity of the contact at the end location is, optionally, based on only a portion of the continuous swipe contact, and not the entire swipe contact (e.g., only the portion of the swipe contact at the end location). In some embodiments, a smoothing algorithm is, optionally, applied to the intensities of the swipe contact prior to determining the characteristic intensity of the contact. For example, the smoothing algorithm optionally includes one or more of: an unweighted sliding-average smoothing algorithm, a triangular smoothing algorithm, a median filter smoothing algorithm, and/or an exponential smoothing algorithm. In some circumstances, these smoothing algorithms eliminate narrow spikes or dips in the intensities of the swipe contact for purposes of determining a characteristic intensity.

The intensity of a contact on the touch-sensitive surface is, optionally, characterized relative to one or more intensity thresholds, such as a contact-detection intensity threshold, a light press intensity threshold, a deep press intensity threshold, and/or one or more other intensity thresholds. In some embodiments, the light press intensity threshold corresponds to an intensity at which the device will perform operations typically associated with clicking a button of a physical mouse or a trackpad. In some embodiments, the deep press intensity threshold corresponds to an intensity at which the device will perform operations that are different from operations typically associated with clicking a button of a physical mouse or a trackpad. In some embodiments, when a contact is detected with a characteristic intensity below the light press intensity threshold (e.g., and above a nominal contact-detection intensity threshold below which the contact is no longer detected), the device will move a focus selector in accordance with movement of the contact on the touch-sensitive surface without performing an operation associated with the light press intensity threshold or the deep press intensity threshold. Generally, unless otherwise stated, these intensity thresholds are consistent between different sets of user interface figures.

An increase of characteristic intensity of the contact from an intensity below the light press intensity threshold to an intensity between the light press intensity threshold and the deep press intensity threshold is sometimes referred to as a “light press” input. An increase of characteristic intensity of the contact from an intensity below the deep press intensity threshold to an intensity above the deep press intensity threshold is sometimes referred to as a “deep press” input. An increase of characteristic intensity of the contact from an intensity below the contact-detection intensity threshold to an intensity between the contact-detection intensity threshold and the light press intensity threshold is sometimes referred to as detecting the contact on the touch-surface. A decrease of characteristic intensity of the contact from an intensity above the contact-detection intensity threshold to an intensity below the contact-detection intensity threshold is sometimes referred to as detecting liftoff of the contact from the touch-surface. In some embodiments, the contact-detection intensity threshold is zero. In some embodiments, the contact-detection intensity threshold is greater than zero.

In some embodiments described herein, one or more operations are performed in response to detecting a gesture that includes a respective press input or in response to detecting the respective press input performed with a respective contact (or a plurality of contacts), where the respective press input is detected based at least in part on detecting an increase in intensity of the contact (or plurality of contacts) above a press-input intensity threshold. In some embodiments, the respective operation is performed in response to detecting the increase in intensity of the respective contact above the press-input intensity threshold (e.g., a “down stroke” of the respective press input). In some embodiments, the press input includes an increase in intensity of the respective contact above the press-input intensity threshold and a subsequent decrease in intensity of the contact below the press-input intensity threshold, and the respective operation is performed in response to detecting the subsequent decrease in intensity of the respective contact below the press-input threshold (e.g., an “up stroke” of the respective press input).

FIGS. 5E-5H illustrate detection of a gesture that includes a press input that corresponds to an increase in intensity of a contact 562 from an intensity below a light press intensity threshold (e.g., “IT_{L}”) in FIG. 5E, to an intensity above a deep press intensity threshold (e.g., “IT_{D}”) in FIG. 5H. The gesture performed with contact 562 is detected on touch-sensitive surface 560 while cursor 576 is displayed over application icon 572B corresponding to App 2, on a displayed user interface 570 that includes application icons 572A-572D displayed in predefined region 574. In some embodiments, the gesture is detected on touch-sensitive display 504. The intensity sensors detect the intensity of contacts on touch-sensitive surface 560. The device determines that the intensity of contact 562 peaked above the deep press intensity threshold (e.g., “IT_{D}”). Contact 562 is maintained on touch-sensitive surface 560. In response to the detection of the gesture, and in accordance with contact 562 having an intensity that goes above the deep press intensity threshold (e.g., “IT_{D}”) during the gesture, reduced-scale representations 578A-578C (e.g., thumbnails) of recently opened documents for App 2 are displayed, as shown in FIGS. 5F-5H. In some embodiments, the intensity, which is compared to the one or more intensity thresholds, is the characteristic intensity of a contact. It should be noted that the intensity diagram for contact 562 is not part of a displayed user interface, but is included in FIGS. 5E-5H to aid the reader.

In some embodiments, the display of representations 578A-578C includes an animation. For example, representation 578A is initially displayed in proximity of application icon 572B, as shown in FIG. 5F. As the animation proceeds, representation 578A moves upward and representation 578B is displayed in proximity of application icon 572B, as shown in FIG. 5G. Then, representations 578A moves upward, 578B moves upward toward representation 578A, and representation 578C is displayed in proximity of application icon 572B, as shown in FIG. 5H. Representations 578A-578C form an array above icon 572B. In some embodiments, the animation progresses in accordance with an intensity of contact 562, as shown in FIGS. 5F-5G, where the representations 578A-578C appear and move upwards as the intensity of contact 562 increases toward the deep press intensity threshold (e.g., “IT_{D}”). In some embodiments, the intensity, on which the progress of the animation is based, is the characteristic intensity of the contact. The operations described with reference to FIGS. 5E-5H can be performed using an electronic device similar or identical to device 100, 300, or 500.

In some embodiments, the device employs intensity hysteresis to avoid accidental inputs sometimes termed “jitter,” where the device defines or selects a hysteresis intensity threshold with a predefined relationship to the press-input intensity threshold (e.g., the hysteresis intensity threshold is X intensity units lower than the press-input intensity threshold or the hysteresis intensity threshold is 75%, 90%, or some reasonable proportion of the press-input intensity threshold). Thus, in some embodiments, the press input includes an increase in intensity of the respective contact above the press-input intensity threshold and a subsequent decrease in intensity of the contact below the hysteresis intensity threshold that corresponds to the press-input intensity threshold, and the respective operation is performed in response to detecting the subsequent decrease in intensity of the respective contact below the hysteresis intensity threshold (e.g., an “up stroke” of the respective press input). Similarly, in some embodiments, the press input is detected only when the device detects an increase in intensity of the contact from an intensity at or below the hysteresis intensity threshold to an intensity at or above the press-input intensity threshold and, optionally, a subsequent decrease in intensity of the contact to an intensity at or below the hysteresis intensity, and the respective operation is performed in response to detecting the press input (e.g., the increase in intensity of the contact or the decrease in intensity of the contact, depending on the circumstances).

For ease of explanation, the descriptions of operations performed in response to a press input associated with a press-input intensity threshold or in response to a gesture including the press input are, optionally, triggered in response to detecting either: an increase in intensity of a contact above the press-input intensity threshold, an increase in intensity of a contact from an intensity below the hysteresis intensity threshold to an intensity above the press-input intensity threshold, a decrease in intensity of the contact below the press-input intensity threshold, and/or a decrease in intensity of the contact below the hysteresis intensity threshold corresponding to the press-input intensity threshold. Additionally, in examples where an operation is described as being performed in response to detecting a decrease in intensity of a contact below the press-input intensity threshold, the operation is, optionally, performed in response to detecting a decrease in intensity of the contact below a hysteresis intensity threshold corresponding to, and lower than, the press-input intensity threshold.

As used herein, an “installed application” refers to a software application that has been downloaded onto an electronic device (e.g., devices 100, 300, and/or 500) and is ready to be launched (e.g., become opened) on the device. In some embodiments, a downloaded application becomes an installed application by way of an installation program that extracts program portions from a downloaded package and integrates the extracted portions with the operating system of the computer system.

As used herein, the terms “open application” or “executing application” refer to a software application with retained state information (e.g., as part of device/global internal state 157 and/or application internal state 192). An open or executing application is, optionally, any one of the following types of applications:
an active application, which is currently displayed on a display screen of the device that the application is being used on;
a background application (or background processes), which is not currently displayed, but one or more processes for the application are being processed by one or more processors; and
a suspended or hibernated application, which is not running, but has state information that is stored in memory (volatile and non-volatile, respectively) and that can be used to resume execution of the application.

As used herein, the term “closed application” refers to software applications without retained state information (e.g., state information for closed applications is not stored in a memory of the device). Accordingly, closing an application includes stopping and/or removing application processes for the application and removing state information for the application from the memory of the device. Generally, opening a second application while in a first application does not close the first application. When the second application is displayed and the first application ceases to be displayed, the first application becomes a background application.

Attention is now directed towards embodiments of user interfaces (“UP”) and associated processes that are implemented on an electronic device, such as portable multifunction device 100, device 300, or device 500.

### User Interfaces and Associated Processes

### User Interfaces for Synchronized Playback of Content Items

Users interact with electronic devices in many different manners, including using electronic devices to communicate with other electronic devices and play items of content. The embodiments described below provide ways in which an electronic device in a communication session with one or more second electronic devices plays a content item synchronized with playback of the content items at the one or more second electronic devices. Providing efficient manners of playing content items in a manner synchronized with other electronic devices enhances interactions with a device, thus reducing the amount of time a user needs to ensure synchronized playback of the content item and reducing the power usage of the device, which increases battery life for battery-powered devices. It is understood that people use devices. When a person uses a device, that person is optionally referred to as a user of the device.

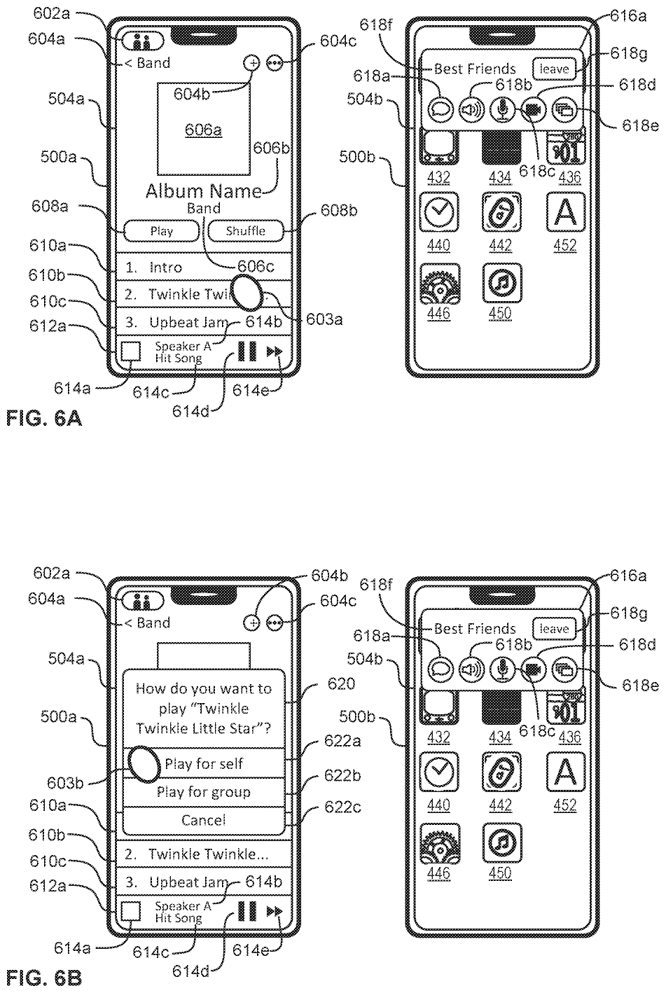

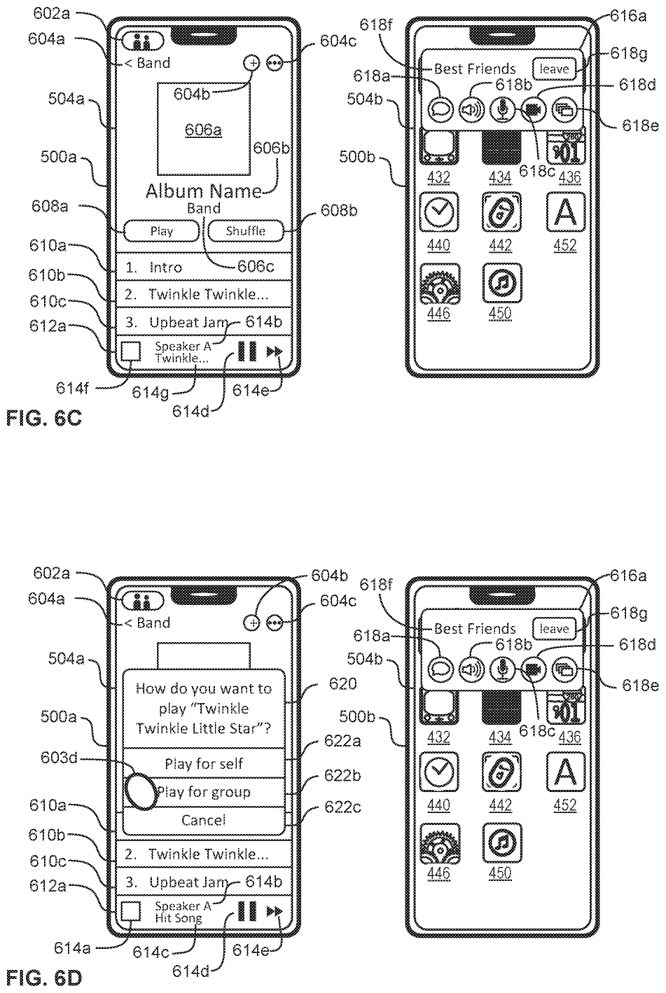

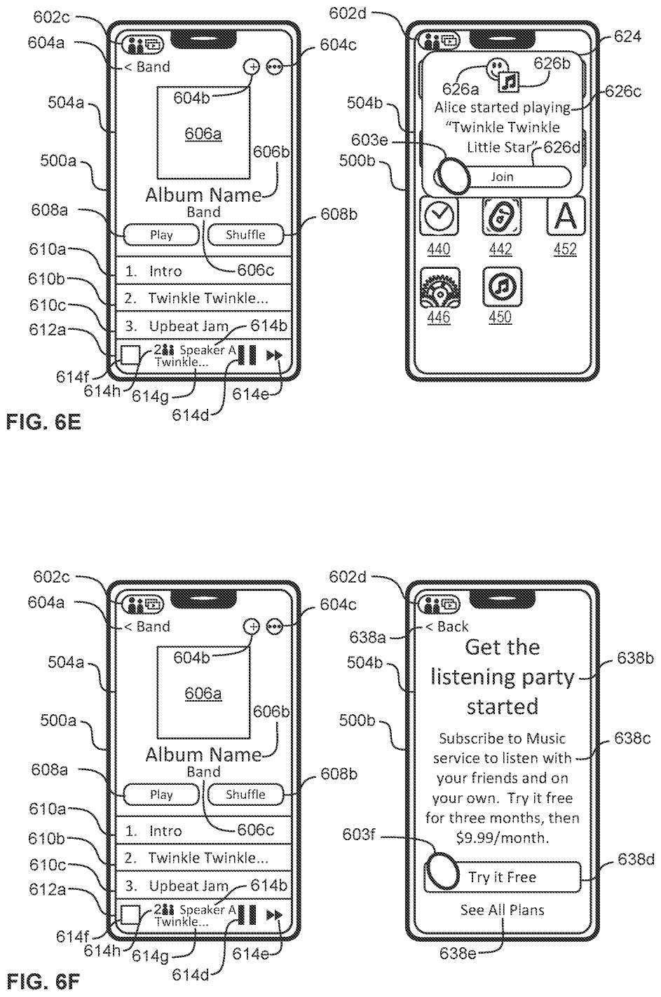

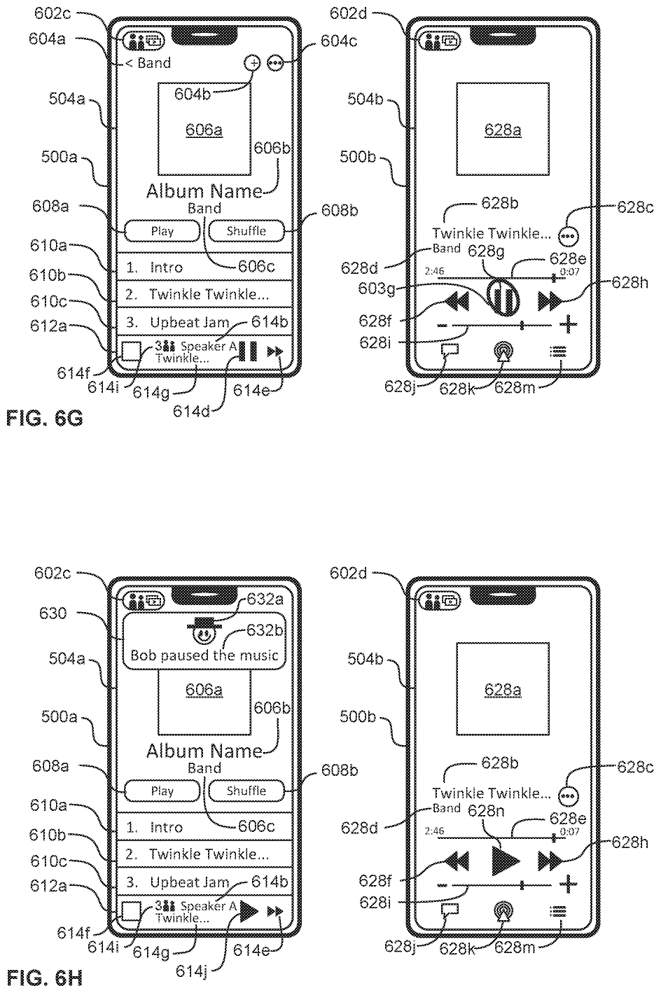

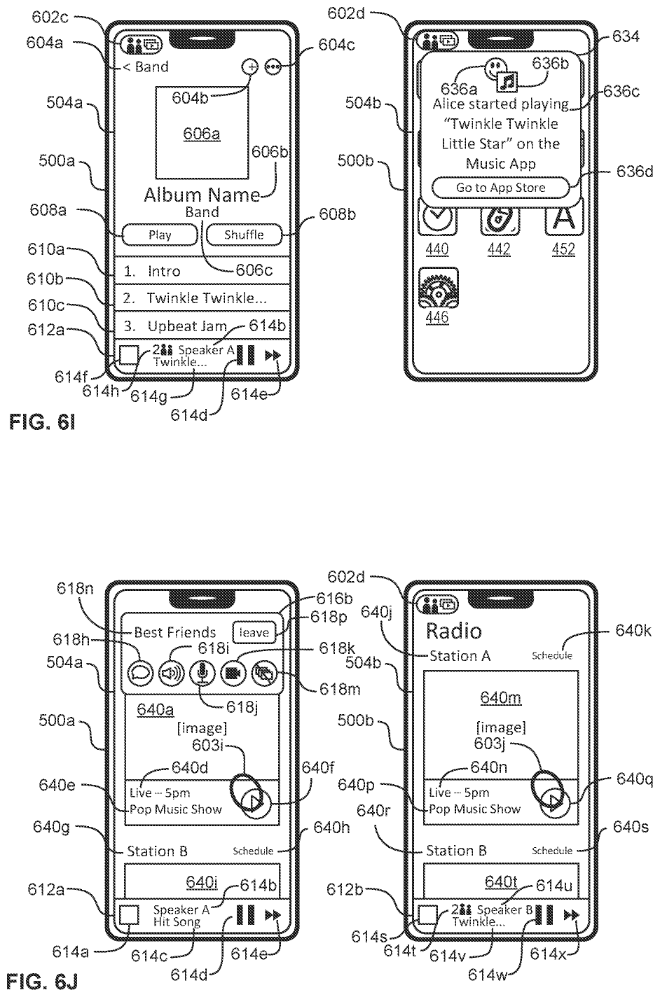

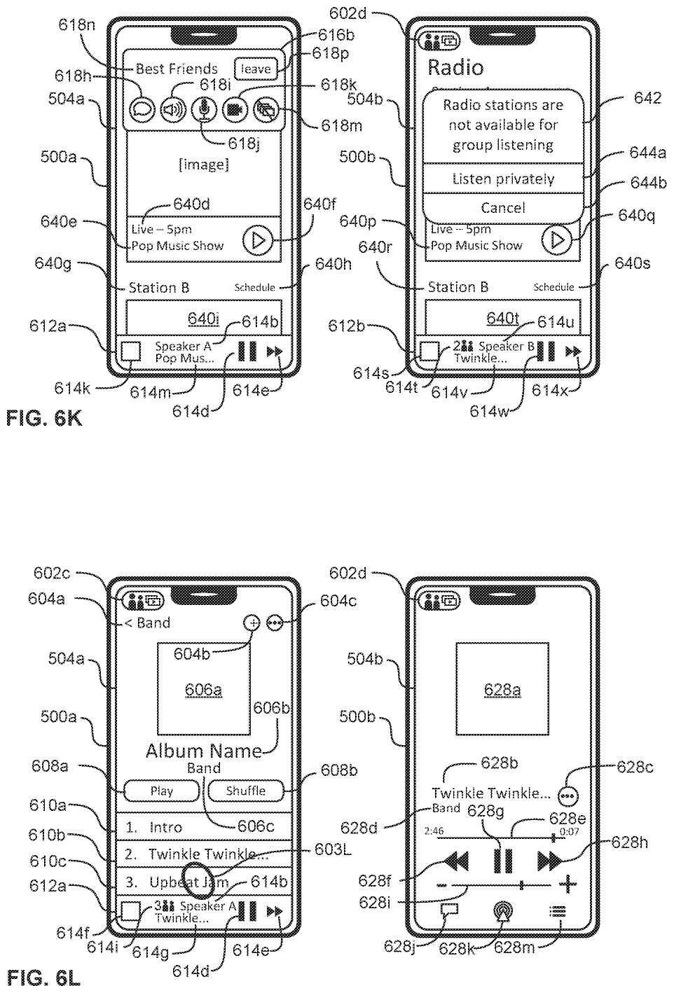

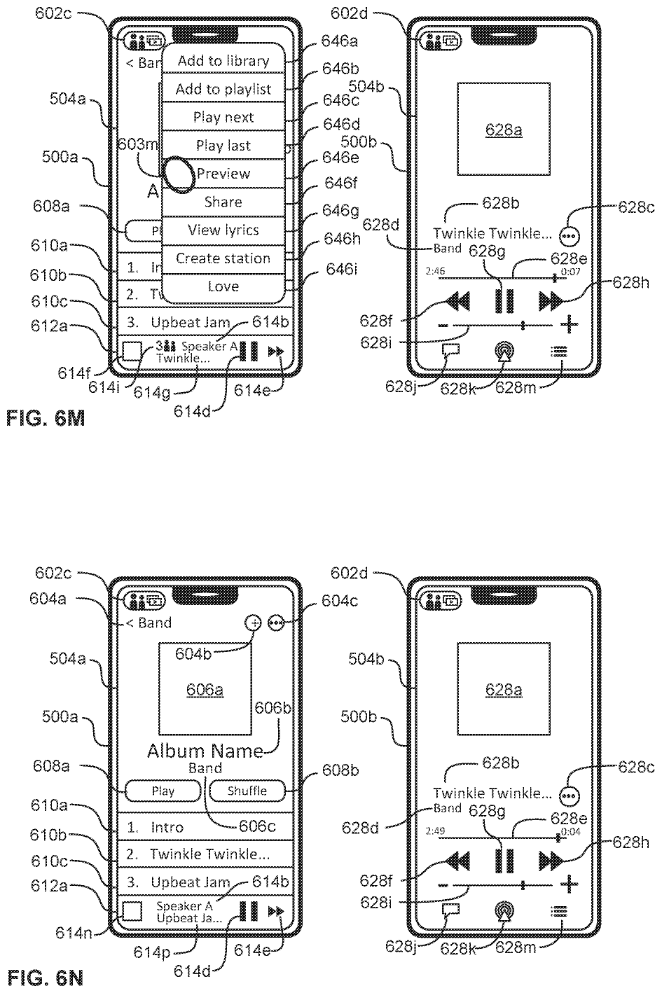

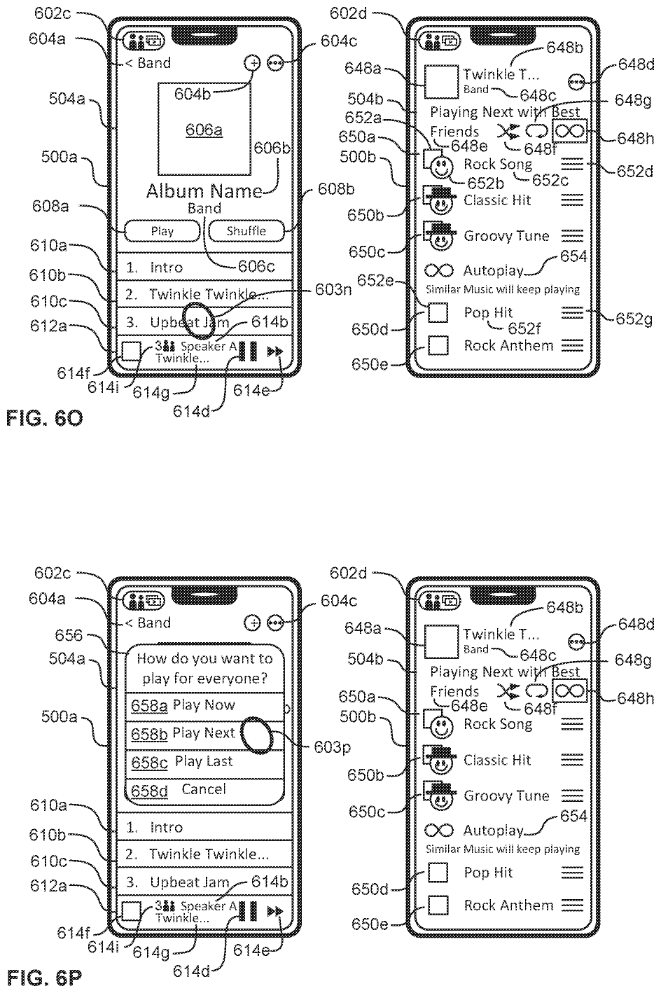

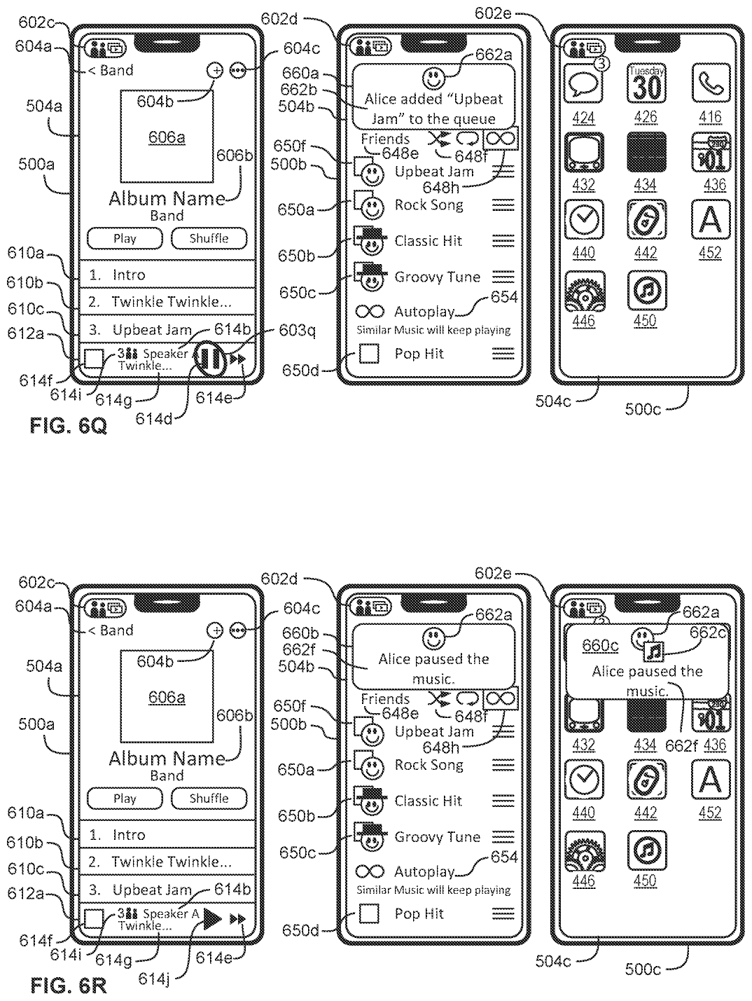

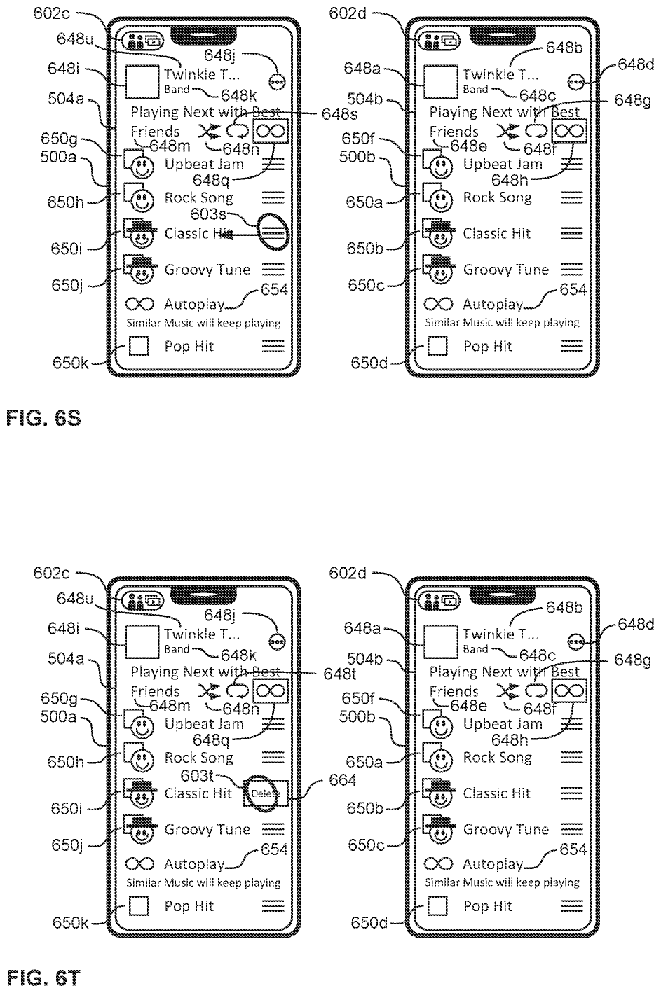

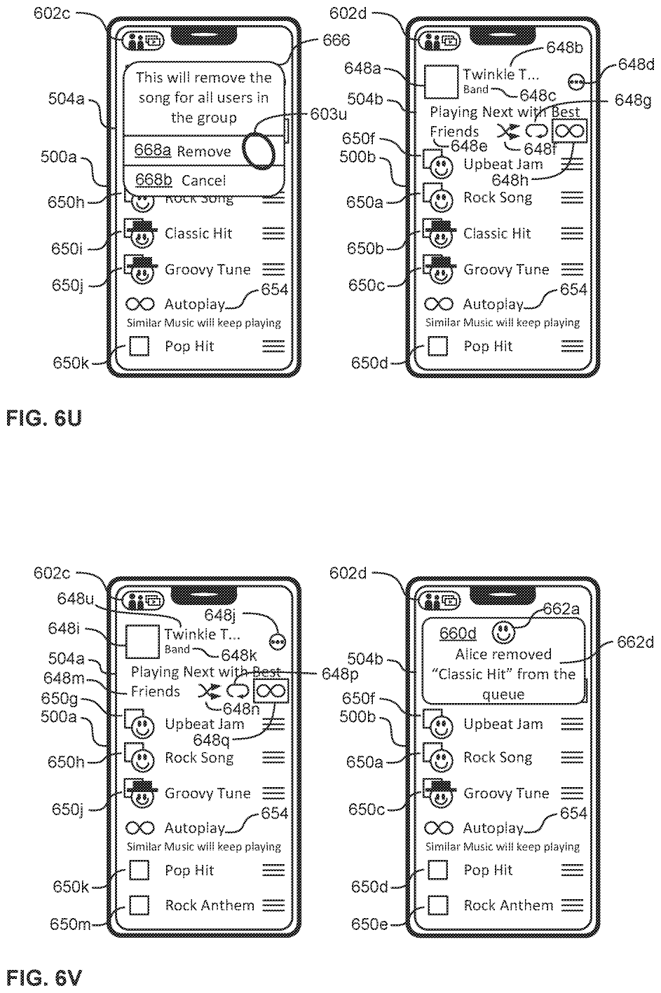

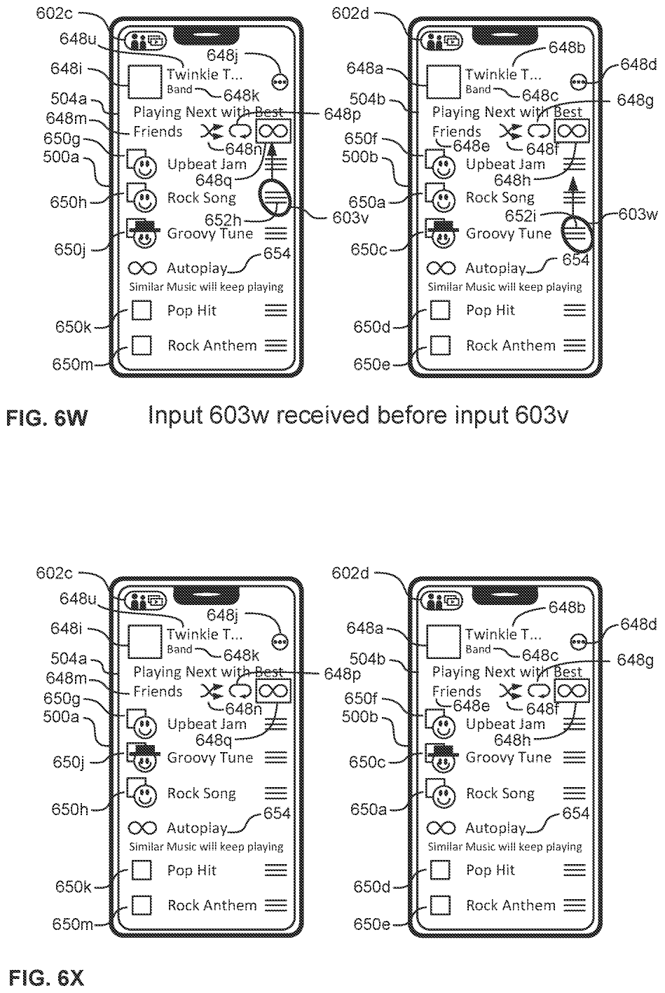

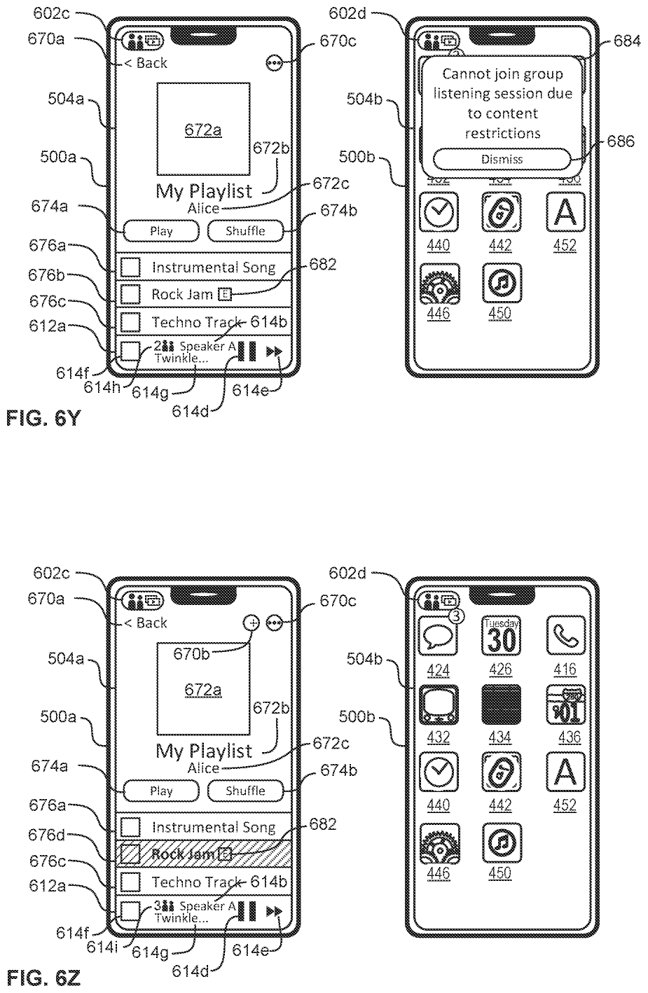

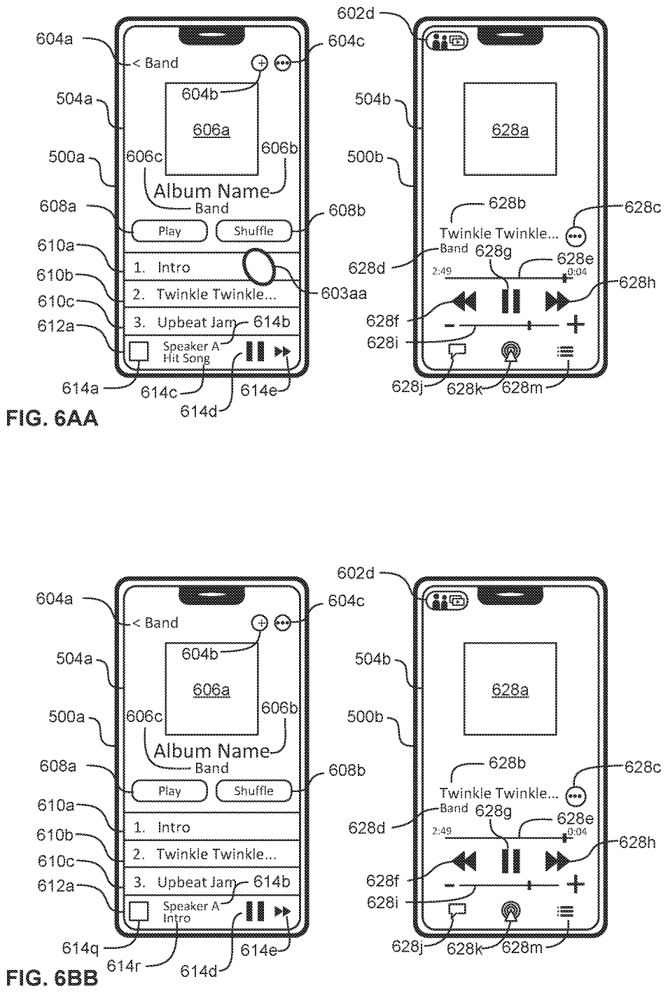

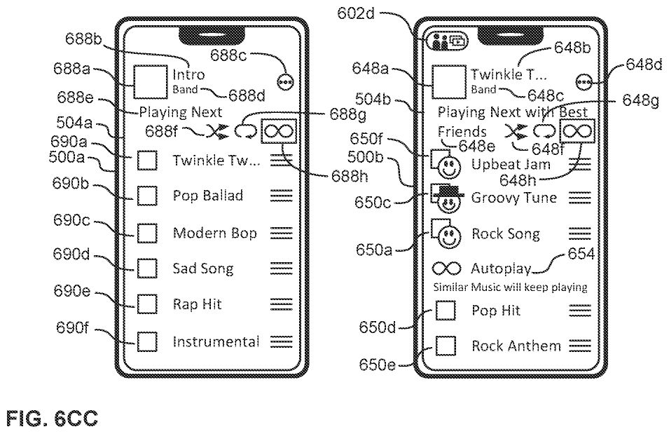

FIGS. 6A-6CC illustrate exemplary ways in which an electronic device 500a plays content items in a manner synchronized with playback of the content item at other electronic devices 500b and 500c of other users in accordance with some embodiments. The embodiments in these figures are used to illustrate the processes described below, including the processes described with reference to FIG. 7. Although FIGS. 6A-6CC illustrate various examples of ways an electronic device is able to perform the processes described below with reference to FIG. 7, it should be understood that these examples are not meant to be limiting, and the electronic device is able to perform one or more processes described below with reference to FIG. 7 in ways not expressly described with reference to FIGS. 6A-6CC.

FIGS. 6A-6CC illustrate various examples of playing content items in a manner synchronized with playback of the content items at other electronic devices participating in a communication session. For example, the electronic devices are in a communication session such as a group video call, group phone call, or group messaging chat that includes synchronized playback of content items, such as audio content (e.g., music, audiobooks, podcasts, etc.) and/or video content (e.g., movies, series of episodic content).

FIGS. 6A-6C illustrate examples of a first electronic device 500a playing content in a private content playback mode of a communication session. For example, the first electronic device 500a, the second electronic device 500b, and one or more additional electronic devices not illustrated in FIGS. 6A-6C are participating in the communication session.

In FIG. 6A, the first electronic device 500a presents a user interface of a content application while participating in a communication session with the second electronic device 500b and optionally one or more other electronic devices not illustrated in FIG. 6A. The second electronic device 500b presents a home screen user interface including a plurality of icons 432-450 associated with applications accessible to (e.g., installed on) the second electronic device 500b and an expanded indication 616a of the communication session.

In some embodiments, while the second electronic device 500b is participating in the communication session, the second electronic device 500b displays an expanded indication 616a of the communication session. In some embodiments, the expanded indication 616a of the communication session includes an indication 618f of a group name of a group of users included in the communication session, an option 618g to leave the communication session, an option 618a to view a chat associated with the communication session, an option 618b to modify the audio settings of the audio output of the communication session, an option 618c to mute or unmute the second electronic device 500b from the communication session, an option 618d to view a video chat of the communication session, and an option 618e to participate or not participate in shared media playback associated with the communication session. In some embodiments, in response to detecting an input to cease display of the expanded indication 616a of the communication session (e.g., a swipe input from the expanded indication 616a towards the upper edge of the display generation component 504b of the second electronic device 500b), the second electronic device 500b ceases display of the expanded indication 616a of the communication session and displays an indication of the communication session similar to the indication 602a displayed by the first electronic device 500a in FIG. 6A (e.g., at a corresponding location in the user interface presented by the second electronic device 500b).

In some embodiments, the content application user interface displayed by the first electronic device 500a is an album page including representations 610a-610c of content items included in a respective album available through a content service associated with the content application. It should be understood that one or more examples illustrated herein with respect to the album page presented by the first electronic device 500a also apply to other types of user interfaces presented in a content application, such as playlist pages, library pages, and other user interfaces that include one or more representations of content items and/or options for initiating playback of one or more content items.

Because the first electronic device 500a is in the communication session while presenting the album page, the first electronic device 500a displays an indication 602a of the communication session. In some embodiments, the first electronic device 500a displays the indication 602a (e.g., at the location shown in FIG. 6A) while displaying user interfaces of other applications and/or other user interfaces of the content application. In some embodiments, the electronic device 500a does not display indication 602a when the first electronic device 500a displays an expanded indication of the communication session (e.g., similar to the expanded indication 616a of the communication session presented by the second electronic device 500b). In some embodiments, in response to detecting selection of indication 602a, the first electronic device 500a displays an expanded indication of the communication session (e.g., similar to the expanded indication 616a of the communication session presented by the second electronic device 500b). In some embodiments, the first electronic device 500a displays the indication 602a illustrated in FIG. 6A while the first electronic device 500a is participating in the communication session while the communication session does not include shared playback of a content item. In some embodiments, as will be described in more detail below with reference to FIG. 6E, the electronic device 500a displays a different indication 602c of the communication session while the electronic device 500a is participating in the communication session while the communication session includes shared playback of one or more content items.

The album page optionally includes an option 604a to navigate to a previously-presented user interface of the content application (e.g., an artist page associated with the artist of the album of the album page), an option 604b to add the album to the library of the user of the first electronic device 500a, an option 604c to view a menu of selectable options that cause the first electronic device 500a to perform one or more actions with respect to the album, an image 606a associated with the album (e.g., “album artwork”), an indication 606b of the name of the album, an indication 606c of the artist of the album, an option 608a that, when selected, causes the electronic device 500a to initiate playback of (e.g., all of) the content items in the album in the order in which the content items appear on the album, and an option 608b to initiate playback of (e.g., all of) the content items in the album in a shuffled order different from the order in which the content items appear on the album. In some embodiments, the album page further includes a playback control element 612a that includes an image 614a (e.g., album artwork) associated with a content item currently playing on the electronic device 500a, an indication 614c of the name of the content item currently playing on the electronic device 500a, an indication 614b of a speaker in communication with the first electronic device 500a that is being used to play back the content item, an option 614d to pause playback of the content, and an option 614e to skip the rest of the content item and play the next item of content to be played.

In some embodiments, the album page further includes representations 610a-c of the content items included in the album. In response to detecting selection of one of the representations 610a-c of the content items included in the album, the electronic device 500a optionally initiates playback of the content item corresponding to the selected representations. In some embodiments, the electronic device 500a includes a setting that, when activated (e.g., toggled on), causes the electronic device 500a to automatically play content items (e.g., in the music application) in the shared content playback mode of the communication session in response to receiving an input corresponding to a request to play a content item (e.g., in the music application) while the electronic device 500a is in a communication session that includes content sharing, such as the input illustrated in FIG. 6A. As shown in FIG. 6A, the first electronic device 500a detects selection (e.g., via contact 603a) of a representation 610b of one of the items of content included in the album. In some embodiments, if the setting to play the content item in the shared content playback mode (e.g., without further inputs) is active, the electronic device 500a initiates playback of the content item in the shared content playback mode, as shown in FIG. 6E, in response to the input illustrated in FIG. 6A without presenting a menu 620 to select between playing the content item in the shared content playback mode or playing the content item in the private content playback mode. In some embodiments, in response to the input illustrated in FIG. 6A, (e.g., in accordance with a determination that the setting to automatically play the content item in the shared content playback mode in response to the request to play the content item while in a communication session that includes content sharing is not active (e.g., toggled off)) the first electronic device 500a displays the menu 620 illustrated in FIG. 6B (e.g., as part of the process to initiate playback of the content item).

FIG. 6B illustrates a menu 620 displayed, for example, in response to the user input illustrated in FIG. 6A (e.g., in accordance with a determination that the setting to automatically play the content item in the shared content playback mode in response to the request to play the content item while in a communication session that includes content sharing is not active). The menu 620 optionally includes an option 622a to initiate playback of the content item corresponding to the representation 610b selected by the user in FIG. 6A at the first electronic device 500a in a private content playback mode of the communication session, an option 622b to initiate playback of the content item corresponding to representation 610b in a shared content playback mode of the communication session, and an option 622c to cease display of menu 620 (e.g., without initiating playback of the content item). In some embodiments, the private content playback mode of the communication session is a mode in which the first electronic device 500a plays content item(s), such as the content item corresponding to representation 610b, at the first electronic device 500a without causing the other electronic devices in shared content playback mode of the communication session to initiate playback of the content item. In some embodiments, the shared content playback mode of the communication session is a mode in which the first electronic device 500a plays content item(s), such as the content item corresponding to representation 610b, at the first electronic device and causes one or more electronic devices in the shared content playback mode of the communication session to also play the content item. As shown in FIG. 6B, the first electronic device 500a detects selection (e.g., via contact 603b) of the option 622a to play the content item corresponding to representation 610b in the private content playback mode of the communication session.

In some embodiments, in response to the input illustrated in FIG. 6B, the first electronic device 500a initiates playback of the content item corresponding to representation 610b that was selected in FIG. 6A in the private content playback mode, as shown in FIG. 6C. For example, playing the content item in the private content playback mode causes the first electronic device 500a to play the content item without causing the other electronic devices in the communication session to initiate playback of the content item.

FIG. 6C illustrates the first electronic device 500a playing the content item in response to the sequence of inputs illustrated in FIGS. 6A-6B, for example. In some embodiments, in response to initiating playback of the content item, the first electronic device 500a updates the playback control element 612a to include an indication 614g of the title of the content item that is currently playing and an image 614f of the content item that is currently playing. In some embodiments, because the first electronic device 500a is playing the content item in the private content playback mode, the first electronic device 500a continues to display the indication 602a of the communication session that indicates that the first electronic device 500a is not participating in shared media playback in the communication session. In some embodiments, the second electronic device 500b does not initiate playback of the content item when the first electronic device 500a initiates playback of the content item because the first electronic device 500a is playing the content item in the private content playback mode. If, instead, the first electronic device 500a initiated playback of the content item in the shared content playback mode of the communication session, the second electronic device 500b would initiate playback of the content item too if it is in the shared content playback mode of the communication session, as will now be described with reference to FIGS. 6D-6G.

In some embodiments, in FIG. 6D, the first electronic device 500a detects selection (e.g., with contact 603d) of option 622b in menu 620. Menu 620 is described in more detail with reference to FIG. 6B above. In some embodiments, menu 620 in FIG. 6D is displayed in response to the user input described above with reference to FIG. 6A (e.g., in accordance with a determination that the setting to automatically play the content item in the shared content playback mode in response to the request to play the content item while in a communication session that includes content sharing is not active). In some embodiments, the option 622b being selected in FIG. 6D corresponds to a request to initiate playback of the content item selected in FIG. 6A in the shared content playback mode of the communication session. In response to detecting selection of option 622b, the first electronic device 500a initiates playback of the content item selected in FIG. 6A at the first electronic device 500a and transmits an indication to the other electronic devices in the communication session to initiate playback of the content item selected in FIG. 6A too, as shown in FIG. 6E. In some embodiments, in accordance with a determination that the setting to automatically play the content item in the shared content playback mode in response to the request to play the content item while in a communication session that includes content sharing is active, the electronic device 500a initiates playback of the content item in the shared content item playback mode as shown in FIG. 6E in response to the input illustrated in FIG. 6A without displaying menu 620 illustrated in FIGS. 6B and 6D and without receiving the input illustrated in FIG. 6D.

FIG. 6E illustrates how electronic devices 500a and 500b can initiate playback of the content item selected in FIG. 6A in the shared content playback mode of the communication session in response to the input illustrated in FIG. 6D (e.g., in accordance with a determination that the setting to automatically play the content item in the shared content playback mode in response to the request to play the content item while in a communication session that includes content sharing is not active) or in response to the input illustrated in FIG. 6A (e.g., in accordance with a determination that the setting to automatically play the content item in the shared content playback mode in response to the request to play the content item while in a communication session that includes content sharing is active). In some embodiments, the first electronic device 500a can display an indication 602c of the communication session that indicates that content is being shared in the communication session and can update the playback control element 612a to include an indication 614g of the title of the content item that is playing in the shared content playback mode of the communication session, an image 614f (e.g., album artwork) associated with the content item that is playing in the shared content playback mode of the communication session, and an indication 614h of the number of users listening to the content item in the communication session. For example, the playback control element 612a in FIG. 6E includes an indication 612a that two users are listening to the content item in the shared content playback mode, such as the first electronic device 500a and another electronic device in the communication session not illustrated in FIG. 6E.

In some embodiments, the first electronic device 500a transmits an indication of the input illustrated in FIG. 6D to the other electronic devices in the communication session, including electronic device 500b (e.g., via one or more servers). In response to receiving the indication of the input, the second electronic device 500b presents an indication 624 of the input received at the first electronic device 500a, for example, as shown in FIG. 6E. The indication 624 can include an image 626a associated with the user of the first electronic device 500a (e.g., because the first electronic device 500a detected the input), an indication 626b of the content application being used to play the content item in the shared content playback mode of the communication session, an indication 626c of the user that provided the input and the title of the content item being played in the shared content playback mode of the communication session, and a selectable option 626d that, when selected, causes the second electronic device 500b to initiate playback of the content item in the shared content playback mode of the communication session. The second electronic device 500b can also present an indication 602d of the communication session that indicates that content is being shared in the communication session, even though the second electronic device 500b is not currently playing the content item in the shared content playback mode. In some embodiments, if the second electronic device 500b is already playing content in the shared content playback mode of the communication session when it receives the indication of the input in FIG. 6D, the second electronic device 500b forgoes presenting the indication 624 illustrated in FIG. 6E and instead presents an indication similar to indication 630 illustrated in FIG. 6H, indication 660a illustrated in FIG. 6Q, indications 660b and 660c in FIG. 6R, indication 660d in FIG. 6V, as will be described in more detail below.

In some embodiments, as shown in FIG. 6E, the second electronic device 500b detects selection (e.g., via contact 603e) of the selectable option 626d to play the content item in the shared content playback mode of the communication session. In some embodiments, in response to the input illustrated in FIG. 6E, the second electronic device 500b can initiate playback of the content item in the shared content playback mode from the playback position at which the other electronic devices in the communication session are currently playing the content item in the shared content playback mode of the communication session, which can be the same as or different from the beginning of the content item, if the second electronic device 500b is entitled to access content via a content (e.g., streaming, playback, browsing, library, etc.) service associated with the communication session. As shown in FIG. 6F, if the second electronic device 500b is not entitled to access content through the content service associated with the communication session, the second electronic device 500b presents a user interface from which a process to gain entitlement to access content via the content service can be initiated (e.g., without playing the content item in the shared content playback mode), as shown in FIG. 6F. For example, the second electronic device 500b is entitled to access content through the content service if a user account associated with the second electronic device 500b has an active subscription to the content service.

FIG. 6F illustrates the second electronic device 500b presenting an example user interface for gaining entitlement to access content through the content service associated with the communication session. In some embodiments, the second electronic device 500b can display the user interface illustrated in FIG. 6F in response to detecting the input illustrated in FIG. 6E while not entitled to access content through the content service associated with the communication session. For example, the user interface includes a selectable option 638a to cease display of the user interface without initiating a process to gain entitlement to the content service, an indication 638b that gaining entitlement to the content service entitles the user to play content items in the shared content playback mode of the communication session using the content service, information 638c about the terms of entitlement to the content service (e.g., subscription information for a subscription-based content service), a selectable option 638d that, when selected, causes the second electronic device 500b to initiate a process to gain entitlement to the content service, and a selectable option 638d that, when selected, causes the second electronic device 500b to present information about other subscription plans that entitle the user of the second electronic device 500b to access content through the content service associated with the communication session. In some embodiments, the content service is a subscription-based content service and the second electronic device 500b will be entitled to access content in the communication session while a user account associated with the second electronic device 500b has an active subscription to the content service. For example, selecting the selectable option 638d can cause the second electronic device 500b to initiate a process to start a free trial of the subscription to the content service. In some embodiments, the second electronic device 500b displays the indication 602d of the communication session with shared content while presenting the user interface related to gaining entitlement to the content service associated with the communication session.

As shown in FIG. 6F, in some embodiments, the second electronic device 500b detects selection (e.g., via contact 6030 of the selectable option 638d to initiate the process to gain entitlement to the content service associated with the communication session. In some embodiments, in response to the input, the second electronic device 500b initiates the process to gain entitlement to the content service associated with the communication session. In some embodiments, the process to gain entitlement to the content service includes initiating a free trial and collecting payment information to pay to maintain the subscription after the free trial period ends.

FIG. 6G illustrates an example of the first electronic device 500a and second electronic device 500b playing a content item in the shared playback mode of the communication session. In some embodiments, the second electronic device 500b displays the user interface illustrated in FIG. 6G and initiates playback of the content item in the shared content playback mode of the communication session automatically after completing the process to gain entitlement to the content service associated with the communication session (e.g., after performing the process initiated in response to the input illustrated in FIG. 6F). In some embodiments, if the second electronic device 500b is entitled to access content through the content service associated with the communication session when the indication of the input illustrated in FIG. 6D is received, the second electronic device 500b initiates playback of the content item in the shared content playback mode and displays the user interface illustrated in FIG. 6G in response to detecting the input illustrated in FIG. 6E without performing the process to gain access to the content service associated with the communication session. In some embodiments, the second electronic device 500b does not present the user interface illustrated in FIG. 6G in response to the input illustrated in FIG. 6E (e.g., and performing the process to access the content service associated with the communication session) and, instead, presents the user interface illustrated in FIG. 6G in response to detecting one or more inputs corresponding to a request to display a user interface of the content application associated with (e.g., the content service associated with) the communication session.

In some embodiments, as shown in FIG. 6G, in response to (e.g., receiving an indication of) the first electronic device 500a initiating playback of the content item in the shared content playback mode of the communication session, the first electronic device 500a updates the indication 614i of the number of users listening to the content in the shared content playback mode of the communication session. For example, if two devices were playing the content item in the shared content playback mode prior to the second electronic device 500b initiating playback of the content item in the shared content playback mode and, now that the second electronic device 500b is also playing the content in the shared content playback mode, the first electronic device 500a can present an indication 614i that three devices are playing the content in the shared content playback mode of the communication session.

FIG. 6G illustrates the second electronic device 500b presenting an example user interface of a content application associated with the content service associated with the communication session while playing the content item in the shared content playback mode of the communication session. In some embodiments, while presenting the user interface, the second electronic device 500b presents the indication 602d of the communication session including shared content playback. In some embodiments, the user interface includes an image 628a associated with the content item that is currently playing, an indication 628b of the title of the content item, an indication 628d of the artist of the content item, a selectable option 628c that, when selected, causes the electronic device 500b to present a menu of actions associated with the content item, a selectable option 628f to skip to the beginning of the content item (or, if selected again, to skip to a previously-played content item), a selectable option 628g to pause the content item, a selectable option 628h to skip to the next content item in a shared content item queue, a slider 628i for controlling the playback volume of the content item, a selectable option 628j to view time-synched lyrics of the content item, a selectable option 628k to view audio output options for playback of the content item, and a selectable option 628m to view the shared playback queue. In some embodiments, as will be described in more detail with reference to FIGS. 6O-6X, while one or more electronic devices are playing content in the shared content playback mode of the communication session, the electronic devices have access to a shared content item queue of content items to be played in the shared content playback mode.

As shown in FIG. 6G, in some embodiments, the second electronic device 500b detects selection (e.g., via contact 603g) of the selectable option 628g to pause the content item that is currently playing. In response to the input illustrated in FIG. 6G, in some embodiments, all of the electronic devices playing the content item in the shared content playback mode of the communication session pause playback of the content item, as shown in FIG. 6H. In some embodiments, the second electronic device 500b transmits an indication of the input illustrated in FIG. 6G (e.g., via one or more servers) to the other electronic devices in the communication session and the other electronic devices pause the content item in response to receiving the indication.

For example, FIG. 6H illustrates the first electronic device 500a and second electronic device 500b after pausing playback of the content item in the shared content playback mode of the communication session in response to (e.g., the indication of) the input illustrated in FIG. 6G. In some embodiments, in response to receiving the indication of the input, the first electronic device 500a pauses playback of the content item, updates the playback control element 612a to include an option 614j to resume playback of the content item (e.g., in place of the option 614d to pause the content item displayed while the content item was playing, such as in FIG. 6G), and displays an indication 630 of the input to pause the content. In some embodiments, the indication 630 of the input to pause the content includes an image 632a associated with the user of the second electronic device 500b and text 632b that indicates the name of the user that paused the content and that the user paused the content. In some embodiments, the first electronic device 500a continues to display the indication 602c of the communication session including shared content playback. In some embodiments, because the first electronic device 500a received the indication of the input while displaying a user interface associated with (e.g., the content application associated with) the content service associated with the communication session, the indication 630 does not include an indication of the content application and is not selectable to display a user interface of the content application. In some embodiments, as will be described in more detail below with reference to FIG. 6I, if the indication of the input to pause the content had been received by the first electronic device 500a while the first electronic device 500a was presenting a user interface other than a user interface of the content application associated with the communication session, the indication would include an indication of the content application and would be selectable to display a user interface of the content application associated with the communication session.

As shown in FIG. 6H, in some embodiments, in response to detecting the input to pause the content, the second electronic device 500b pauses the content and updates the user interface to include a selectable option 628n to resume playback of the content item in the shared content playback mode. In some embodiments, the second electronic device 500b displays the selectable option 628n to resume playback of the content item illustrated in FIG. 6H at the same location at which the second electronic device 500b displayed the selectable option 628g to pause the content item illustrated in FIG. 6G. In some embodiments, the second electronic device 500b continues to display the indication 602d of the communication session including shared content playback.

In some embodiments, the second electronic device 500b detects the indication of the input received at the first electronic device 500a to initiate playback of the content item in the shared content playback mode of the communication session illustrated in FIG. 6D while the second electronic device 500b does not have access to the content application associated with the communication session. For example, the content application is not downloaded and/or installed on the second electronic device 500b when the second electronic device 500b receives the indication of the input to initiate playback of the content item in the shared content playback mode of the communication session. In some embodiments, as shown in FIG. 6I, in response to receiving the indication of the input received at the first electronic device 500a to initiate playback of the content item in the shared content playback mode while the second electronic device 500b does not have access to the content application associated with the communication session, the second electronic device 500b presents the indication 634 of the input to initiate playback of the content item in the shared content playback mode.

As shown in FIG. 6I, in some embodiments, the second electronic device 500b presents indication 634 in response to receiving the indication of the input received at the first electronic device 500a to initiate playback of the content item in the shared content playback mode while the second electronic device 500b does not have access to the content application associated with the communication session. In some embodiments, the indication 634 illustrated in FIG. 6I can be the same as the indication 624 illustrated in FIG. 6E that the second electronic device 500b presents in response to receiving the indication of the input to initiate playback of the content item in the shared content playback mode while the second electronic device 500b has access to the content application associated with the communication session, except indication 624 includes the selectable option 626d to initiate playback of the content item in the shared content playback mode (e.g., after gaining access to the content service) and indication 634 includes a selectable option 636d to initiate a process to gain access to the content application associated with the communication session. In some embodiments, in response to detecting selection of selectable option 636d, the second electronic device 500b presents an application store user interface that includes a selectable option that, when selected, causes the second electronic device 500b to initiate a process to access the content application associated with the communication session, such as a process to download and/or install the content application. In some embodiments, once the second electronic device 500b has access to the content application associated with the communication session, the second electronic device 500b is able to play content items in the shared content playback mode of the communication session.

In some embodiments, the content service associated with the communication session provides access to a variety of different types of content. For example, a music content service provides access to songs, albums, playlists, and live radio stations. In some embodiments, it is not possible to play all of the types of content in the shared content playback mode of the communication session. For example, it may be possible to play songs, albums, and playlists in the shared content playback mode but not possible to play live radio stations in the shared content playback mode.

FIG. 6J illustrates the first electronic device 500a and the second electronic device 500b presenting a user interface of the content application associated with the communication session for playing live radio stations according to some embodiments. In some embodiments, the user interface includes an indication 640j of the name of the radio station, an option 640k to view a schedule of live programming for the radio station, an image 640m and 640a associated with a live radio show that is currently streaming, an indication 640n and 640d that the radio show is currently live and the start time of the live radio show, an indication 640p and 640e of the title of the radio show, a selectable option 640q and 640f to play the radio show, an indication 640r and 640g of a second radio station, a selectable option 640s and 640h for viewing the live broadcast schedule of the second radio station, and an image 640t and 640i associated with a radio show that is currently playing on the second radio station.

In some embodiments, in the example of FIG. 6J, the first electronic device 500a is in the private content playback mode of the communication session and the second electronic device 500b is in the shared content playback mode of the communication session. For example, because the first electronic device 500a is in the private content playback mode of the communication session, the expanded indication 616b of the communication session includes an indication 618m that the first electronic device 500a is not participating in shared content playback in the communication session and the content playback control element 612a does not include an indication (e.g., indication 614h in FIG. 6I) of the number of users listening the in shared content playback mode. As another example, because the second electronic device 500b is in the shared content playback mode, the content playback control element 612b displayed by the second electronic device 500b includes an indication 614t of the number of users listening to the content in the shared content playback mode of the communication session. In FIG. 6J, for example, the second electronic device 500b displays indication 602d of the communication session that indicates that the communication session includes shared content playback. In some embodiments, because the second electronic device 500b displays indication 602d, the second electronic device 500b does not display an expanded indication of the communication session. If, instead of displaying indication 602d, the second electronic device 500b were displaying an expanded indication of the communication session, the expanded indication of the communication session would include an indication that the second electronic device 500b is participating in shared content playback instead of the indication 618m that indicates non-participation in shared content playback in the communication session.

As shown in FIG. 6J, the first electronic device 500a can detect selection (e.g., via contact 603i) of the option 640f to initiate playback of the live radio broadcast and the second electronic device 500b can detect selection (e.g., via contact 603j) of the option 640q to initiate playback of the live radio broadcast. In some embodiments, the first electronic device 500a initiates playback of the live radio broadcast in the private content playback mode, as shown in FIG. 6K, because the first electronic device 500a is in the private content playback mode when the input is received. In some embodiments, the second electronic device 500b forgoes initiating playback of the live radio broadcast in response to the input, as shown in FIG. 6K, because it is not possible to play live radio broadcasts in the shared content playback mode and the second electronic device 500b is in the shared content playback mode when the input is received.

FIG. 6K illustrates the first electronic device 500a and the second electronic device 500b in response to the inputs illustrated in FIG. 6J according to some embodiments of the disclosure. In some embodiments, because the first electronic device 500a was in the private content playback mode of the communication session when the first electronic device 500a detected the input illustrated in FIG. 6J, the first electronic device 500a initiates playback of the live radio broadcast. For example, the electronic device 500a updates the content playback control element 612a to include an indication 614m of the title of the live radio broadcast and an image 614k associated with the live radio broadcast. In some embodiments, the first electronic device 500a continues to display the expanded indication 616b of the communication session including the indication 618m that the first electronic device 500a is not participating in shared content playback in the communication session.

In some embodiments, because the second electronic device 500b was in the shared content playback mode of the communication session when the second electronic device 500b received the input illustrated in FIG. 6J, the second electronic device 500b does not initiate playback of the live radio broadcast in FIG. 6K. In response to the input in FIG. 6K, the second electronic device 500b presents an indication 642 that it is not possible to play live radio broadcasts in the private content playback mode of the communication session while continuing to play, in the shared content playback mode, the content that is playing in the communication session, for example. In some embodiments, the indication 642 includes a selectable option 644a that, when selected, causes the second electronic device 500b to cease playback of content in the shared content playback mode and initiate playback of the live radio broadcast in the private content playback mode without modifying playback of the content item in the shared content playback mode for other electronic devices in the communication session. In some embodiments, the indication 642 further includes a selectable option 644b that, when selected, causes the second electronic device 500b to cease display of the indication 642 without initiating playback of the live radio broadcast. In some embodiments, in response to detecting selection of option 644b, the second electronic device 500b continues to play the content item in the shared content playback mode of the communication ses sion without modifying playback of the content item in the shared content playback mode of the communication session at the second electronic device 500b or any other electronic devices playing the content in the shared content playback mode of the communication session.

In some embodiments, an electronic device can temporarily transition to the private content playback mode to play a preview of a content item in response to detecting an input requesting to play the preview of the content item while the electronic device is playing content in the shared content playback mode of the communication session, as shown in FIGS. 6L-6N. In this way, the user of the electronic device is able to preview a song privately, for example, before playing the song in the shared content playback mode of the communication session.

For example, in FIG. 6L, the first electronic device 500a displays the album page described above with reference to FIG. 6A while playing content in the shared content playback mode of the communication session and the second electronic device 500b presents the playback user interface described above with reference to FIG. 6G while playing content in the shared content playback mode of the communication session. In some embodiments, because both the first electronic device 500a and the second electronic device 500b are playing content in the shared content playback mode, the first electronic device 500a and second electronic device 500b play the same item of content with synchronized playback (e.g., the first electronic device 500a and second electronic device 500b are playing the content item with the same playback position). While playing the content item in the shared content playback mode, the first electronic device 500a detects a secondary selection (e.g., via contact 603L) of one of the representations 610c of an item of content in the album, for example. In some embodiments, secondary selection can be a long press, a force tap, a right click, or similar input. In response to detecting the secondary selection in FIG. 6L, the first electronic device 500a can display the menu illustrated in FIG. 6M in some embodiments.

In some embodiments, as shown in FIG. 6M, the first electronic device 500a displays menu of selectable options 646a-i related to the content item corresponding to representation 610c in response to the input illustrated in FIG. 6L. For example, the menu includes an option 646a to add the content item to a library of the user account associated with the first electronic device 500a, an option 646b to initiate a process to add the content item to a playlist, an option 646c to add the content item to the beginning of a (e.g., shared) content item playback queue, an option 646d to add the content item to the end of a (e.g., shared) content item playback queue, an option 646e to play a preview of the content item, an option 646f to initiate a process to share the content item with another user account or electronic device, an option 646g to view the full lyrics of the content item, and option 646h to create a radio station including content similar to (e.g., same or similar genre, artist, etc.) the content item, and an option 646i to designate the content item as a content item that the user of the first electronic device 500a “loves”. As shown in FIG. 6M, in some embodiments, the first electronic device 500a detects selection of the option 646e to play a preview of the content item. In some embodiments, the first electronic device 500a forgoes display of option 646e if the secondary selection of the representation 610c of the content item is detected while the first electronic device 500a is not in the shared content playback mode of the communication session, either because the first electronic device 500a is in the private content playback mode of the communication session or because the first electronic device 500a is not participating in a communication session. In some embodiments, in response to detecting selection of option 646e, the first electronic device 500a plays a preview of the content item in the private content playback mode without causing the other electronic devices playing content in the shared content playback mode of the communication session to play the preview of the content item. In some embodiments, the preview of the content item is a predetermined portion (e.g., subset) of the content item. For example, the preview of the content item is a thirty-second sample of the content item. In some embodiments, the user is able to request to preview a song by selecting an icon or image included in the representation 610c of the song associated with a preview of that song (e.g., while the electronic device 500a is in the shared content playback mode of the communication session). In some embodiments, the user does not need to cause the electronic device 500a to display options 6246a-i to preview the song and can instead select the icon or image associated with the preview of the song. In some embodiments, in response to selection of the icon or image associated with the preview of the song included in the representation 610c of the song, the electronic device 500 initiates playback of the preview of the song. In some embodiments, in response to selection of a portion of the representation 610c of the song different from the icon or image associated with the preview of the song, the electronic device 500 presents the user interface in FIG. 6D, FIG. 6M, FIG. 6P, or initiate playback of the song.

For example, FIG. 6N illustrates the first electronic device 500a playing the preview of the content item in the private content playback mode while the second electronic device 500b continues to play another content item in the shared content playback mode. In some embodiments, while playing the preview of the content item, the first electronic device 500a updates the playback control element 612a to include an indication 614p of the title of the content item and an image 614n corresponding to the content item. In some embodiments, because the second electronic device 500b continues to play the content item in the shared playback mode of the communication session, the second electronic device 500b continues to display the playback user interface illustrated in FIG. 6M. In some embodiments, after the first electronic device 500a finishes playing the preview of the content item, the first electronic device 500a automatically resumes playback of content in the shared content playback mode from a playback position later than the playback position at which the first electronic device ceased playing the content in the shared content playback mode (e.g., to remain synchronized with playback of the content at the other electronic devices in the communication session that continued to play content in the shared content playback mode while the first electronic device 500a was playing the preview of the other content item in the private content playback mode).

In some embodiments, the electronic devices in the communication session play content from a shared content playback queue when playing content items in the shared content playback mode. In some embodiments, the shared content playback queue includes a plurality of content items in an ordered list and the electronic devices play the content items in the order of the queue, automatically playing the next content item after each content item finishes playing. In some embodiments, all of the users in the communication session (e.g., that are playing content in the shared content playback mode) are able to edit the queue, including adding content items to the queue, removing content items from the queue, and reordering the content items in the queue. FIGS. 6O-6X illustrate examples of the electronic devices in the communication session interacting with the shared content item queue according to some embodiments.

In some embodiments, as shown in FIG. 6O, the second electronic device 500b displays the shared content item queue of the communication session. For example, the second electronic device 500b displays an indication 648e of the queue including the name of the group in the communication session, an option 648f to play content in a shuffled order, an option 648g to repeat a sequence of content, an option 648h to automatically play additional content after playing all of the content items in the queue, a plurality of representations 650a-c of content items in the queue, an indication 654 of content items that will play after all of the content items in the queue have been played, and representations 650d-e of content items that will play after all of the content items in the queue have been played. In some embodiments, representation 650a of a content item in the shared content item queue includes an image 652a associated with the content item, a representation 652b of the user that added the content item to the queue, an indication 652c of the title of the content item, and a user interface element 652d for dragging the content item to a different position in the queue. In some embodiments, representations 650b and 650c include similar elements as representation 650a. In some embodiments, representation 650d of a content item that will play after all of the content items in the queue have been played includes an image 652e associated with the content item, an indication 652f of the title of the content item, and a user interface element 652g that can be dragged to change the playback position of the content item relative to other content items in the queue or in the list of items to be played after all of the items in the queue have been played. In some embodiments, the content items to be played after playing all of the items in the shared content playback queue are selected (e.g., by one or more of the electronic devices in the communication session and/or one or more servers in communication with the electronic devices in the communication session) based on the content items in the shared content item queue and/or the content consumption histories of the users in the communication session.

In some embodiments, while displaying the representations 650a-c of content items in the queue and representations 650d-e of content items that will play after all of the content items in the queue have been played, the second electronic device 500b also displays an image 648a associated with the content item that is currently playing, an indication 648b of the content item that is currently playing, an indication 648c of the artist of the content item that is currently playing, an option 648d that, when selected, causes the second electronic device 500b to present a plurality of options of actions to be performed with respect to the content item that is currently playing on the second electronic device 500b, and the indication 602d of the communication session that indicates that the communication session includes shared playback of content.

In some embodiments, as shown in FIG. 6O, the first electronic device 500a displays the album page user interface described in more detail above with reference to FIG. 6A while playing a content item in the shared content playback mode of the communication session. As shown in FIG. 6O, in some embodiments, the first electronic device 500a detects selection (e.g., via contact 603n) of a representation 610c of a content item. In some embodiments, in response to the input illustrated in FIG. 6O, the first electronic device 500a displays a plurality of options for initiating playback of the content item in the shared content playback mode.

FIG. 6P illustrates an example of the user interface presented by the first electronic device 500a in response to the input illustrated in FIG. 6O according to some embodiments. In some embodiments, in response to the input illustrated in FIG. 6O, the first electronic device 500a presents menu 656a including options 658a-d. In some embodiments, the menu 656 includes an option 658a to initiate playback of the content item in the shared content playback mode now (e.g., and ceasing playback of the content item that is currently playing in the shared content playback mode), an option 658a to add the content item to the beginning of the shared content item queue, an option 658c to add the content item to the end of the shared content item queue, and an option 658d to cease display of menu 656 without adding the content item to the queue or initiating playback of the content item. In some embodiments, initiating playback of the content item in the shared content playback mode causes all of the electronic devices playing content in the shared content playback mode of the communication session to initiate playback of the content item. As shown in FIG. 6P, in some embodiments, the first electronic device 500a detects selection (e.g., via contact 603p) of the option 658b to add the content item to the beginning of the shared content item queue. In some embodiments, in response to the input illustrated in FIG. 6P, the electronic devices in the communication session add the content item to the shared content playback queue, as shown in FIG. 6Q.

For example, FIG. 6Q illustrates the second electronic device 500b presenting the shared content playback queue after adding the content item to the queue in response to the input detected at the first electronic device 500a in FIG. 6P in accordance with some embodiments. As shown in FIG. 6Q, the second electronic device 500b presents a representation 650f of the content item selected by the first electronic device 500a at the top of the shared content item queue, for example. In some embodiments, in response to receiving an indication of the input received at the first electronic device 500a, the second electronic device 500b presents an indication 660a of the input. The indication 600a can include, for example, an indication 662a of the user of the first electronic device 500a, and an indication 662b of the title of the content item added to the queue by the user of the first electronic device 500a. In some embodiments, the second electronic device 500a displays the indication 660a because the second electronic device 500a is displaying a user interface of the content application associated with (e.g., the content service associated with) the communication session. In some embodiments, a third electronic device 500c that is also participating in the communication session does not display an indication of the first electronic device 500a adding the content item to the queue because the third electronic device 500c is not displaying a user interface of the content application when the third electronic device 500c receives the indication of the input received at the first electronic device 500a. In some embodiments, electronic devices in the communication session display indications of a first subset of actions with respect to the shared content playback mode (e.g., changes to the shared content item playback queue) only while displaying a user interface of the content application. In some embodiments, electronic devices in the communication session display indications of a second subset of actions with respect to the shared content playback mode (e.g., changes to playback of the item currently playing, such as playing, pausing, and/or skipping content items or within a content item) irrespective of the user interface the electronic devices are displaying when the indication of the input is received.

For example, as shown in FIG. 6Q, the first electronic device 500a detects selection (e.g., via contact 603q) of an option 614d to pause the content item currently playing in the shared content playback mode. In response to (e.g., an indication of) the input, the electronic devices in the communication session pause playback of the content item in the shared content playback mode of the communication session in some embodiments. In some embodiments, electronic devices 500b and 500c present visual indications of the input received by the first electronic device 500a in response to receiving the indication of the input received by the first electronic device 500a, as shown in FIG. 6R.

In FIG. 6R, the second electronic device 500b presents indication 660b of the input and the third electronic device 500c presents indication 660c of the input in response to receiving an indication of the input detected by the first electronic device 500a in FIG. 6Q. In some embodiments, the second electronic device 500b presents indication 660b while displaying a user interface of the content application associated with the communication session. For example, the indication 660b includes an indication 662a of the user of the first electronic device 500a and an indication 662f that the user of the first electronic device 500a paused the playback of the content in the shared content playback mode. In some embodiments, the third electronic device 500c presents indication 660c while displaying a home screen user interface, which is not a user interface of the content application associated with the communication session. For example, the indication 660c includes the indication 662a of the user of the first electronic device 500a and the indication 662f that the user of the first electronic device 500a paused playback of the content in the shared content playback mode, similar to indication 660b. In some embodiments, indication 660c further includes an indication 662c of the content application associated with the communication session because the indication 660c is displayed while the third electronic device 500c is displaying a user interface that is not a user interface of the content application associated with the communication session. In some embodiments, because indication 660c is displayed while the third electronic device 500c is not displaying a user interface of the content application associated with the communication session, indication 660c is selectable to display a user interface of the content application associated with the communication session. In some embodiments, the second electronic device 500b does not perform an action in response to detecting selection of indication 660b because the second electronic device 500b is already displaying a user interface of the content application associated with the communication session.

FIGS. 6S-6U illustrates an example of the first electronic device 500a receiving a sequence of inputs to remove a content item from the shared content playback queue according to some embodiments. For example, in FIG. 6S, the first electronic device 500a detects a swipe input (e.g., via contact 603s) on a representation 650i of a content item in the shared content item playback queue. As shown in FIG. 6T, in response to the input illustrated in FIG. 6S, the first electronic device 500a displays a selectable option 664 that, when selected, causes the first electronic device 500a to initiate the process to remove the content item from the shared content playback queue, for example. In some embodiments, as shown in FIG. 6T, the first electronic device 500a detects selection (e.g., via contact 603t) of the option 664 to initiate the process to remove the content item from the content playback queue. In response to the input illustrated in FIG. 6T, in some embodiments, the first electronic device 500a displays menu 666 illustrated in FIG. 6U. As shown in FIG. 6U, in some embodiments, the menu includes text that indicates that removing the content item from the queue will remove the content item from the queue for all users in the communication session, an option 668a that, when selected, causes the first electronic device 500a to remove the content item from the content playback queue and an option 668b to cease display of the menu 666 without removing the content item from the content playback queue. For example, in FIG. 6U, the first electronic device 500a detects selection of the option 668a to remove the content item from the content item playback queue. In response to the input illustrated in FIG. 6U, the first electronic device 500a removes the content item from the queue and the second electronic device 500a presents a visual indication of the input illustrated in FIG. 6U, as shown in FIG. 6V.

FIG. 6V illustrates the content item playback queue after removing the content item in response to the input illustrated in FIG. 6V and the second electronic device 500b presenting an indication 660d of the input received by the first electronic device 500a in FIG. 6U according to some embodiments. As shown in FIG. 6V, the first electronic device 500a and second electronic device 500b no longer display the indications 650i and 650b of the content item removed by the user of the first electronic device 500a illustrated in FIG. 6U because the content item was removed from the content playback queue. FIG. 6V also illustrates the second electronic device 500b displaying an indication 660d of the input received by the first electronic device 500a according to some embodiments. In some embodiments, the indication 660d includes an indication 662a of the user of the first electronic device 500a and text 662d indicating that the user of the first electronic device 500a removed the content item from the queue, including an indication of the title of the content item that was removed. In some embodiments, the second electronic device 500b displays the indication 660d because the second electronic device 500b is displaying a user interface associated with the content application associated with the communication session when the second electronic device 500b receives the indication of the input received at the first electronic device 500a in FIG. 6U.

In some embodiments, multiple electronic devices in the communication session receive inputs to update the shared content playback queue before the queue is updated in accordance with one or more of the inputs. For example, one of the electronic devices receives an input to update the queue after another electronic device receives an input to update the queue but before the queue is updated in accordance with the input that was received first. In this situation, in some embodiments, the queue is updated in accordance with the input that was received (e.g., by a server in communication with the electronic devices in the communication session) first without being updated in accordance with inputs received after the first-received input (but before the change to the queue is made in accordance with the first-received input).

FIG. 6W illustrates an example of the first electronic device 500a and the second electronic device 500b receiving inputs to reorder the content items in the shared content item playback queue according to some embodiments. For example, the first electronic device 500a detects a swipe input (e.g., via contact 603v) starting from a user interface element 652h for changing the position of a content item associated with representation 640h within the shared playback queue and the second electronic device 500b detects a swipe input (e.g., via contact 603w) starting from a user interface element 652i for changing the position of a content item associated with representation 650c within the queue. In some embodiments, the first electronic device 500a detects the input of contact 603v after the second electronic device 500b detects the input of contact 603w but before the queue is reordered in response to the input detected at the second electronic device 500b. In some embodiments, in response to the inputs illustrated in FIG. 6W, the electronic devices 500a and 500b (and any other electronic devices playing content in the shared content playback mode of the communication session) re-order the content items in the queue in accordance with the input detected at the second electronic device 500b, as shown in FIG. 6X.

FIG. 6X illustrates an example of the updated shared content playback queue in response to the inputs illustrated in FIG. 6W according to some embodiments. In some embodiments, because the first electronic device 500a received an input to re-order the content playback queue after the second electronic device 500b received an input to re-order the content playback queue but before the content playback queue was reordered in response to the input received by the second electronic device 500b, the content playback queue is reordered in accordance with the input received by the second electronic device 500b without being reordered in accordance with the input received by the first electronic device 500a. For example, as shown in FIG. 6X, representation 650c of “Groovy Tune” is above representation 650a of “Rock Song,” as requested by the user of the second electronic device 500b in FIG. 6X. In some embodiments, if the second electronic device 500b had received the input illustrated in FIG. 6W after the first electronic device 500a had received the input illustrated in FIG. 6W, but before the queue had been updated in accordance with the input received by the first electronic device 500a, then the queue would have been updated in accordance with the input received by the first electronic device 500a without being updated in accordance with the input received by the second electronic device 500b. For example, representation 650h of “Rock Song” would be above representation 650g of “Upbeat Jam”.

In some embodiments, one or more (e.g., user accounts associated with) electronic devices participating in the communication session are subject to content playback restrictions, such as parental control restrictions that restrict playback of explicit content or content having one or more specified parental control ratings. In some embodiments, an electronic device subject to content playback restrictions is not able to play content in the shared content playback mode of a communication session if the shared content playback of the communication session has fewer restrictions than the restrictions enforced on the electronic device. In some embodiments, shared content playback of a communication session is subject to the content playback restrictions in place on the electronic device that initiated the communication session. In some embodiments, shared content playback of a communication session is subject to content playback restrictions in place on the electronic device that initiated shared content playback in the communication session. For example, if (e.g., shared content playback of) a communication session is initiated by an electronic device without content playback restrictions, then electronic devices subject to content playback restrictions are unable to participate in shared content playback in the communication session. As another example, if (e.g., shared content playback of) a communication session is initiated by an electronic device subject to content playback restrictions, then only content that is not restricted by those content playback restrictions can be played in the shared content playback mode of the communication session, even by electronic devices that are not subject to content playback restrictions. In some embodiments, an electronic device that is subject to content playback restrictions is not able to join a communication session initiated by an electronic device that is subject to more lenient content playback restrictions (or not subject to content playback restrictions at all).

FIGS. 6Y-6Z illustrate examples of enforcement of content playback restrictions when playing content in the shared content playback mode of a communication session according to some embodiments. In these examples, the first electronic device 500a is subject to fewer content playback restrictions than the content playback restrictions enforced on the second electronic device 500b. For example, the content playback restriction settings (if any) of the first electronic device 500a allow the first electronic device 500a to play explicit music and the content playback restriction settings of the second electronic device 500b prevent the second electronic device 500b from playing explicit music.

For example, in FIG. 6Y, the first electronic device 500a and second electronic device 500b are participating in a communication session that has the same content playback restriction settings as the content playback restriction settings active on the first electronic device 500a, which are more lenient than the content playback restriction settings active on the second electronic device 500b. In some embodiments, the content playback restriction settings of the shared content playback mode of the communication session match the content playback restriction settings of the first electronic device 500a because the first electronic device 500a initiated (e.g., shared content playback in) the communication session.

In some embodiments, in FIG. 6Y, the first electronic device 500a presents a playlist page of the content application associated with (e.g., a content service associated with) the communication session. The playlist page can include an option 670a to navigate to a previously-displayed user interface of the content application, an option 670c to display a menu including a plurality of selectable options for performing actions with respect to the playlist, an image 672a associated with the playlist, an indication 672b of the title of the playlist, an indication 672b of the user that created the playlist, an option 674a to initiate playback of the playlist in the predetermined order of the playlist, an option 674b to initiate playback of the playlist in a shuffled order different from the predetermined order of the playlist, and a plurality of representations 676a-c of content items in the playlist that are selectable to initiate playback of the content item corresponding to the selected representation. In some embodiments, the first electronic device 500a presents the indication 602c of the communication session including shared content playback and the content playback control element 612a while displaying the playlist page. In some embodiments, the content item corresponding to representation 676b includes an indication 682 that the content item is an explicit content item. In some embodiments, the content playback restriction setting active on the first electronic device 500a allows the first electronic device 500a to play explicit content and the shared playback mode of the communication session has the same content playback restriction setting as the first electronic device 500a, so representation 676b is selectable to play the corresponding content item in the shared content playback mode of the communication session.

In some embodiments, because the content playback restriction setting of the second electronic device 500b does not allow the second electronic device 500b to play explicit content and the content playback restriction setting of the shared playback mode of the communication session allows playback of explicit content, the second electronic device 500b is not able to play content in the shared content playback mode of the communication session. In some embodiments, the second electronic device 500b presents an indication 684 that the second electronic device 500b is not able to play content in the shared content playback mode of the communication session because the content playback restriction setting of the second electronic device 500b is more restrictive than the content playback restriction setting of the shared playback mode of the communication session. In some embodiments, the indication 684 includes a selectable option 686 that, when selected, causes the electronic device 500b to cease display of the indication 684 without initiating playback of content in the shared content playback mode of the communication session and without modifying content playback restriction settings of the second electronic device 500b.

In some embodiments, the second electronic device 500b is able to join the communication session but is not able to play content in the shared content playback mode of the communication session because the content playback restriction setting of the second electronic device 500b is more restrictive than the content playback restriction setting of the shared playback mode of the communication session. In some embodiments, because the second electronic device 500b is participating in the communication session, the second electronic device 500b presents the indication 602d of the communication session. In some embodiments, indication 684 is presented in response to initiation of content playback in the shared content playback mode of the communication session (e.g., in response to detecting an indication of the input received at the first electronic device 500a in FIG. 6D). In some embodiments, indication 684 is presented in response to receiving an input at the second electronic device 500b requesting to join shared content playback in the communication session, such as the input received at the second electronic device in FIG. 6E.

In some embodiments, the second electronic device 500b is not able to join the communication session because the content playback restriction setting of the second electronic device 500b is more restrictive than the content playback restriction setting of the shared playback mode of the communication session. If the second electronic device 500b is not able to join the communication session, then the second electronic device 500b would not display the indication 602d of the communication session while displaying indication 684 in some embodiments. In some embodiments, indication 684 is presented in response to detecting an input at the second electronic device 500b corresponding to a request to join the communication session.

In some embodiments, in FIG. 6Z, the first electronic device 500a and second electronic device 500b are participating in a communication session that has the same content playback restriction settings as the content playback restriction settings active on the second electronic device 500b, which are more restrictive than the content playback restriction settings active on the first electronic device 500a. In some embodiments, the content playback restriction settings of the shared content playback mode of the communication session match the content playback restriction settings of the second electronic device 500b because the second electronic device 500b initiated (e.g., shared content playback in) the communication session.

In some embodiments, in FIG. 6Z, the first electronic device 500a displays the playlist page described above with reference to FIG. 6Y. In FIG. 6Z, however, the representation 676d of the explicit content item is not selectable because the shared content playback mode of the communication session does not allow playback of explicit content even though the first electronic device 500a is not restricted from playing explicit content (e.g., when not in the communication session or when in the private content playback mode). In some embodiments, because the content playback restriction setting of the first electronic device 500a allows the first electronic device 500a to play explicit content, if the first electronic device 500a was in the private content playback mode, representation 676d would be selectable to initiate playback of the content item in the private content playback mode.

In some embodiments, in FIG. 6Z, the second electronic device 500b is able to play content in the shared content playback mode of the communication session because the content playback restriction setting of the communication session is not more lenient than the content playback restriction setting of the second electronic device 500b. In some embodiments, the second electronic device 500b does not display in the indication illustrated in FIG. 6Y because the second electronic device 500b is not prevented from joining (e.g., shared content playback of) the communication session. Because the second electronic device 500b is playing content in the shared content playback mode (e.g., along with the first electronic device 500b and another electronic device in the communication session), the first electronic device 500a presents an indication 614i that three users are playing content in the shared content playback mode in FIG. 6Z. In some embodiments, in FIG. 6Y, only the first electronic device 500a and another electronic device not shown in FIG. 6Y are playing content in the shared content playback mode because the second electronic device 500b is not able to play content in the shared content playback mode, so the first electronic device 500a presents an indication 614h that two users are playing content in the shared content playback mode.

In some embodiments, while an electronic device is not participating in a communication session, initiating playback of a content item on the electronic device does not cause playback to be initiated on other electronic devices participating in a communication session. For example, in FIG. 6AA, the first electronic device 500a is not participating in a communication session while the second electronic device 500b is participating in a communication session. In some embodiments, as shown in FIG. 6AA, the first electronic device 500a displays the album page described above with reference to FIG. 6A. Because the first electronic device 500a is not in a communication session, the first electronic device 500a does not display an indication of the communication session in FIG. 6AA, such as indication 602a illustrated in FIG. 6A, for example. In some embodiments, in FIG. 6AA, the second electronic device 500b is currently playing a content item in the shared content playback mode of the communication session in which the second electronic device 500b is participating. Because the second electronic device 500b is in a communication session that includes shared content playback, the second electronic device 500b displays an indication 602d of the communication session including shared content playback, for example. In some embodiments, the first electronic device 500a and second electronic device 500b are playing different items of content. For example, the first electronic device 500a presents an indication 614c of the item of content playing at the first electronic device 500a while the first electronic device 500a is not participating in a communication session and the second electronic device 500b displays an indication 628b of the content item the second electronic device 500b is playing the shared content playback mode of the communication session.

As shown in FIG. 6AA, the first electronic device 500a detects selection (e.g., via contact 603aa) of a representation 610a of an item of content. In some embodiments, in response to the input illustrated in FIG. 6AA, the first electronic device 500a initiates playback of the content item corresponding to the selected representation 610a without causing any other electronic devices to initiate playback of the content item (e.g., because the first electronic device 500a is not in a communication session, so the first electronic device 500a cannot be in a shared content playback mode of the communication session), as shown in FIG. 6BB. In some embodiments, the first electronic device 500a forgoes presenting a menu similar to the menu 620 illustrated in FIG. 6D that was displayed in response to the user input illustrated in FIG. 6A because the first electronic device is not in a communication session when selection of option 610a is received in FIG. 6AA. In some embodiments, the first electronic device 500b forgoes presenting a menu similar to the menu 656 illustrated in FIG. 6P that was displayed in response to the user input illustrated in FIG. 6O because the first electronic device 500a is not in a communication session (and, therefore, not in a shared playback mode of a communication session) when selection of option 610a is received in FIG. 6AA.

In some embodiments, as shown in FIG. 6BB, in response to the input illustrated in FIG. 6AA, the first electronic device 500a initiates playback of the content item corresponding to representation 610a. As shown in FIG. 6BB, the first electronic device 500a updates the playback control element 612a to include an image 614q (e.g., album artwork) corresponding to the content item and an indication 614r of the title of the content item while playing the content item in response to the input illustrated in FIG. 6AA. In some embodiments, the second electronic device 500b continues to play the content in the shared content playback mode of the communication session and does not play the content item selected at the first electronic device 500a in FIG. 6AA because the first electronic device 500a is not in a communication session with the second electronic device 500b when the input in FIG. 6AA was received.

In some embodiments, while an electronic device is not in a communication session or is playing content in a private content playback mode of a communication session, the electronic device plays content from a private content queue that is different from the shared content queue from which electronic devices in the shared playback mode of a communication session play content. For example, in FIG. 6CC, the first electronic device 500a is not in a communication session and displays a private content playback queue and the second electronic device 500b is in the shared content playback mode of a communication session and displays a shared content playback queue.

In some embodiments, as shown in FIG. 6CC, the second electronic device 500b presents the shared content playback queue, which can be similar to the shared content playback queue described above with reference to FIG. 6O. In FIG. 6CC, in some embodiments, the private content playback queue displayed by the first electronic device 500a can include an indication 688e of the queue, an option 688f for playing content in a shuffled order, an option 688g for repeating playback of content items, an option 688h to play additional content items after playing all of the content items in the queue, and representations 690a-f of content items in the private content playback queue. In some embodiments, the indication 688e of the private content playback queue does not include an indication of a name of a communication session, such as the indication 648e displayed by the second electronic device 500b because the first electronic device 500a is not in a communication session and/or the first electronic device 500a is not sharing the queue with other electronic devices in a communication session (e.g., if the first electronic device is in the private content playback mode of the communication session while displaying the private content playback queue). In some embodiments, the representations 690a-f of content items in the private content playback queue do not include indications of the user that added the content items to the queue, as is the case for the representations 650a, 650c, and 650f in the shared content playback queue displayed by the second electronic device. In some embodiments, when the mode to play content items after all of the content items in the private content item queue have been played is active on the first electronic device 500a, the first electronic device 500a selects content items to play after the content items in the queue based on the content items in the private content item queue and/or based on the content consumption history of the first electronic device 500a without being based on the content consumption history of other electronic devices. It should be understood that, in some embodiments, if the first electronic device 500a is displaying the private queue while in the private content playback mode of a communication session, the first electronic device 500a presents a visual indication of the communication session, such as indication 602a in FIG. 6A if shared content playback is not occurring in the communication session or indication 602c in FIG. 6E if shared content playback is occurring in the communication session (e.g., amongst the other electronic devices in the communication session).

FIG. 7 is a flow diagram illustrating a method of playing content items at an electronic device in a manner synchronized with playback of the content item at other electronic devices of other users in accordance with some embodiments. The method 700 is optionally performed at an electronic device such as device 100, device 300, device 500, device 500a, device 500b, and 500c as described above with reference to FIGS. 1A-1B, 2-3, 4A-4B and 5A-5H. Some operations in method 700 are, optionally combined and/or order of some operations is, optionally, changed.

As described below, the method 700 provides ways in which an electronic device plays content items at an electronic device in a manner synchronized with playback of the content item at other electronic devices of other users. The method reduces the cognitive burden on a user when interacting with a user interface of the device of the disclosure, thereby creating a more efficient human-machine interface. For battery-operated electronic devices, increasing the efficiency of the user's interaction with the user interface conserves power and increases the time between battery charges.

In some embodiments, method 700 is performed at an electronic device in communication with one or more input devices (e.g., a mobile device (e.g., a tablet, a smartphone, a media player, or a wearable device), a computer (e.g., a desktop computer, a laptop computer), or a wearable device (e.g., a watch, a head-mounted device), optionally in communication with one or more of a mouse (e.g., external), trackpad (optionally integrated or external), remote control device (e.g., external), another mobile device (e.g., separate from the electronic device), a handheld device (e.g., external), and/or a controller (e.g., external, etc.), or a set-top box in communication one or more input devices (e.g., a remote control)). In some embodiments, the display generation component is a display integrated with the electronic device (optionally a touch screen display), external display such as a monitor, projector, television, or a hardware component (optionally integrated or external) for projecting a user interface or causing a user interface to be visible to one or more users, etc.

In some embodiments, such as in FIG. 6G, while the electronic device (e.g., 500b) is in a communication session (e.g., a group phone call, a group videoconferencing session, a group media consumption session) with one or more second electronic devices (e.g., 500a), the one or more second electronic devices associated with one or more second users different from a user of the electronic device (702), while playback of a content item (e.g., audio content such as music, podcast, audio book or video content such as a movie, video clip, or episode of a content series) is occurring (e.g., the electronic device is playing the content item at the electronic device and/or causing the content item to be played by the other devices in the communication session, or the electronic device is playing the content item in response to the initiation of playback of the content item by another device associated with another user in the communication session), the electronic device (e.g., 500b) receives (704), via the one or more input devices, an input (e.g., 603g) corresponding to a request to modify the playback of the content item, such as in FIG. 6G. In some embodiments, the request to modify playback of the content item is a request to play/pause the content item, initiate playback of the content item, skip ahead or skip backwards within a content item, add or remove a content item from a queue of content items to be played next, skip ahead or skip back in the queue to a content item different from a content item that is currently playing.

In some embodiments, the communication session is a synchronized media and communication session in which electronic devices in the communication session are able to play content items in a manner synchronized with the other electronic devices in the shared media and communication session. In some embodiments, some or all of the electronic device in the communication session are in communication with some or all of the other electronic devices in the communication session. For example, a plurality of smartphones in a communication session together present audio and/or video captured by the other smartphones in the communication session to facilitate a group videoconference between two or more users. In some embodiments, the communication session facilitates communication between users. In some embodiments, the communication session is different from communication between two electronic devices for the purpose of presenting audio, such as a Bluetooth connection between an electronic device (e.g., smartphone, tablet, laptop, set-top box) and a speaker. In some embodiments, the communication session includes synchronized playback of content items at all of the electronic devices in the communication session. For example, while the electronic devices are in the communication session without the communication session including shared playback of content, one of the electronic devices initiates playback of a content item, which causes the content item to be played at some or all of the electronic devices in the communication session in a synchronized manner.

In some embodiments, such as in FIG. 6H, while the electronic device (e.g., 500b) is in a communication session (e.g., a group phone call, a group videoconferencing session, a group media consumption session) with one or more second electronic devices (e.g., 500a), the one or more second electronic devices (e.g., 500a) associated with one or more second users different from a user of the electronic device (e.g., 500b) (702), in response to receiving the input (706), in accordance with a determination that the input is received while the electronic device (e.g., 500b) is in a shared content playback mode of the communication session, the electronic device (e.g., 500b) modifies (708) the playback of the content item in accordance with the input at the electronic device (e.g., 500b) and at the one or more second electronic devices (e.g., 500a), such as in FIG. 6H. In some embodiments, while the electronic device is in the shared content playback mode of the communication session, the electronic device plays content that is shared in the communication session. In some embodiments, some or all electronic devices in the communication session in the shared content playback mode play the same content in a time-synchronized manner with one another. For example, if the input is an input to pause the content item, the electronic device and the one or more second electronic devices pause the content item being played at their respective devices in response to the input. In some embodiments, while one or more electronic devices in the communication session are in the shared content playback mode, one or more respective electronic devices in the communication are in a private content playback mode in which content playback at the respective electronic devices is not synchronized with (e.g., any of) the other electronic devices in the communication session.

In some embodiments, such as in FIG. 6B, while the electronic device (e.g., 500a) is in a communication session (e.g., a group phone call, a group videoconferencing session, a group media consumption session) with one or more second electronic devices (e.g., 500b), the one or more second electronic devices (e.g., 500b) associated with one or more second users different from a user of the electronic device (e.g., 500a) (702), in response to receiving the input (706), in accordance with a determination that the input is received while the electronic device (e.g., 500a) is in a private content playback mode of the communication session (different from the shared content playback mode of the communication session), such as in FIG. 6B, the electronic device (e.g., 500a) modifies (710) the playback of the content item in accordance with the input at the electronic device (e.g., 500a) without modifying the playback of the content item at the one or more second electronic devices (e.g., 500b), such as in FIG. 6C. In some embodiments, the electronic device is able to present content items not shared in the communication session while in the communication session and in the private content playback mode. In some embodiments, while the electronic device is in the private content playback mode, the one or more second electronic devices in the communication session are in the shared content playback mode. For example, while in the communication session, the one or more second electronic devices play a first content item in a synchronized manner and the electronic device plays a second content item independent from content playback at the one or more second electronic devices. For example, in response to receiving an input to pause the content, the electronic device pauses the content playing at the first electronic device without pausing the content being played by (e.g., any of) the other electronic devices in the communication session. In some embodiments, it is possible for one or more electronic devices in the communication session to be in neither the shared content playback mode nor the private content playback mode. For example, one or more electronic devices in the communication session forgo playing content while in the communication session.

The above-described manner of providing a shared content playback mode in which an input to modify playback of a content item controls playback of content on a plurality of devices in a communication session and a private playback mode in which an input to modify playback of the content item controls playback of the content item on an electronic device without controlling playback of content items on other electronic devices in the communication session provides an efficient way of maintaining content synchronization in the shared content playback mode and prevents the content playback of one or more electronic devices in the private content playback mode from interfering with content playback on the other electronic devices, which additionally reduces power usage and improves battery life of the electronic device by enabling the user to use the electronic device more quickly and efficiently.

In some embodiments, such as in FIG. 6E, while the electronic device (e.g., 500b) is in the communication session, the electronic device (e.g., 500b) receives an indication of selection of a respective content item at a respective electronic device (e.g., 500a) of the one or more second electronic devices. In some embodiments, the selection of the representation of the respective content item is detected via the one or more input devices in communication with the electronic device. In some embodiments, a respective one of the one or more second electronic devices detects selection of the representation of the respective content item and the electronic device detects an indication of the selection (e.g., received from the respective one of the one or more second electronic devices). In some embodiments, the representation of the respective content item is displayed in a user interface of a content (e.g., browsing, streaming, playback, library) application. In some embodiments, if the electronic devices in the communication session were previously playing content in the shared content playback mode of the communication session, but the content is currently paused or otherwise not playing, one of the electronic devices in the communication session detects selection of an option to resume playback of a content item that had previously been playing (e.g., a play button or option) instead of selection of (e.g., a representation of) a content item.

In some embodiments, such as in FIG. 6G, while the electronic device (e.g., 500b) is in the communication session, in response to receiving the indication of selection of (e.g., the representation of) the respective content item, the electronic device (e.g., 500b) initiates playback of the respective content item at the electronic device (e.g., 500b) (e.g., and the one or more second electronic devices). In some embodiments, if the electronic device is not already in the shared content playback mode of the communication session when the indication of selection of the respective content item is received, the electronic device initiates a process to enter the shared content playback mode in response to receiving the indication of selection of the respective content item. For example, the electronic device enters the shared content playback mode of the communication session and then initiates playback of the content item. In some embodiments, playback of the content item at the electronic device is synchronized with playback of the content item at the one or more second electronic devices. For example, playback of the content at the electronic device and the one or more second electronic devices starts at the same time. In some embodiments, while the electronic device is in the communication session and the communication session does not include shared playback of content, the electronic device receives the selection of the respective content item and, in response, presents an option to initiate shared playback (e.g., of the respective content item) in the communication session.

The above-described manner of initiating playback of a content item in response to an indication of an input to play the content item received at one of the second electronic devices provides an efficient way of presenting content in a manner synchronized with other electronic devices in the communication session, which additionally reduces power usage and improves battery life of the electronic device by enabling the user to use the electronic device more quickly and efficiently.

In some embodiments, such as in FIG. 6A, while the electronic device (e.g., 500a) is in the communication session (e.g., and while playback of the content item is not occurring in the communication session), the electronic device (e.g., 500a) receives, via the one or more input devices (e.g., from one of the one or more second electronic devices, for example via one or more servers in communication with the electronic device, the one of the one or more second electronic devices, and/or each other), an indication of a request (e.g., 603a) to initiate playback of a respective content item in the communication session. In some embodiments, the request to initiate playback of the respective content item in the communication session is a request to play the respective content item in the shared playback mode of the communication session. In some embodiments, the input is detected by the one of the one or more second electronic devices and an indication of the input is communicated to the electronic device (e.g., from the one of the one or more second electronic devices, optionally via one or more servers). In some embodiments, the electronic device is playing respective content in the private content playback mode.

In some embodiments, such as in FIG. 6B, while the electronic device (e.g., 500a) is in the communication session, in response to receiving the indication of the request to initiate playback of the respective content item in the communication session, in accordance with a determination that a user account associated with the electronic device is entitled to access the respective content item through a content (e.g., streaming, playback, library, browsing, etc.) service associated with (e.g., a content (e.g., streaming, playback, library, browsing, etc.) application associated with) the communication session, the electronic device (e.g., 500a) presents a selectable option (e.g., 622b) that, when selected, causes the electronic device (e.g., 500a) to initiate playback of the respective content item in the shared content playback mode of the communication session. In some embodiments, in response to detecting selection of the selectable option, the electronic device initiates playback of the respective content item at a playback position of the respective content item at which the content item is playing in the communication session (e.g., not necessarily at the beginning of the content item, but at the current playback position of the content item in the communication session). Thus, in some embodiments, playback of the respective content item is synchronized among the electronic devices in the shared playback mode of the communication session. In some embodiments, once the respective content item is done playing, the electronic devices in the communication session initiate playback of a next content item in a shared content item queue associated with the communication session. In some embodiments, the electronic device is entitled to access content via the content service because the user account associated with the electronic device has an active subscription to the content service and/or the subscription includes the respective content item as a content item to which access is included. In some embodiments, all of the electronic devices playing content in the communication session have active subscriptions to the content service. In some embodiments, the selectable option is presented with an indication of the user that initiated playback of the respective content item in the shared playback mode of the communication session and an indication of the (e.g., title, artist, etc. of the) respective content item.

In some embodiments, while the electronic device (e.g., 500a) is in the communication session, in response to receiving the indication of the request to initiate playback of the respective content item in the communication session, in accordance with a determination that the user account associated with the electronic device is not entitled to access the respective content item through the content (e.g., streaming, playback, library, browsing, etc.) service associated with (e.g., a content (e.g., streaming, playback, library, browsing, etc.) application associated with) the communication session, the electronic device (e.g., 500a) forgoes presenting the selectable option, such as forgoing presentation of option 622b illustrated in FIG. 6B. In some embodiments, in accordance with the determination that the user account associated with the electronic device is not entitled to access content through the content service associated with the communication session, the electronic device presents a selectable option that, when selected, causes the electronic device to initiate a process to subscribe to the content (e.g., streaming, playback, library, browsing, etc.) service associated with the communication session. For example, the electronic device is not entitled to access the respective content item because the user account of the electronic device does not have an active subscription to the content service associated with the communication session or the subscription that the user account of the electronic device has a subscription that does not include access to the respective content item. In some embodiments, one or more of the other electronic devices in the communication session that are not entitled to access content through the content service associated with the communication session are unable to play content in the shared playback mode of the communication session unless and until the electronic devices complete a process to gain entitlement to the content through the content service (e.g., by subscribing to the content service). In some embodiments, the electronic device presents visual indications of the user that initiated playback of the respective content item in the shared playback mode of the communication session and an indication of the (e.g., title, artist, etc. of the) respective content item.

The above-described manner of presenting the option to initiate playback of the respective content item in accordance with a determination that the user is entitled to access content through the content service associated with the communication session and forgoing presentation of the selectable option if the electronic device is not entitled to access content through the content service associated with the communication session provides efficient manners of joining the shared content playback mode of the communication session and indicating to the user when it is not possible to join the shared content playback mode of the communication session, which additionally reduces power usage and improves battery life of the electronic device by enabling the user to use the electronic device more quickly and efficiently.

In some embodiments, such as in FIG. 6A, while the electronic device (e.g., 500a) is in the communication session (e.g., and prior to playback of the content item occurring), the electronic device (e.g., 500a) receives, via the one or more input devices, an input corresponding to selection of a respective content item (e.g., corresponding to representation 610b). In some embodiments, the electronic device detects selection of a representation of the respective content item. In some embodiments, the electronic device detects selection of an option to initiate playback of the respective content item (e.g., a play button). For example, the electronic device was previously playing the respective content item, paused the respective content item, and then receives selection of the play option to resume playback of the respective content item. In some embodiments, the input is a voice input requesting playback of the respective content item.

In some embodiments, such as in FIG. 6B, while the electronic device (e.g., 500a) is in the communication session (e.g., and prior to playback of the content item occurring), in response to receiving the input corresponding to selection of the respective content item (e.g., corresponding to representation 610b), the electronic device (e.g., 500a) displays, via a display generation component in communication with the electronic device, a first selectable option (e.g., 622b) that, when selected, causes the electronic device to initiate playback of the respective content item in the shared content playback mode on the electronic device (e.g., 500a) and the one or more second electronic devices (e.g., 500b), such as in FIG. 6B. In some embodiments, if the electronic device is not already in the shared content playback mode (e.g., the electronic device is in the private content playback mode or is not in a playback mode associated with the communication session (e.g., the electronic device is not playing content when the input is received)), the electronic device enters the shared content playback mode of the communication session in response to detecting selection of the first selectable option. In some embodiments, one or more second electronic devices in the communication session that are in the shared content playback mode of the communication session initiate playback of the respective content item in response to receiving indication(s) of the input corresponding to selection of the respective content item. In some embodiments, one or more electronic devices in the communication session that are in the private content playback mode of the communication session forgo initiating playback of the respective content item. In some embodiments, the one or more electronic devices in the communication session in the private content playback mode present a visual indication of the initiation of playback of the respective item of content and/or a selectable option to enter the shared content playback mode of the communication session and initiate playback of the respective content item.

In some embodiments, such as in FIG. 6B, while the electronic device (e.g., 500a) is in the communication session (e.g., and prior to playback of the content item occurring), in response to receiving the input corresponding to selection of the respective content item (e.g., corresponding to representation 610b in FIG. 6A), the electronic device (e.g., 500a) displays, via a display generation component in communication with the electronic device (e.g., 500a), a second selectable option (e.g., 622a) that, when selected, causes the electronic device (e.g., 500a) to initiate playback of the respective content item in the private content playback mode on the electronic device (e.g., 500a) without initiating playback of the respective content item on the one or more second electronic devices (e.g., 500b), such as in FIG. 6B. In some embodiments, if the electronic device is not already in the private content playback mode (e.g., the electronic device is in the shared content playback mode or is not in a playback mode associated with the communication session (e.g., the electronic device is not playing content when the input is received)), the electronic device enters the private content playback mode of the communication session in response to detecting selection of the second selectable option. In some embodiments, the one or more second electronic devices in the communication session do not receive indication(s) of the input corresponding to selection of the respective content item and forgo initiating playback of the respective content item because the electronic device is playing the respective content item in the private content playback mode. In some embodiments, one or more second electronic devices in the shared content playback mode of the communication session play a second item of content while the electronic device plays the respective item of content in the private content playback mode.

The above-described manner of presenting options to play the respective content item in the shared content playback mode or in the private content playback mode provides an efficient way of confirming the playback mode to be used when selection of a content item is received, which additionally reduces power usage and improves battery life of the electronic device by enabling the user to use the electronic device more quickly and efficiently, such as by reducing user error of initiating playback in a playback mode not intended by the user, which would subsequently be reversed.

In some embodiments, the electronic device has settings that cause the electronic device to remain in the private content playback mode or to remain in the shared content playback mode while in the communication session. For example, while one of these settings is active, the electronic device forgoes presenting options to play the respective content item in the private content playback mode or the shared content playback mode in response to detecting selection of the content item and instead initiates playback in the content playback mode of the electronic device without requiring an additional input confirming the content playback mode. In some embodiments, while the setting for remaining in the shared content playback mode is active, the electronic device automatically initiates playback of selected content items selected at the electronic device and at the one or more second electronic devices in the communication session (e.g., without requiring an input confirming the content items should be played for the one or more second electronic devices in the communication session). In some embodiments, while the setting for remaining in the private content playback mode is active, the electronic device automatically initiates playback of content items selected at the electronic device without initiating playback of the content items at the one or more second electronic devices in the communication session (e.g., without requiring an input confirming the content items should not be played for the one or more second electronic devices in the communication session).

In some embodiments, the input corresponding to the request to modify playback of the content item is an input to play/pause a content item, scrub a content item, skip ahead to the next content item in a content item queue, skip back to the beginning of the content item or to a previous content item in the content queue, or change the playback position within a content item in response to detecting selection of a portion of lyrics of the content item. In some embodiments, if the input is received while the electronic device is in the shared content playback mode of the communication session, the electronic device and the one or more second electronic devices modify playback of the content item in accordance with the input. For example, while in the shared content item playback mode of the communication session, in response to detecting an input to skip ahead to the next content item in a content item queue, the electronic device and the one or more second electronic devices cease presenting the content item and initiate playback of the next content item in the content item queue.

In some embodiments, such as in FIG. 6O, while the electronic device (e.g., 500b) is in the communication session and while the electronic device (e.g., 500b) is in the shared content playback mode of the communication session, the electronic device (e.g., 500b) plays a respective content item from a shared content item queue of the communication session that includes a plurality of content items (e.g., corresponding to representations 650a-c), wherein the electronic device (e.g., 500b) and the one or more second electronic devices (e.g., 500a) are able to edit the shared content item queue. In some embodiments, after completing playback of the respective content item, the electronic device and one or more second electronic devices initiate playback of the next content item in the shared content item queue. In some embodiments, playback of content items from the content item queue continues until all of the content items in the content item queue have been played. In some embodiments, after playing all of the content items in the queue (e.g., there are no more content items in the queue), the electronic device continues playing content selected based on the content items that were in the queue and the content consumption histories of the users in the communication session and/or ceases playback of content items. In some embodiments, editing the shared content item queue includes adding or removing content items from the queue and/or reordering the content items in the queue.

The above-described manner of playing content items in the shared content playback mode of the communication session from a shared content item queue provides an efficient way of automatically playing a plurality of content items, one after another, in the shared content playback mode of the communication session, which additionally reduces power usage and improves battery life of the electronic device by enabling the user to use the electronic device more quickly and efficiently.

In some embodiments, while the electronic device (e.g., 500b) is in the communication session (and while the electronic device is in the shared content playback mode of the communication session), the electronic device (e.g., 500b) receives, via the one or more input devices, an input corresponding to a request to display, via a display generation component in communication with the electronic device, the shared content item queue, such as detecting selection of option 628m in FIG. 6N. In some embodiments, the electronic device displays a user interface of a content (e.g., streaming, playback, browsing, etc.) application associated with the communication session, including a selectable option that, when selected, causes the electronic device to display a content item queue of the content application. In some embodiments, while the electronic device is in the communication session (e.g., in the shared playback mode), in response to detecting selection of the selectable option, the electronic device displays the shared content item queue of the communication session. In some embodiments, while the electronic device is not participating in a communication session and/or while the electronic device is in a private content playback mode while in the communication session, in response to detecting selection of the selectable option, the electronic device displays a private content item queue, different from the shared content item queue. In some embodiments, the content item queue includes an ordered list of content items that the electronic device is configured to play in the order of the queue. For example, if the queue includes a first content item followed by a second content item, the electronic device will play the first content item followed by the second content item.

In some embodiments, such as in FIG. 6O, while the electronic device (e.g., 500b) is in the communication session (and while the electronic device is in the shared content playback mode of the communication session), in response to receiving the input corresponding to the request to display the shared content item queue, the electronic device (e.g., 500b) displays, via the display generation component, a first representation (e.g., 650a) of a first content item included in the shared content item queue, the first representation (e.g., 650a) of the first content item displayed in association with a representation (e.g., 652b) of a user (e.g., associated with one of the electronic devices that are participating in the communication session) that added the first content item to the shared content item queue. In some embodiments, the first representation of the first content item included in the shared content item queue includes an indication of the title of the first content item, an artist of the first content item, and/or an image associated with the first content item (e.g., album artwork for the first content item). In some embodiments, the electronic device displays an image (e.g., avatar) corresponding to the user that added the first content item to the shared content item queue within the first representation of the first content item. For example, the image associated with the user that added the first content item to the shared content item queue is displayed (e.g., at least partially) overlaid on the image associated with the first content item. In some embodiments, the image associated with the user that added the first content item to the shared content item queue is an image associated with or included in a contact card of the user accessible to or stored on the electronic device.

In some embodiments, such as in FIG. 6O, while the electronic device (e.g., 500b) is in the communication session (and while the electronic device is in the shared content playback mode of the communication session), in response to receiving the input corresponding to the request to display the shared content item queue, the electronic device (e.g., 500b) displays, via the display generation component, a second representation (e.g., 650b) of a second content item included in the shared content item queue, the second representation (e.g., 650b) of the second content item displayed in association with a representation of a user that added the second content item to the shared content item queue. In some embodiments, the second representation of the second content item included in the shared content item queue includes an indication of the title of the second content item, an artist of the second content item, and/or an image associated with the second content item (e.g., album artwork for the second content item). In some embodiments, the electronic device displays an image (e.g., avatar) corresponding to the user that added the second content item to the shared content item queue within the second representation of the second content item. For example, the image associated with the user that added the second content item to the shared content item queue is displayed (e.g., at least partially) overlaid on the image associated with the second content item. In some embodiments, the image associated with the user that added the second content item to the shared content item queue is an image associated with or included in a contact card of the user accessible to or stored on the electronic device. In some embodiments, the first and second representations are displayed in an order that reflects the order of the first and second content items in the shared content item queue. For example, if the first content item is before the second content item in the shared content item queue, the electronic device displays the first representation above or to the right of the second representation.

The above-described manner of displaying representations of the users that added the first and second content items to the shared content item queue provides an efficient way of informing the users who added each content item to the queue while displaying the queue and indicating to the user whether the queue is the private queue or the shared queue, which additionally reduces power usage and improves battery life of the electronic device by enabling the user to use the electronic device more quickly and efficiently.

In some embodiments, such as in FIG. 6T, the electronic device (e.g., 500a) receives, via the one or more input devices, an input (e.g., via contact 603t) corresponding to a request to remove a respective content item (e.g., corresponding to representation 650i) included in the shared content item queue from the shared content item queue. In some embodiments, the input corresponding to the request to remove the respective content item included in the shared content item queue is selection of a selectable option to remove the respective content item from the shared content item queue. In some embodiments, the selectable option is displayed within or proximate to a representation of the respective content item in the shared content item queue. In some embodiments, the selectable option is presented in response to the user performing a swipe gesture on the representation of the respective content item in the shared content item queue. For example, the electronic device detects a swipe from the right side of the representation of the respective content item towards the left and, in response, displays an option to delete the respective content item from the shared content item queue. In some embodiments, the input corresponding to a request to remove the respective content item from the shared content item queue is a swipe input with a duration, distance, and/or speed that exceeds a predetermined threshold. In some embodiments, if the swipe input has a duration, distance, and/or speed that is less than the predetermined threshold, the electronic device displays the selectable option to remove the respective content item from the shared content item queue.

In some embodiments, such as in FIG. 6U, in response to receiving the input corresponding to the request to remove the respective content item from the shared content item queue, the electronic device (e.g., 500a) displays, via a display generation component in communication with the electronic device, a visual indication (e.g., 666) that indicates that the respective content item will be removed from the shared content item queue for the electronic device (e.g., 500a) and for the one or more second electronic devices (e.g., 500b). In some embodiments, the visual indication is a dialog box including text that indicates that the respective content item will be removed from the content item queue for all users in the communication session, an option selectable to confirm the respective content item should be removed from the shared content item queue, and an option selectable to dismiss the dialog box without removing the respective content item from the shared content item queue. In some embodiments, in response to detecting selection of the option to confirm the respective content item should be removed from the shared content item queue, the electronic device removes the respective content item from the shared content item queue. In some embodiments, after the respective content item is removed from the shared content item queue, the electronic device and the one or more second electronic devices in the communication session will not play the respective content item during the communication session (e.g., unless it is added to the queue again). In some embodiments, the visual indication is displayed in response to detecting selection of the selectable option to delete the respective content item from the shared content item queue. In some embodiments, the visual indication is displayed in response to detecting a swipe input with a speed, duration, or distance exceeding the predetermined threshold (e.g., without first detecting selection of the selectable option).

The above-described manner of presenting an indication that removing the respective content item from the shared content item queue removes the content item for all users in the conversation provides an efficient way of allowing the user to confirm deletion of the content item from the shared content item queue before deleting the respective content item for all users in the communication session which additionally reduces power usage and improves battery life of the electronic device by enabling the user to use the electronic device more quickly and efficiently, by preventing the user from performing an unintended function that will be subsequently reversed.

In some embodiments, such as in FIG. 6W, the electronic device (e.g., 500a) receives, via the one or more input devices, an input (e.g., via contact 603v) corresponding to a request to change a playback order of the plurality of respective content items included in the shared content item queue while the playback order of the plurality of respective content items included in the shared content item queue is a first playback order. In some embodiments, the request to change the playback order of the plurality of respective content items included in the shared content item queue is a request to move a respective content item up or down in the shared playback queue. For example, if the first playback order includes playing a first content item, then a second content item, then a third content item, the request is a request to move the first content item to a position after the second content item and/or third content item. As another example, the request is a request to move the third content item before the first content item and/or second content item in the content item queue. As another example, the request is a request to move the second content item to play before the first content item or after the third content item.

In some embodiments, in response to receiving the input corresponding to the request to change the playback order of the plurality of respective content items included in the shared content item queue, such as in FIG. 6W, in accordance with a determination that a respective one of the one or more second electronic devices (e.g., 500b) detected an input corresponding to a second request to change the playback order of the plurality of respective content items included in the shared content item queue from the first playback order prior to the electronic device (e.g., 500a) receiving the input corresponding to the request to change the playback order of the plurality of respective content items included in the shared content item queue, the electronic device (e.g., 500a) updates the playback order of the respective content items included in the shared content item queue to be a second playback order according to the input detected at the respective one of the one or more second electronic devices (e.g., 500b), such as in FIG. 6X (e.g., without reordering the content item queue in accordance with the first request). In some embodiments, the input corresponding to the second request is an input to move a respective content item in the content item queue up or down in the playback order of the content item queue, such as one of the examples described above with respect to the first request. In some embodiments, a server receives the input corresponding to the first request and the input corresponding to the second request and, if the second request is received prior to the first request (and the first request is received before the content item queue is updated to the second playback order in accordance with the second request), the server reorders the content item queue according to the second request. In some embodiments, if the first request is received after the content item queue is updated to the second playback order in accordance with the second request, the electronic device updates the content item queue according to the first request.

In some embodiments, in response to receiving the input corresponding to the request to change the playback order of the plurality of respective content items included in the shared content item queue, such as in FIG. 6W, in accordance with a determination that the respective one of the one or more second electronic devices (e.g., 500a) did not detect an input corresponding to the second request to change the playback order of the plurality of respective content items included in the shared content item queue from the first playback order prior to the electronic device (e.g., 500b) receiving the input corresponding to the request to change the playback order of the plurality of respective content items included in the shared content item queue (e.g., none of the one or more second electronic devices detected an input corresponding to a request to reorder the content item queue or the input corresponding to the second request was received after the input corresponding to the first request), such as in FIG. 6W, the electronic device (e.g., 500b) updates the playback order of the respective content items included in the shared content item queue to be a third playback order, different from the second playback order, according to the input detected at the electronic device (e.g., 500b), such as in FIG. 6X. (e.g., without updating the content item queue in accordance with the second request). In some embodiments, a server receives the input corresponding to the first request and the input corresponding to the second request and, if the first request is received prior to the second request (and the second request is received before the content item queue is updated to the third playback order in accordance with the first request), the server reorders the content item queue according to the first request. In some embodiments, if the second request is received after the content item queue is updated to the third playback order in accordance with the first request, the electronic device updates the content item queue according to the second request. In some embodiments, if two or more requests to order the content item queue are received prior to the content item queue being updated in response to any of the requests, the electronic device updates the content item queue in accordance with the request that was received first.

The above-described manner of reordering the shared content item queue according to the request to reorder the content item queue that was received first provides an efficient way of reordering the content item queue in a predictable way, which additionally reduces power usage and improves battery life of the electronic device by enabling the user to use the electronic device more quickly and efficiently, by avoiding reordering the queue in a manner that was not intended by the user and will be subsequently reversed.

In some embodiments, after playing a first content item in the shared content item queue (e.g., the content item queue displayed by electronic device 500b in FIG. 6O), in accordance with a determination that the content item queue includes a second content item (e.g., 650a) after the first content item in the content item queue, the electronic device (e.g., 500b) initiates playback of the second content item (e.g., 650a). In some embodiments, after completing playback of a respective content item, the electronic device (e.g., and the one or more second electronic devices) play the next content item in the content item queue.

In some embodiments, after playing a first content item (e.g., 650c) in the shared content item queue (e.g., the content item queue displayed by electronic device 500b in FIG. 6O), in accordance with a determination that the content item queue does not include the second content item (e.g., or any content items) after the first content item (e.g., 650c) in the content item queue, the electronic device (e.g., 500b) plays, during the communication session, one or more content items (e.g., 650d-e) selected based on the plurality of content items (e.g., 650a-c) previously included in the shared content item queue of the communication session and content consumption histories of a user account associated with the electronic device (e.g., 500b) and one or more user accounts associated with the one or more second electronic devices (e.g., 500a). In some embodiments, after playing a respective content item, if there are no content items remaining in the content item queue, the electronic device (e.g., and the one or more second electronic devices) play content items selected based on the content items that were included in the content item playback queue and the content consumption histories of the user accounts of the electronic devices in the communication session. In some embodiments, the one or more content items played after playing all of the content items in the queue have the same or similar artists and/or genres as the content items in the shared content item queue and/or content consumption histories of the users. In some embodiments, while the electronic device is in the private content playback mode or while the electronic device is not in a communication session, after playing all content items in a private content item queue, the electronic device plays content items selected based on the content items in the private content item queue and/or the content consumption history of the user account associated with the electronic device without playing content items selected based on the shared content item queue and/or the content consumption histories of the user accounts associated with the one or more second electronic devices. In some embodiments, while the electronic device is playing content items from a private queue while the electronic device is not in the shared content playback mode of the communication session (e.g., the electronic device is in the private content playback mode of the communication session or is not in a communication session), the electronic device stops playing content once it plays all of the content items in the private queue.

The above-described manner of playing content items based on the content items in the shared content item playback queue and the content consumption histories of the user accounts of the electronic device and the one or more second electronic devices after playing the content items in the shared content item playback queue provides an efficient way of continuing to play content after all of the content items in the queue have been played, which additionally reduces power usage and improves battery life of the electronic device by enabling the user to use the electronic device more quickly and efficiently.

In some embodiments, such as in FIG. 6L, the electronic device (e.g., 500a) detects, via the one or more input devices, an input (e.g., via contact 603L) corresponding to a request to initiate playback of a respective content item. In some embodiments, the input includes selection of a representation of the respective content item displayed in a user interface of a content (e.g., browsing, streaming, playback, library) application associated with the communication session. In some embodiments, the selection of the representation is a secondary selection (e.g., right click, long tap, force tap, etc.) and, in response to detecting the secondary selection of the representation, the electronic device displays a menu of options to perform a plurality of respective actions with respect to the respective content item.

In some embodiments, in response to detecting the input (e.g., via contact 603L) corresponding to a request to initiate playback of the respective content item, such as in FIG. 6L, in accordance with a determination that the electronic device (e.g., 500a) is in the communication session and the electronic device (e.g., 500a) is in the shared content playback mode of the communication session and playing a second respective content item (e.g., the second respective content item is also playing at the one or more second electronic devices in the communication session) when the input corresponding to the request to initiate playback of the respective content item is received, such as in FIG. 6L, the electronic device (e.g., 500a) displays, via a display generation component in communication with the electronic device, a selectable option (e.g., 646e) that, when selected, causes the electronic device (e.g., 500a) to cease playing the second respective content item at the electronic device (e.g., 500a) (e.g., without causing the one or more second electronic devices to cease playing the second respective content item) and initiate playback of a predetermined respective portion of the respective content item at the electronic device (e.g., 500a) without initiating playback of the predetermined respective portion of the respective content item at the one or more second electronic devices (e.g., 500b), such as in FIG. 6M. In some embodiments, the predetermined respective portion of the respective content item is a preview of the respective content item. In some embodiments, the predetermined respective portion of the respective content item is a portion other than the beginning of the respective content item. In some embodiments, the duration of the predetermined respective portion of the respective content item is less than the full duration of the respective content item and starts after the beginning of the respective content item and ends before the ending of the respective content item. In some embodiments, the predetermined respective portion of the respective content item has a predetermined duration and a predetermined respective portion of a second respective content item has the same predetermined duration. For example, a plurality of content items available through the content application associated with the communication session have associated 30-second previews. In some embodiments, in response to selection of an option to play the respective content item for the users in the communication session, the electronic device and one or more second electronic devices initiate playback of the respective content item. In some embodiments, in response to selection of an option to play the respective content item at the electronic device without playing the respective content item at the one or more second electronic devices, the electronic device initiates playback of the respective content item without the one or more second electronic devices initiating playback of the respective content item. In some embodiments, once the electronic device finishes playing the predetermined respective portion of the respective content item, the electronic device resumes playback of the second respective content item. In some embodiments, the electronic device resumes playback of the second respective content item at a later playback position than the playback position of the second respective content item at which the electronic device ceased playback of the second respective content item because the second respective content item continued to play on the one or more second electronic devices while the electronic device was playing the predetermined respective portion of the respective content item. In some embodiments, whenever the electronic device ceases playing content in the shared content playback mode to play other content in the private content playback mode, when resuming playback in the shared content playback mode, the electronic device resumes playback from the same playback position as the playback position of the content at the one or more second electronic devices, which is optionally a different (e.g., later) playback position than the playback position at which the electronic device ceased playback of the content in the shared content playback mode.

In some embodiments, such as in FIG. 6AA, in response to detecting the input (e.g., via contact 603aa) corresponding to a request to initiate playback of the respective content item, in accordance with a determination that the electronic device (e.g., 500a) is not in the communication session while the input corresponding to the request to initiate playback of the respective content item is received (or in accordance with a determination that the electronic device is in the communication session and in the private content playback mode while the input corresponding to the request to initiate playback of the respective content item is received), the electronic device (e.g., 500a) display of the selectable option (e.g., selectable option 646e illustrated in FIG. 6M), such as in FIG. 6BB. In some embodiments, the electronic device does not display the option to present a preview of the content item in response to (e.g., secondary) selection of the representation of the content item while the electronic device is not in the shared content playback mode. In some embodiments, the electronic device presents the option to privately present a preview of a content item while the electronic device is in the shared content playback mode to allow the user to double-check that the content item is the content item they intend to play for the group of users in the communication session before playing the content item for the group and does not present the option when the electronic device is not in the shared content playback mode.

The above-described manner of presenting an option to present the respective predefined portion of the content item at the electronic device without presenting the respective predefined portion of the content item to the one or more second electronic devices provides an efficient way of allowing the user to preview a content item before playing it for the users in the communication session, which additionally reduces power usage and improves battery life of the electronic device by enabling the user to use the electronic device more quickly and efficiently.

In some embodiments, in order for the electronic devices in the communication session to participate in synchronized playback of content items, the user accounts of the electronic devices in the communication session need to be subscribed to a subscription that entitles the user accounts to access content items through a content service associated with the communication session. In some embodiments, the subscriptions of the users in the communication session need to be associated with the same region. For example, a first user with a content subscription based in a first country and a second user with a content subscription based in a second country are unable to participate in synchronized content playback during a communication session because their subscriptions are based in different countries.

In some embodiments, such as in FIG. 6Y, while the electronic device (e.g., 500a) is in the communication session and while the electronic device (e.g., 500a) is in the shared content playback mode of the communication session, in accordance with a determination that the communication session was initiated at a first respective electronic device (e.g., 500a) (e.g., associated with a user account that is) associated with first content playback restrictions, the electronic device (e.g., 500a) restricts playback of one or more content items according to the first content playback restrictions. In some embodiments, the content playback restrictions are parental controls restricting the first respective electronic device from accessing explicit content. For example, if the communication session is initiated by an electronic device at which parental controls that prevent access to explicit content are active, it is not possible for any of the electronic devices in the communication session to initiate playback of explicit content in the shared content playback mode during participation in the communication session (e.g., at a plurality of or all of the electronic devices in the communication session).

In some embodiments, such as in FIG. 6Z, while the electronic device (e.g., 500a) is in the communication session and while the electronic device (e.g., 500a) is in the shared content playback mode of the communication session, in accordance with a determination that the communication session was initiated at a second respective electronic device (e.g., 500b) (e.g., associated with a user account that is) associated with second content playback restrictions, the electronic device (e.g., 500a) restricts playback of the one or more content items according to the second content playback restrictions. In some embodiments, the content playback restrictions are parental controls that are not enabled on the second respective electronic device, thus enabling the second respective electronic device to access explicit content. For example, if the communication session is initiated by an electronic device at which parental controls that prevent access to explicit content are not active, it is possible for any of the electronic devices in the communication session to initiate playback of explicit content in the shared content playback mode (e.g., at a plurality of or all of the electronic devices in the communication session). In some embodiments, a variety of content playback restriction settings are available to the first and second respective electronic devices. For example, a first setting permits access to a first subset of content items but restricts access to second and third subsets of content items and a second setting permits access to the first and second subsets of content items but restricts access to the third subset of content items. In this example, if the electronic device that initiated the communication session is configured with the first setting, electronic devices in the communication session are able to initiate playback, in the shared content playback mode, of the first subset of content items but are not able to initiate playback, in the shared content playback mode, of the second and third subsets of content items. As another example, if the electronic device that initiated the communication session is configured with the second setting, electronic devices in the communication session are able to initiate playback, in the shared content playback mode, of the first and second subsets of content items but are not able to initiate playback, in the shared content playback mode, of the third subset of content items.

The above-described manner of applying the content restriction settings of the electronic device that initiated the communication session to the content played in the shared content playback mode of the communication session provides an efficient way of maintaining content restriction settings and synchronized playback in the communication session, which additionally reduces power usage and improves battery life of the electronic device by enabling the user to use the electronic device more quickly and efficiently.

In some embodiments, after completing playback of a first content item, in accordance with a determination that the electronic device (e.g., 500a) is in the communication session and the electronic device is in the shared content playback mode of the communication session, such as in FIG. 6X, the electronic device (e.g., 500a) initiates playback of a second content item (e.g., 650g) included in a shared content item queue associated with the communication session. In some embodiments, while the electronic device is in the shared playback mode of the communication session, the electronic device (e.g., and the one or more second electronic devices in the communication session) automatically plays the next content item in a shared content item queue associated with the communication session after completing playback of a respective content item.

In some embodiments, after completing playback of a first content item, in accordance with a determination that the electronic device (e.g., 500a) is not in the shared content playback mode of the communication session (e.g., the electronic device is not in the communication session or the electronic device is in the private content playback mode of the communication session), such as in FIG. 6CC, the electronic device (e.g., 500a) initiates playback of a third content item (e.g., 590a) included in a private content item queue not associated with the communication session. In some embodiments, while the electronic device is not in the shared playback mode of the communication session, the electronic automatically plays the next content item in a private content item queue not associated with the communication session after completing playback of a respective content item (e.g., and the one or more second electronic devices forgo playing the next content item in the private content item queue). In some embodiments, the electronic device maintains a private content item queue from which the electronic device plays content items while the electronic device is not in the shared content playback mode of the communication session. For example, prior to entering and/or after exiting the shared content item playback mode, the electronic device plays content from the private content item queue.

The above-described manner of playing content items from a private content item queue while not in the shared content item playback mode and playing content items from a shared content item queue while in the shared content item playback mode provides an efficient way of maintaining the private content item queue for use while the electronic device is not in the shared content playback mode, which additionally reduces power usage and improves battery life of the electronic device by enabling the user to use the electronic device more quickly and efficiently (e.g., by not requiring the user to set up the private queue after exiting the shared content playback mode).

In some embodiments, such as in FIG. 6A, while the electronic device (e.g., 500a) is in a respective communication session with one or more electronic devices (e.g., 500b) (e.g., the same as or different from the one or more second electronic devices), the one or more electronic devices (e.g., 500b) associated with one or more users different from the user of the electronic device, the electronic device (e.g., 500a) receives, via the one or more electronic devices (e.g., from one of the one or more third electronic devices, for example, via one or more servers in communication with the electronic device, the one or more third electronic devices, and/or each other), an indication of a request (e.g., via contact 603a) to initiate playback of a respective content item in the respective communication session. In some embodiments, the one of the one or more third electronic devices receives an input corresponding to a request to initiate playback of the respective content item in the shared content playback mode of the respective communication session and transmits an indication of the request to the other electronic devices in the communication session.

In some embodiments, in response to receiving the indication of the request (e.g., via contact 603a) to initiate playback of the respective content item in the respective communication session, such as in FIG. 6A, in accordance with a determination that a content playback restriction setting of the electronic device (e.g., 500a) is not more restrictive than a content playback restriction setting associated with the respective communication session, the electronic device (e.g., 500a) displays, via a display generation component in communication with the electronic device (e.g., 500a), a selectable option (e.g., 622b) that, when selected, causes the electronic device to initiate playback of the respective content item in a shared content playback mode of the respective communication session, such as in FIG. 6B. In some embodiments, the content playback restriction setting is a parental control setting restricting the electronic device from accessing explicit content. For example, if the respective communication session restricts playback of explicit content and the electronic device does not have any content playback restrictions, the electronic device is able to play content in the shared content playback mode of the respective communication session. In some embodiments, the content playback restriction setting is set for a user account associated with the electronic device and is active on all of the electronic devices associated with that user account. In some embodiments, while the electronic device is in the communication session, the electronic device plays content items in the shared content item playback mode of the communication session in accordance with a determination that the content restriction setting of the communication session is not less restrictive than the content restriction setting of the (e.g., user account of the) electronic device. For example, a content restriction setting prevents the electronic device from playing explicit content items. As another example, a content restriction setting prevents the electronic device from playing content items having one or more predetermined content ratings (e.g., PG-13, R, TV-17, TV-MA, etc.). In some embodiments, if the content restriction settings of the communication session are more restrictive than the content restriction settings of the electronic device, the electronic device is not able to play content items restricted by the communication session in the shared content playback mode even if the electronic device is able to play those content items in the private playback mode and/or while not in the communication session.

In some embodiments, in response to receiving the indication of the request (e.g., via contact 603a) to initiate playback of the respective content item in the respective communication session, such as in FIG. 6A, in accordance with a determination that the content playback restriction setting of the electronic device (e.g., 500a) is more restrictive than the content playback restriction setting associated with the respective communication session, the electronic device (e.g., 500a) forgoes display of the selectable option (e.g., 622b illustrated in FIG. 6B), such as in FIG. 6BB. For example, if the respective communication session allows playback of explicit content and the electronic device restricts playback of explicit content, the electronic device is not able to play content in the shared content playback mode of the respective communication session. In some embodiments, the electronic device presents a visual indication indicating that the one of the one or more third electronic devices has initiated playback of the respective content item in the respective communication session but the electronic device is unable to play content in the shared content playback mode of the respective communication session due to the content restriction setting on the electronic device. In some embodiments, the communication session has content playback restriction settings that match the content playback restriction settings of the electronic device that initiated the communication session. The above-described manner of preventing playback of content in the shared content playback mode of the respective communication session when the content playback restriction setting of the electronic device is more restrictive than the content playback restriction setting of the respective communication session provides an efficient way of maintaining content restriction settings and synchronized playback in the communication session, which additionally reduces power usage and improves battery life of the electronic device by enabling the user to use the electronic device more quickly and efficiently.

In some embodiments, when a user in the communication session initiates playback of a content item in the shared content playback mode, if the electronic device is not already in the shared content playback mode, the electronic device presents a selectable option that, when selected, causes the electronic device to enter the shared content playback mode. In some embodiments, if the electronic device is not subscribed to a content service associated with the communication session when the selection of the selectable option is detected, the electronic device presents an option that, when selected, causes the electronic device to initiate a process to subscribe to the content service.

In some embodiments, while the electronic device is in the communication session, the electronic device has access to a first respective content (e.g., streaming, browsing, playback, library, etc.) application for playing content associated with the communication session. In some embodiments, while the electronic device is in the shared content playback mode of the communication session, the electronic device plays (and the one or more second electronic devices play) content items via the first respective content application.

In some embodiments, such as in FIG. 6I, while the electronic device (e.g., 500b) is in a respective communication session with one or more third electronic devices (e.g., 500a) (e.g., the one or more third electronic devices are the same as or different from the one or more second electronic devices), the one or more third electronic devices (e.g., 500a) associated with one or more third users (e.g., the same or different from the second users) different from the user of the electronic device (e.g., 500b), the electronic device (e.g., 500a) receives, from a respective one of the one or more third electronic devices (e.g., 500a) (e.g., optionally via one or more servers in communication with the first electronic device, the respective one of the one or more third electronic devices, and/or each other), an indication of shared playback of a respective content item associated with the respective communication session, such as in FIG. 6I. In some embodiments, the indication is an indication of an input received at the one of the one or more third electronic devices corresponding to a request to initiate playback of a respective content item in the shared content playback mode of the communication session. In some embodiments, in response to the indication, one or more electronic devices in the shared playback mode of the communication session initiate playback of the respective content item and one or more electronic device in the communication session that are not in the share playback mode present a visual indication of the indication of shared playback of the respective content item.

In some embodiments, such as in FIG. 6I, while the electronic device (e.g., 500b) is in a respective communication session with one or more third electronic devices (e.g., 500a) (e.g., the one or more third electronic devices are the same as or different from the one or more second electronic devices), the one or more third electronic devices (e.g., 500a) associated with one or more third users (e.g., the same or different from the second users) different from the user of the electronic device (e.g., 500b), in response to receiving the indication of the shared playback of the respective content item, in accordance with a determination that the electronic device (e.g., 500b) does not have access to a second respective content application (e.g., the second respective content application is the same as the first respective content application or different from the first respective content application) for playing content associated with the respective communication session, the electronic device (e.g., 500b) displays, via a display generation component in communication with the electronic device (e.g., 500b), a selectable option (e.g., 636d) that, when selected, causes the electronic device (e.g., 500b) to initiate a process to gain access to the second respective content application. In some embodiments, the selectable option is displayed within or at a location proximate to a visual indication of shared playback of the respective content item in the shared playback mode of the communication session. In some embodiments, in response to detecting selection of the selectable option, the electronic device initiates the process to gain access to (e.g., download, install) the second respective content application. In some embodiments, the second respective content application is an application through which electronic devices play content items in the shared content playback mode of the communication session. In some embodiments, in response to receiving the indication of the shared playback of the respective content item, in accordance with a determination that the electronic device has access to the second respective content application, the electronic device displays a selectable option that, when selected, causes the electronic device to initiate playback of the respective content item in the shared content playback mode without initiating the process to gain access to the second respective content application.

The above-described manner of presenting an option to access the second respective content application in response to shared playback of a content item in the shared playback mode of the respective communication session being received provides an efficient way of gaining access to the application needed to play the content in the shared content playback mode of the communication session, which additionally reduces power usage and improves battery life of the electronic device by enabling the user to use the electronic device more quickly and efficiently.

In some embodiments, such as in FIG. 6G, while the electronic device (e.g., 500a) is in the communication session and while the electronic device (e.g., 500a) is in the shared content playback mode of the communication session, the electronic device (e.g., 500a) receives, from a respective one of the one or more second electronic devices (e.g., 500b) (e.g., via one or more servers in communication with the electronic device, the one or more second electronic devices, and/or each other), an indication of a first input (e.g., via contact 603g) corresponding to a request to modify playback of the content item at the electronic device (e.g., 500a) and the one or more second electronic devices (e.g., 500b), such as in FIG. 6G. In some embodiments, the request corresponds to a request to play the content item, pause the content item, skip ahead to the next content item (e.g., in a content item queue), skip back to the beginning of the content item, skip back to a previous content item (e.g., in a content item queue), change the playback position within the content item, or a different manner of modifying playback of the content item. In some embodiments, the first input is detected at the respective one of the one or more second electronic device and the electronic device receives an indication of the first input from the respective one of the one or more second electronic devices (e.g., via one or more servers).

In some embodiments, such as in FIG. 6H, while the electronic device (e.g., 500a) is in the communication session and while the electronic device (e.g., 500a) is in the shared content playback mode of the communication session, in response to receiving the indication of the first input, such as the input illustrated in FIG. 6G, the electronic device (e.g., 500a) modifies playback of the content item at the electronic device (e.g., 500a) in accordance with the first input, such as in FIG. 6H. In some embodiments, in response to the input, the electronic device and the one or more second electronic devices in the shared content playback mode of the communication session modify playback of the content item in accordance with the request.

In some embodiments, such as in FIG. 6H, while the electronic device (e.g., 500a) is in the communication session and while the electronic device (e.g., 500a) is in the shared content playback mode of the communication session, in response to receiving the indication of the first input, such as in the input illustrated in FIG. 6G, the electronic device (e.g., 500a) displays, via a display generation component in communication with the electronic device (e.g., 500a), a visual indication (e.g., 630) of (e.g., the modification to playback of the content item associated with) the first input, such as in FIG. 6H. In some embodiments, the visual indication includes an indication of the user associated with the electronic device that received the indication of the first input. In some embodiments, the visual indication includes an indication of the specific request made by the user. For example, if a first user provided an input corresponding to a request to pause a first content item, the visual indication would include an indication of the first user and an indication that the first input corresponds to a request to pause the content item. The above-described manner of displaying a visual indication of the first input provides an efficient way of indicating to the user why playback of the content item was modified, which additionally reduces power usage and improves battery life of the electronic device by enabling the user to use the electronic device more quickly and efficiently.

In some embodiments, if the indication of the first input is received while the electronic device presents a user interface of a content (e.g., browsing, streaming, playback, library, etc.) application associated with the communication session (e.g., the application through which the electronic devices play content in the shared content playback mode of the communication session), the visual indication does not include an indication of the content application. In some embodiments, if the indication of the first input is received while the electronic device presents a user interface of an application other than the content (e.g., browsing, streaming, playback, library, etc.) application associated with the communication session, the visual indication includes an indication of the content application. In some embodiments, the indication of the first input that is presented while the electronic device presents the user interface of the application other than the content application associated with the communication session is selectable to present the user interface of the content application associated with the communication session. In some embodiments, the indication of the first input that is presented while the electronic device presents the user interface of the content application associated with the communication session is not selectable to perform an action (e.g., because the electronic device is already presenting a user interface of the content application associated with the communication session).

In some embodiments, such as in FIG. 6Q, displaying the visual indication (e.g., 660a) of the first input is in accordance with a determination that the request to modify playback of the content item is a request to modify playback of the content item in a first manner (e.g., the request corresponds to a request to perform one of a first subset of actions with respect to playback of the content) and that the indication of the first input is received while the electronic device (e.g., 500b) is presenting a user interface of a content (e.g., streaming, browsing, playback, library) application associated with the communication session. In some embodiments, while the electronic device displays a user interface of the content (e.g., streaming, browsing, playback, library) application associated with the communication session, the electronic device displays visual indications of a first plurality of actions related to modifying the playback of respective content items playing the shared content playback mode of the communication session.

In some embodiments, such as in FIG. 6Q, in response to receiving the indication of the first input, in accordance with a determination that the request to modify playback of the content item is the request to modify playback of the content item in the first manner and that the indication of the first input is received while the electronic device (e.g., 500c) is presenting a user interface of an application different from the content application associated with the communication session, forgoing displaying the visual indication of the first input (e.g., the visual indication 660a displayed by electronic device 500b). In some embodiments, while the electronic device is displaying a user interface other than a user interface of the content application associated with the communication session, the electronic device only presents visual indications of a subset of actions to modify playback of the content playing in the shared content playback mode of the communication session. For example, if a user adds or removes a content item from a shared content playback item queue associated with the communication session, the electronic device only presents a visual indication of the adding or removing of the content item if the electronic device is presenting a user interface of the content application associated with the communication session and forgoes presenting the visual indication if the electronic device is presenting a user interface of a different application when the input to perform the action is received (e.g., at one of the second electronic devices). In some embodiments, if the electronic device detects an input corresponding to the request to modify playback of the content item, the electronic device forgoes presenting the visual indication of the request irrespective of the user interface being displayed by the electronic device.

The above-described manner of forgoing display of the visual indication while the electronic device presents a user interface other than a user interface of the content application associated with the communication session provides an efficient way of reducing distractions while the user is interacting with an application other than the content application associated with the communication session, which additionally reduces power usage and improves battery life of the electronic device by enabling the user to use the electronic device more quickly and efficiently.

In some embodiments, such as in FIG. 6R, in response to receiving the indication of the first input, in accordance with a determination that the request to modify playback of the content item is a request to modify playback of the content item in a second manner different from the first manner (e.g., the request corresponds to a request to perform one of a second subset of actions with respect to playback of the content), the electronic device (e.g., 500c) displays the visual indication (e.g., 660c) of the first input irrespective of whether the electronic device (e.g., 500c) is presenting a user interface of the content application associated with the communication session or a user interface of the application different from the content application associated with the communication session when the indication of the first input is received. For example, the electronic device presents visual indications when a user initiates playback of a content item, pauses a content item, skips a content item, changes the playback position of the currently-playing content item or skips to a previous content item in a shared content item queue associated with the communication session irrespective of whether the electronic device is presenting a user interface of the content application associated with the communication session or presenting a user interface of a different application.

The above-described manner of presenting a visual indication of the first respective input corresponding to the request to modify playback of the content item in the second manner irrespective of whether the electronic device is presenting a user interface of the content application or a user interface of a different application provides an efficient way of informing the user why playback of the content item changes, which additionally reduces power usage and improves battery life of the electronic device by enabling the user to use the electronic device more quickly and efficiently.

In some embodiments, the electronic device displays visual indications when a user adds a song to the shared content item queue of the communication session, initiates or pauses playback of a content item, skips ahead or skips back to a content item in the shared content item queue, and/or transmits an indication of a reaction (e.g., like, love, dislike, laugh, emphasis, etc.) to a content item.

In some embodiments, the electronic device presents a user interface of a content (e.g., streaming, playback, browsing, library, etc.) application associated with the communication session. In some embodiments, the electronic device uses the content application associated with the communication session to present items of content in the shared content playback mode of the communication session. In some embodiments, the user interface of the content application associated with the communication session includes an indication of the current content playback status of the content application, including an indication of (e.g., title, artist, etc. of) the content item playing on the electronic device, an indication of an audio device (e.g., speaker system, headphones, etc.) being used to present the content, an image (e.g., album artwork) associated with the content item playing on the electronic device, a selectable option to play/pause the content, a selectable option to skip to the next content item in a content item queue, and a visual indication of the number of users consuming the content in the shared content playback mode of the communication session.

In some embodiments, the content application associated with the communication session is able to access a plurality of types of content items, such as live radio stations, albums, playlists, songs, podcasts, etc. In some embodiments, a subset of these types of content items is available for playback in the shared content playback mode of the communication session and a subset of these types of content items is not available for playback in the shared content playback mode of the communication session. For example, live content, such as live radio stations, are not available for playback in the shared playback mode of the communication session and other content, such as albums, playlists, songs, and podcasts are available for playback in the shared playback mode of the communication session. In some embodiments, all of the types of content are available while the electronic device is not in the shared content playback mode (e.g., while the electronic device is not in a communication session, while the electronic device is in the private content playback mode of the communication session).

In some embodiments, such as in FIG. 6E, while the electronic device (e.g., 500b) is associated with first content playback restrictions and while the electronic device (e.g., 500b) is in the communication session, the communication session associated with second content playback restrictions, while the electronic device is not in the shared content playback mode of the communication session, the electronic device (e.g., 500b) receives, via the one or more input devices, an input (e.g., via contact 603e) corresponding to a request to enter the shared content playback mode of the communication session, such as in FIG. 6E. In some embodiments, the input corresponding to the request to enter the shared content playback mode of the communication session is selection of an option to initiate playback of a respective content item in the shared content playback mode of the communication session. In some embodiments, the input corresponding to the request to enter the shared content playback mode of the communication session is selection of a visual indication that one of the second electronic devices has initiated playback of a respective content item in the shared content playback mode of the communication session. In some embodiments, the content playback restrictions are parental controls restricting the first respective electronic device from accessing explicit content. For example, if the communication session is associated with parental controls that prevent access to explicit content, it is not possible for any of the electronic devices in the communication session to initiate playback of explicit content in the shared content playback mode during participation in the communication session (e.g., at a plurality of or all of the electronic devices in the communication session). As another example, if the communication session is associated with content playback restrictions that allow playback of all content available from a content service, including explicit content and non-explicit content, then it is possible for the electronic devices in the shared content playback mode of the communication session to play explicit and non-explicit content in the shared content playback mode of the communication session. In some embodiments, a variety of content playback restriction settings are available to the electronic device and the communication session. For example, a first setting permits access to a first subset of content items but restricts access to second and third subsets of content items and a second setting permits access to the first and second subsets of content items but restricts access to the third subset of content items. In this example, if the communication session is associated with the first setting, electronic devices in the communication session are able to initiate playback, in the shared content playback mode, of the first subset of content items but are not able to initiate playback, in the shared content playback mode, of the second and third subsets of content items. As another example, if the communication session is associated with the second setting, electronic devices in the communication session are able to initiate playback, in the shared content playback mode, of the first and second subsets of content items but are not able to initiate playback, in the shared content playback mode, of the third subset of content items. In some embodiments, the communication session is associated with the same content restriction settings of the respective electronic device that initiated the communication session. In some embodiments, the communication session is associated with the same content restriction settings of the respective electronic device that initiated playback of content in the shared content playback mode of the communication session. In some embodiments, the content playback restrictions of the electronic device are associated with a user account associated with the electronic device and are associated with other electronic devices also associated with the same user account.

In some embodiments, while the electronic device (e.g., 500b) is associated with first content playback restrictions and while the electronic device (e.g., 500b) is in the communication session, the communication session associated with second content playback restrictions, in response to the input (e.g., via contact 603e) corresponding to the request to enter the shared content playback mode of the communication session, such as in FIG. 6E, in accordance with a determination that the first content playback restrictions are more restrictive than the second content playback restrictions, the electronic device (e.g., 500b) forgoes entering the shared content playback mode of the communication session, such as in FIG. 6Y. In some embodiments, an electronic device is able to join a communication session, but not able to join the shared content playback mode of the communication session, if the content playback restrictions of the communication session allow playback of content that is restricted (e.g., not allowed) by the content playback restrictions of the electronic device (e.g., the content playback restrictions of the electronic device are more restrictive than the content playback restrictions of the communication session).

In some embodiments, while the electronic device (e.g., 500b) is associated with first content playback restrictions and while the electronic device (e.g., 500b) is in the communication session, the communication session associated with second content playback restrictions, in response to the input (e.g., via contact 603e) corresponding to the request to enter the shared content playback mode of the communication session, such as in FIG. 6E, in accordance with a determination that the first content playback restrictions are not more restrictive than the second content playback restrictions, the electronic device (e.g., 500b) enters the shared content playback mode of the communication session, such as in FIG. 6G. In some embodiments, an electronic device is able to join a communication session and able to join the shared content playback mode of the communication session if the content playback restrictions of the communication session restrict playback of content that is restricted by (e.g., not allowed by) the content playback restrictions of the electronic device (e.g., the content playback restrictions of the communication session and the electronic device are the same). In some embodiments, an electronic device is able to join a communication session and able to join the shared content playback mode of the communication session if the content playback restrictions of the communication session restrict playback of content that is allowed by the content playback restrictions of the electronic device (e.g., the content playback restrictions of the communication session are more restrictive than the content playback restrictions of the electronic device).

The above-described manner of restricting access to the shared content playback mode of a communication session associated with content playback restrictions that are less restrictive than the content playback restrictions of the electronic device provides an efficient way of enforcing the content playback restrictions on the electronic device, which additionally reduces power usage and improves battery life of the electronic device by enabling the user to use the electronic device more quickly and efficiently.

In some embodiments, while the electronic device (e.g., 500b) is associated with first content playback restrictions, while the electronic device (e.g., 500b) is not in the communication session, the communication session associated with second content playback restrictions, the electronic device (e.g., 500b) receives, via the one or more input devices, an input corresponding to a request to join the communication session. In some embodiments, the content playback restrictions are parental controls restricting the first respective electronic device from accessing explicit content. In some embodiments, the content playback restrictions of the electronic device are associated with a user account associated with the electronic device and are associated with other electronic devices also associated with the same user account. For example, if the communication session is associated with parental controls that prevent access to explicit content, it is not possible for any of the electronic devices in the communication session to initiate playback of explicit content in the shared content playback mode during participation in the communication session (e.g., at a plurality of or all of the electronic devices in the communication session). As another example, if the communication session is associated with content playback restrictions that allow playback of all content available from a content service, including explicit content and non-explicit content, then it is possible for the electronic devices in the shared content playback mode of the communication session to play explicit and non-explicit content in the shared content playback mode of the communication session. In some embodiments, a variety of content playback restriction settings are available to the electronic device and the communication session. For example, a first setting permits access to a first subset of content items but restricts access to second and third subsets of content items and a second setting permits access to the first and second subsets of content items but restricts access to the third subset of content items. In this example, if the communication session is associated with the first setting, electronic devices in the communication session are able to initiate playback, in the shared content playback mode, of the first subset of content items but are not able to initiate playback, in the shared content playback mode, of the second and third subsets of content items. As another example, if the communication session is associated with the second setting, electronic devices in the communication session are able to initiate playback, in the shared content playback mode, of the first and second subsets of content items but are not able to initiate playback, in the shared content playback mode, of the third subset of content items. In some embodiments, the communication session is associated with the same content restriction settings of the respective electronic device that initiated the communication session. In some embodiments, the communication session is associated with the same content restriction settings of the respective electronic device that initiated playback of content in the shared content playback mode of the communication session.

In some embodiments, in response to the input corresponding to the request to join the communication session, in accordance with a determination that the first content playback restrictions are more restrictive than the second content playback restrictions, the electronic device (e.g., 500b) forgoes joining the communication session. In some embodiments, the input corresponding to the request to join the communication session is selection of an indication of initiation of the communication session (e.g., similar to an incoming call indication). In some embodiments, an electronic device is not able to join a communication session if the content playback restrictions of the communication session allow playback of content that is restricted (e.g., not allowed) by the content playback restrictions of the electronic device (e.g., the content playback restrictions of the electronic device are more restrictive than the content playback restrictions of the communication session).

In some embodiments, in response to the input corresponding to the request to join the communication session, in accordance with a determination that the first content playback restrictions are not more restrictive than the second content playback restrictions, the electronic device (e.g., 500b) joins the communication session. In some embodiments, an electronic device is able to join a communication session if the content playback restrictions of the communication session restrict playback of content that is restricted by (e.g., not allowed by) the content playback restrictions of the electronic device (e.g., the content playback restrictions of the communication session and the electronic device are the same). In some embodiments, an electronic device is able to join a communication session if the content playback restrictions of the communication session restrict playback of content that is allowed by the content playback restrictions of the electronic device (e.g., the content playback restrictions of the communication session are more restrictive than the content playback restrictions of the electronic device). The above-described manner of restricting access to a communication session associated with content playback restrictions that are less restrictive than the content playback restrictions of the electronic device provides an efficient way of enforcing the content playback restrictions on the electronic device, which additionally reduces power usage and improves battery life of the electronic device by enabling the user to use the electronic device more quickly and efficiently.

It should be understood that the particular order in which the operations in FIG. 7 have been described is merely exemplary and is not intended to indicate that the described order is the only order in which the operations could be performed. One of ordinary skill in the art would recognize various ways to reorder the operations described herein.

The operations in the information processing methods described above are, optionally, implemented by running one or more functional modules in an information processing apparatus such as general purpose processors (e.g., a as described with respect to FIGS. 1A-1B, 3, 5A-5H) or application specific chips. Further, the operations described above with reference to FIG. 7 are, optionally, implemented by components depicted in FIGS. 1A-1B. For example, receiving operation 704 is, optionally, implemented by event sorter 170, event recognizer 180, and event handler 190. Event monitor 171 in event sorter 170 detects a contact on touch screen 504, and event dispatcher module 174 delivers the event information to application 136-1. A respective event recognizer 180 of application 136-1 compares the event information to respective event definitions 186, and determines whether a first contact at a first location on the touch screen corresponds to a predefined event or sub-event, such as selection of an object on a user interface. When a respective predefined event or sub-event is detected, event recognizer 180 activates an event handler 190 associated with the detection of the event or sub-event. Event handler 190 optionally utilizes or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

As described above, one aspect of the present technology is the gathering and use of data available from various sources to share content items in communication sessions. The present disclosure contemplates that in some instances, this gathered data may include personal information data that uniquely identifies or can be used to contact or locate a specific person. Such personal information data can include demographic data, location-based data, telephone numbers, email addresses, twitter IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to recommend content items based on content consumption histories of one or more users in a communication session. Accordingly, use of such personal information data enables users to consume content relevant to their interests. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of multi-participant live communication sessions, the present technology can be configured to allow users to select to “opt in” or “opt out” of participation in the collection of personal information data during registration for services or anytime thereafter. In another example, users can select not to share data associated with the user. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, a representation of gaze for a particular user can be corrected at a system of another user by inferring preferences and/or the gaze direction of the particular user and/or the other user based on non-personal information data or a bare minimum amount of personal information, such as the content being requested by the device associated with a user, other non-personal information available to the multi-participant live communication services, or publicly available information.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

What is claimed is:

1. A method comprising:
at an electronic device in communication with one or more input devices:
while the electronic device is in a communication session with one or more second electronic devices, the one or more second electronic devices associated with one or more second users different from a user of the electronic device:
while playback of a content item is occurring, receiving, via the one or more input devices, an input corresponding to a request to modify the playback of the content item; and
in response to receiving the input:
in accordance with a determination that the input is received while the electronic device is in a shared content playback mode of the communication session, modifying the playback of the content item in accordance with the input at the electronic device and at the one or more second electronic devices; and
in accordance with a determination that the input is received while the electronic device is in a private content playback mode of the communication session, modifying the playback of the content item in accordance with the input at the electronic device without modifying the playback of the content item at the one or more second electronic devices.

2. The method of claim 1, further comprising
while the electronic device is in the communication session:
receiving an indication of selection of a respective content item at a respective electronic device of the one or more second electronic devices; and
in response to receiving the indication of selection of the respective content item, initiating playback of the respective content item at the electronic device.

3. The method of claim 1, further comprising:
while the electronic device is in the communication session:
receiving, via the one or more input devices, an indication of a request to initiate playback of a respective content item in the communication session; and
in response to receiving the indication of the request to initiate playback of the respective content item in the communication session:
in accordance with a determination that a user account associated with the electronic device is entitled to access the respective content item through a content service associated with the communication session, presenting a selectable option that, when selected, causes the electronic device to initiate playback of the respective content item in the shared content playback mode of the communication session; and
in accordance with a determination that the user account associated with the electronic device is not entitled to access the respective content item through the content service associated with the communication session, forgoing presenting the selectable option.

4. The method of claim 1, further comprising:
while the electronic device is in the communication session:
receiving, via the one or more input devices, an input corresponding to selection of a respective content item; and
in response to receiving the input corresponding to selection of the respective content item, displaying, via a display generation component in communication with the electronic device:
a first selectable option that, when selected, causes the electronic device to initiate playback of the respective content item in the shared content playback mode on the electronic device and the one or more second electronic devices; and
a second selectable option that, when selected, causes the electronic device to initiate playback of the respective content item in the private content playback mode on the electronic device without initiating playback of the respective content item on the one or more second electronic devices.

5. The method of claim 1, further comprising:
while the electronic device is in the communication session and while the electronic device is in the shared content playback mode of the communication session:
playing a respective content item from a shared content item queue of the communication session that includes a plurality of content items, wherein the electronic device and the one or more second electronic devices are able to edit the shared content item queue.

6. The method of claim 5, further comprising:
while the electronic device is in the communication session:
receiving, via the one or more input devices, an input corresponding to a request to display, via a display generation component in communication with the electronic device, the shared content item queue; and
in response to receiving the input corresponding to the request to display the shared content item queue, displaying, via the display generation component:
a first representation of a first content item included in the shared content item queue, the first representation of the first content item displayed in association with a representation of a user that added the first content item to the shared content item queue, and
a second representation of a second content item included in the shared content item queue, the second representation of the second content item displayed in association with a representation of a user that added the second content item to the shared content item queue.

7. The method of claim 5, further comprising:
receiving, via the one or more input devices, an input corresponding to a request to remove a respective content item included in the shared content item queue from the shared content item queue; and
in response to receiving the input corresponding to the request to remove the respective content item from the shared content item queue, displaying, via a display generation component in communication with the electronic device, a visual indication that indicates that the respective content item will be removed from the shared content item queue for the electronic device and for the one or more second electronic devices.

8. The method of claim 5, further comprising:
receiving, via the one or more input devices, an input corresponding to a request to change a playback order of the plurality of respective content items included in the shared content item queue while the playback order of the plurality of respective content items included in the shared content item queue is a first playback order; and
in response to receiving the input corresponding to the request to change the playback order of the plurality of respective content items included in the shared content item queue:
in accordance with a determination that a respective one of the one or more second electronic devices detected an input corresponding to a second request to change the playback order of the plurality of respective content items included in the shared content item queue from the first playback order prior to the electronic device receiving the input corresponding to the request to change the playback order of the plurality of respective content items included in the shared content item queue, updating the playback order of the respective content items included in the shared content item queue to be a second playback order according to the input detected at the respective one of the one or more second electronic devices; and
in accordance with a determination that the respective one of the one or more second electronic devices did not detect an input corresponding to the second request to change the playback order of the plurality of respective content items included in the shared content item queue from the first playback order prior to the electronic device receiving the input corresponding to the request to change the playback order of the plurality of respective content items included in the shared content item queue, updating the playback order of the respective content items included in the shared content item queue to be a third playback order, different from the second playback order, according to the input detected at the electronic device.

9. The method of claim 5, further comprising:
after playing a first content item in the shared content item queue:
in accordance with a determination that the content item queue includes a second content item after the first content item in the content item queue, initiating playback of the second content item; and
in accordance with a determination that the content item queue does not include the second content item after the first content item in the content item queue, playing, during the communication session, one or more content items selected based on the plurality of content items previously included in the shared content item queue of the communication session and content consumption histories of a user account associated with the electronic device and one or more user accounts associated with the one or more second electronic devices.

10. The method of claim 1, further comprising:
detecting, via the one or more input devices, an input corresponding to a request to initiate playback of a respective content item; and in response to detecting the input corresponding to a request to initiate playback of the respective content item:
in accordance with a determination that the electronic device is in the communication session and the electronic device is in the shared content playback mode of the communication session and playing a second respective content item when the input corresponding to the request to initiate playback of the respective content item is received:
displaying, via a display generation component in communication with the electronic device, a selectable option that, when selected, causes the electronic device to cease playing the second respective content item at the electronic device and initiate playback of a predetermined respective portion of the respective content item at the electronic device without initiating playback of the predetermined respective portion of the respective content item at the one or more second electronic devices; and
in accordance with a determination that the electronic device is not in the communication session while the input corresponding to the request to initiate playback of the respective content item is received, forgoing display of the selectable option.

11. The method of claim 1, further comprising:
while the electronic device is in the communication session and while the electronic device is in the shared content playback mode of the communication session:
in accordance with a determination that the communication session was initiated at a first respective electronic device associated with first content playback restrictions, restricting playback of one or more content items according to the first content playback restrictions; and
in accordance with a determination that the communication session was initiated at a second respective electronic device associated with second content playback restrictions, restricting playback of the one or more content items according to the second content playback restrictions.

12. The method of claim 1, further comprising:
after completing playback of a first content item:
in accordance with a determination that the electronic device is in the communication session and the electronic device is in the shared content playback mode of the communication session, initiating playback of a second content item included in a shared content item queue associated with the communication session; and
in accordance with a determination that the electronic device is not in the shared content playback mode of the communication session, initiating playback of a third content item included in a private content item queue not associated with the communication session.

13. The method of claim 1, further comprising:
while the electronic device is in a respective communication session with one or more electronic devices, the one or more electronic devices associated with one or more users different from the user of the electronic device, receiving, via the one or more electronic devices, an indication of a request to initiate playback of a respective content item in the respective communication session; and
in response to receiving the indication of the request to initiate playback of the respective content item in the respective communication session:
in accordance with a determination that a content playback restriction setting of the electronic device is not more restrictive than a content playback restriction setting associated with the respective communication session, displaying, via a display generation component in communication with the electronic device, a selectable option that, when selected, causes the electronic device to initiate playback of the respective content item in a shared content playback mode of the respective communication session; and
in accordance with a determination that the content playback restriction setting of the electronic device is more restrictive than the content playback restriction setting associated with the respective communication session, forgoing display of the selectable option.

14. The method of claim 1, wherein while the electronic device is in the communication session, the electronic device has access to a first respective content application for playing content associated with the communication session, and the method further comprises:
while the electronic device is in a respective communication session with one or more third electronic devices, the one or more third electronic devices associated with one or more third users different from the user of the electronic device:
receiving, from a respective one of the one or more third electronic devices, an indication of shared playback of a respective content item associated with the respective communication session; and
in response to receiving the indication of the shared playback of the respective content item, in accordance with a determination that the electronic device does not have access to a second respective content application for playing content associated with the respective communication session, displaying, via a display generation component in communication with the electronic device, a selectable option that, when selected, causes the electronic device to initiate a process to gain access to the second respective content application.

15. The method of claim 1, further comprising:
while the electronic device is in the communication session and while the electronic device is in the shared content playback mode of the communication session:
receiving, from a respective one of the one or more second electronic devices, an indication of a first input corresponding to a request to modify playback of the content item at the electronic device and the one or more second electronic devices; and
in response to receiving the indication of the first input:
modifying playback of the content item at the electronic device in accordance with the first input; and
displaying, via a display generation component in communication with the electronic device, a visual indication of the first input.

16. The method of claim 15, wherein displaying the visual indication of the first input is in accordance with a determination that the request to modify playback of the content item is a request to modify playback of the content item in a first manner and that the indication of the first input is received while the electronic device is presenting a user interface of a content application associated with the communication session, and the method further comprises:
in response to receiving the indication of the first input:
in accordance with a determination that the request to modify playback of the content item is the request to modify playback of the content item in the first manner and that the indication of the first input is received while the electronic device is presenting a user interface of an application different from the content application associated with the communication session, forgoing displaying the visual indication of the first input.

17. The method of claim 16, further comprising:
in response to receiving the indication of the first input:
in accordance with a determination that the request to modify playback of the content item is a request to modify playback of the content item in a second manner different from the first manner, displaying the visual indication of the first input irrespective of whether the electronic device is presenting a user interface of the content application associated with the communication session or a user interface of the application different from the content application associated with the communication session when the indication of the first input is received.

18. The method of claim 1, further comprising:
while the electronic device is associated with first content playback restrictions and while the electronic device is in the communication session, the communication session associated with second content playback restrictions:
while the electronic device is not in the shared content playback mode of the communication session, receiving, via the one or more input devices, an input corresponding to a request to enter the shared content playback mode of the communication session; and
in response to the input corresponding to the request to enter the shared content playback mode of the communication session:
in accordance with a determination that the first content playback restrictions are more restrictive than the second content playback restrictions, forgoing entering the shared content playback mode of the communication session; and
in accordance with a determination that the first content playback restrictions are not more restrictive than the second content playback restrictions, entering the shared content playback mode of the communication session.

19. The method of claim 1, further comprising:
while the electronic device is associated with first content playback restrictions:
while the electronic device is not in the communication session, the communication session associated with second content playback restrictions, receiving, via the one or more input devices, an input corresponding to a request to join the communication session; and
in response to the input corresponding to the request to join the communication session:
in accordance with a determination that the first content playback restrictions are more restrictive than the second content playback restrictions, forgoing joining the communication session; and
in accordance with a determination that the first content playback restrictions are not more restrictive than the second content playback restrictions, joining the communication session.

20. An electronic device, comprising:
one or more processors;
memory; and
one or more programs, wherein the one or more programs are stored in the memory and configured to be executed by the one or more processors, the one or more programs including instructions for:
while the electronic device is in a communication session with one or more second electronic devices, the one or more second electronic devices associated with one or more second users different from a user of the electronic device:
while playback of a content item is occurring, receiving, via one or more input devices, an input corresponding to a request to modify the playback of the content item; and
in response to receiving the input:
in accordance with a determination that the input is received while the electronic device is in a shared content playback mode of the communication session, modifying the playback of the content item in accordance with the input at the electronic device and at the one or more second electronic devices; and
in accordance with a determination that the input is received while the electronic device is in a private content playback mode of the communication session, modifying the playback of the content item in accordance with the input at the electronic device without modifying the playback of the content item at the one or more second electronic devices.

21. A non-transitory computer readable storage medium storing one or more programs, the one or more programs comprising instructions, which when executed by one or more processors of an electronic device, cause the electronic device to perform a method comprising:
while the electronic device is in a communication session with one or more second electronic devices, the one or more second electronic devices associated with one or more second users different from a user of the electronic device:
while playback of a content item is occurring, receiving, via one or more input devices, an input corresponding to a request to modify the playback of the content item; and
in response to receiving the input:
in accordance with a determination that the input is received while the electronic device is in a shared content playback mode of the communication session, modifying the playback of the content item in accordance with the input at the electronic device and at the one or more second electronic devices; and
in accordance with a determination that the input is received while the electronic device is in a private content playback mode of the communication session, modifying the playback of the content item in accordance with the input at the electronic device without modifying the playback of the content item at the one or more second electronic devices.
